(19) United States
(12) Patent Application Publication
(10) Pub. No.: US 2011/0062888 A1
(43) Pub. Date: Mar. 17, 2011

(54) Energy saving extra-low voltage dimmer and security lighting system wherein fixture control is local to the illuminated area

(76) Inventors: Montgomery C. Bondy, Surrey (CA); Allen B. Hepworth, El Cajon, CA (US); Brent McKee, Halfmoon Bay (CA); Richard J. Bentley, Port Moody (CA)

(21) Appl. No.: 12/662,312

(22) Filed: Apr. 9, 2010

Related U.S. Application Data
(63) Continuation-in-part of application No. 11/723,445, filed on Mar. 20, 2007, now abandoned.
Application No. 11/723,445 is a continuation-in-part of application No. 10/999,917, filed on Dec. 1, 2004, now abandoned.

(51) Int. Cl. H05B 37/02

(52) U.S. Cl. 315/294; 315/291

(57) ABSTRACT

Prior applications disclosed power supply transmission voltage resulting in reduced line losses, with further energy conservation via luminous intensity control (dimming) of lamp(s) including LEDs. Additionally, an invertible, convertable luminaire, and upgraded control module design (comparable to a computer mainframe) comprised of function components including, for example, a microcontroller with programmable CPU, multiple LED driver(s), multiple independent lamp control(s), variable ON time segmentation(s) and variable ramp speed(s), voice actuation (s), security system(s), battery charge component(s), voltage drop (current) limiter(s), protection, ammeter(s), volt and watt meter(s); and voids for optional modules including but not limited to: clock timer(s); photocell(s); motion detector(s) of various function(s); push button(s); programming and function display(s); microphone(s); wireless transmitter(s)/receiver(s); fiber optic interconnection(s); remote control(s); integration to personal computer(s) or other central control system(s); speaker(s); camera(s); irrigation control(s); luminaire mountable laser module(s) and beacon(s); battery array(s); transmission voltage double isolation for nominal 15 volt maximum wet contact.

### CROSS-REFERENCE TO RELATED APPLICATIONS

This is a Continuation-In-Part of prior U.S. patent application Ser. No. 11/723,445, “ENERGY SAVING EXTRA-LOW VOLTAGE DIMMER LIGHTING SYSTEM”, by the same inventors, Bondy et al, which was a Continuation-In-Part of prior U.S. patent application Ser. No. 10/999,917, ‘MULTIPLE DIMMER LIGHTING SYSTEM”, by the same inventors, Bondy et al.

### SPECIFICATION

### Background of the Invention

1. Field of the Invention

This application relates to extra-low voltage outdoor lighting, where variation in placement and brightness of individual lights may provide striking contrast of illumination of plants or buildings within a garden or other area, and where energy conservation may be a desired outcome, and where safety and potentially security may be a desired outcome, and where dramatic effects of multi-colour lamp output may be programmed for multiple time/light color segments and ramp time segments for a homogeneous arrangement.

2. Description of the Prior Art

With respect to existing dimming methods, there are none available on the market for extra-low voltage lighting at the time of this application. Prior to the Bondy et al system, attempts were made to find a practical and effective method for dimming extra-low voltage outdoor landscape luminaires, however as will be seen, none of the methods proved to have merit.

Using one method, a magnetic dimmer was placed in series with the 120 volt AC supply side of the power supply with 12-volt AC secondary transmission conductors. The result was not satisfactory. With wire runs in place the lamps dimmed unevenly; some with longer runs were so dim as to be totally ineffective. This occurred because, with this method, all conductors must be equal in resistance whether by length or AWG size. With this configuration of equal lengths of supply wire, all lamps dimmed equally and therefore did not produce the desired result since various light locations required differing light outputs. In fact, conductors could produce different levels of dimming if they were purposely cut to different lengths, which was a very complex process and only proved the power losses. Other problems included a very noisy power supply with attendant power losses. The conductor losses were very large with the most severe losses on longer runs. Since the supply was dimmed below nominal 12 volts AC, the power losses ranged above 25 percent.

A second method was the utilization of a magnetic dimmer placed in series with a multi-tap transformer (120 volt AC). This resulted in better control for dimming but the over-voltage taps merely indicated how severe the power losses were. A 15 volt tap already indicates a 25 percent power loss if the result is nominal 12 volts at the luminaire. The use of the line voltage primary dimmer resulted in again far too much power loss. Precise control of lamp output was in every case a complex calculation. Again, with noise and heat losses in the transformer added to the other losses above, the power losses were over 25 percent. National Electrical Code cannot be adhered to under these conditions. A third method would be to place the dimmers at the power supply, but again the line losses were excessively high. The voltage through the secondary transmission conductors was low enough to cause as much undesired dimming effect in line losses as the dimmer itself.

The Bondy et al system overcame the above problems sufficiently well as to be called far superior. With the embodiments disclosed in this continuation-in-part, the purpose of the Bondy et al system is to offer a quality commercial and residential outdoor lighting and security system for professionals and homeowners, with important considerations being safety, security, energy conservation, and the provision of refined aesthetics. Components work together to improve the performance to energy consumption ratio, and thus the lighting system can be enjoyed in full, and the total energy consumption will be a small fraction of a comparably sized system such as are currently available in 12 volt assemblies without dimming, staging, motion sensing or location specific function capacity. Each addition that we have made to our original energy saving system, makes possible greater energy saving. The combination security and lighting embodiment is no exception. The Bondy et al system may be completed in stages, if desired, without the slightest compromise in quality or cohesiveness.

A line voltage (120 volts AC) system could be made to function in a similar manner as the Bondy et al system, but the expense would be exorbitant. The complexity would require numerous components arranged in a large, custom-built indoor control assembly and requiring individual supply conductors for each luminaire and a secondary arrangement for the low voltage pathway luminaires. Only a small percentage of end users could afford the material and installation costs. Outdoor architectural and landscape lighting systems of this complexity are most likely to be found in connection with large commercial buildings, and these systems are custom designed by experienced persons with graduate degrees and/or other qualifications. Funding for these systems is planned and provided for, and these systems are most often intended to increase the prestige and exclusivity of the companies who plan to occupy the buildings for commercial purposes. The Bondy et al system brings top end performance into the range of average homeowners' budgets, which is part of the commercial advantage of the system. This was actualized along with keeping the system very simple for the end user to install. Lamp life will be lengthened by dimming and the quality components will serve for many years.

We wish to point out that what we are offering primarily for the purpose of safety, security and energy conservation has very much expanded the creative and functional capacity of the Bondy et al system to the point that persons without experience may safely produce many and more likely all of the effects of these prestigious systems. We have been able, by means of innovation and the declining cost of electronic components, to produce these effects and even extra effects for a very small fraction of the cost. In fact, a very impressive effect could be produced by a novice by means of the Bondy et al system. That the Bondy et al system will also be energy conserving and reduce light pollution is, in our opinion, a considerable achievement.

Additionally, Bondy et al are aware of the recently revised National Electrical Code with regard to outdoor extra-low voltage architectural and outdoor lighting systems, and specifically the new limitations of systems which are subject to potential wet contact as a step toward safety, but also a very great restriction to what may be achieved by consumers who seek to purchase low voltage systems and install them also. This has brought about a situation where potential dimming, if not done at the luminaire or as close as practicable to the luminaire, is now in our view untenable. Thus, we see that without the Bondy et al system, anyone wishing to create systems which may approximate the functions herein disclosed must be produced by a licensed tradesperson with a very costly range of necessary material and considerable landscape excavation and repair. What may be produced in any attempt to match the performance and efficiency of the Bondy et al system will need to be the work of a very qualified, knowledgeable and creative mind. Unless a system is custom developed and comprised of a very large quantity of components at a voltage which is considered dangerous (i.e., 120 volts), Bondy et al are not aware of any prior art or other method to achieve the results which we have attained at a safe voltage and with an optioned assembly. The reason for this statement will become clear. Line losses preclude dimming at point of power supply because it will require ever longer supply conductors with increased distance. We resolved these complications in the design of the Bondy et al system.

With the passing of time, Bondy et al have seen an increased number of off grid or back-up power supply systems operating at 30 volts DC. The purpose of this is two-fold, in our view. First, the conductors which are routed from solar arrays and windmills, etc., can in the case of moderately large system become unmanageably large at points of termination, most importantly. Line losses in these and many low voltage power supply conductors can be, and we believe often are, an unseen waste of energy. When considering 12 volt lighting systems, even those which have managed to get a U.L. (Underwriter's Laboratory) listing can be seen to produce voltage drops which are so large as to be visible in lamp dimming as the lamps on a single conductor are at greater distance from the supply. Our position is that National Electrical Code requirements as to percent voltage drop are clearly set out and these limits are not adhered to with many of the ‘kits’ which are available. It will be seen that with foresight these losses can be much reduced. With this continuation-in-part, we have concluded that there is a very large increase in energy saving potential when the individual luminaire assemblies are controlled by location.

### DESCRIPTION OF THE INVENTION

### Disclosures from Bondy et al Prior Application Ser. No. 11/723,445

Remarks: In this section, Description of the Invention, we have maintained the disclosures of the Bondy et al prior application Ser. No. 11/723,445 with minor changes as indicated by strikethroughs and underlining. These disclosures are followed by the new disclosures of this Continuation-in-Part, as will be clearly indicated.

An energy saving system of extra-low voltage outdoor lighting is provided in which a single or multitude of extra-low voltage luminaires each have an individual Control Module which enables the setting of individual brightness for each lamp in either the singular or a plurality. Each individual Control Module (internal or external to the luminaire) can be pre-set during installation or adjusted afterward. All manner of primary on/off switching is made possible by the growing market and, consequently, products that are being made available. Most countries have what are called extra-low voltage weatherproof power supply transformers. The object of these is to allow laypersons having no prior training to install a system of lighting outdoors without the likelihood of anyone being injured. Most North American systems rely on power supply (120 volt AC) with secondary supply voltages of 12 volts. This voltage is also the rating of most available luminaires.

Next in the Bondy et al system are the conductors used. We recommend in our system that conductors will be run as for the 12 volt systems. As it is commonly known in the trade that voltage drop in a conductor is directly related to load and voltage, the higher the voltage the lower the power loss. Since our system includes a secondary voltage of 24 volts then it follows that the percent drop will be cut in half. This is another energy saving component of our system. The output of the Control Module (made known in the detailed description) will be from 12 volts DC (average) down depending on dimming setting.

To elucidate, for the remainder of the detailed description of the Control Module, whenever 12 volt dimming is mentioned the following description most accurately describes what occurs.

Lamp brightness is controlled by adjusting the control pot, which then causes the circuitry to vary the duty cycle (on to off time) of the lamp. The result is that the lamp sees the average of the on-off time as a lower voltage and therefore does not light as brightly. For example, if the duty cycle is 50% (on half the time) when operated from a 12 volt supply, the lamp would see the average as 0.5×12=6 volts. This feature can also be used successfully to compensate for voltage variations due to conductor voltage drop and to allow the unit to be run from higher voltages than the 12 volts that the lamp is designed for without the lamp sustaining damage. Thus, when operated from a 24 volt supply, the lamp will have maximum brightness when the average DC voltage is 12 volts, which works out to 0.5×24=12 volts or 50% duty cycle. So, by allowing changes in the supply voltage to also change the duty cycle of the lamp power, brightness settings can be automatically maintained with variations in supply voltage.

Since the lights can be made to be as bright as necessary, and not more than this, is a further source of energy savings in our system. Yet another is the short length of the power conductors between the Control Module and the lamp when lower than 12 volts is applied, as is the case for dimming. Further, in another embodiment, as stated in the Bondy et al prior application Ser. No. 10/999,917 and disclosed in greater detail in the Bondy et al prior application Ser. No. 11/723,445, the use of LED (light emitting diode) lamps that have been color corrected would result in a much more efficient light source when compared to halogen lamps, which are commonly used in the extra-low voltage outdoor lighting market.

The system of extra-low voltage outdoor lighting can be made to operate from 12 volts to 30 volts AC. DC voltage can also be utilized. The Control Module will compensate for fluctuations and continue a light output as has been set. The Control Module has a memory and will reset the lamp output upon restarting. The embodiment can handle loads to 50 watts. Future embodiments may have decreased or increased power-handling capacity.

In an embodiment the Control Module would be mounted inside the proprietary spherical luminaire. The latter would make the Bondy et al system a one-piece unit for easy installation.

In other embodiments the Control Module could be made to control all manner of extra-low voltage luminaires as long as the input of said luminaires is 12 volts. The Control Module is recommended for use with voltages exceeding 12 volts to the Control Module.

Another embodiment would be to have a system including an approved outdoor power supply transformer operating at approximately 24 volts AC and connected to a singular or plurality of secondary transmission conductors:
a) all of which are connected to the Control Modules within the several proprietary spherical luminaires for the purpose of dimming the included lamp to the desired light output;
b) all of which are connected to our Control Modules either inside our proprietary spherical luminaires, or outside our proprietary spherical luminaires but weatherproof and also connected to 12 volt luminaires of other manufacture (with licensing agreement);
c) all of which are connected to our weatherproof Control Modules and all controlling luminaires of other manufacture (with licensing agreement) but rated at 12 volts.

In another embodiment our Control Module would be utilized purely as a dimmer and power loss reducer to upgrade existing outdoor lighting systems. Areas where light output is too bright could then be dimmed. In the main, a power supply transformer (120 volt AC) would be required with secondary voltage of 24 volts, or a multi-tap transformer ranging above 12 volts AC and approved for outdoor use.

The Bondy et al system thus comprises a system of extra-low voltage outdoor lighting where the main power switch turns on and off the system by energizing or de-energizing the primary conductors to the hereafter approved extra-low voltage transformer. When energized said transformer's secondary output is a nominal 24 volts. The secondary transmission conductors are connected to the secondary terminal of the transformer and run either underground, under sod, along fence boards or whatever the case may be to said Control Modules. The Control Module has input and output terminals and said 24 volt conductors are connected to the input terminals. The Control Module then rectifies the incoming power, and then regulates the incoming power down to 12 volts. The Control Module then allows the voltage to be dropped or again raised as is needed for the purpose of attaining the desired light effect from a lamp. For this purpose the Control Module has a weatherproof means to allow for the latter adjustment. The lamp is connected to the output terminals of the Control Module by means of power conductors. After installation said weatherproofed control can be adjusted as often as desired by the end user.

In a further embodiment:
a) the Control Module first rectifies, then regulates, and then dims the power supplied to the extra-low voltage luminaire;
b) power at 24 volts AC is supplied along electrical conductors that would typically be used for 12 volts AC, and is then stepped down by the Control Module to 12 volts DC to the luminaire, whereby power loss over the electrical cable is approximately halved;
c) in addition to stepping power supply voltage down from 24 volts AC to 12 volts DC, the Control Module provides for selectable further reduction of voltage to the luminaire as desired for dimming lighting effects and further energy savings;
d) an extra-low voltage Control Module including a rectifier and dimmer operating between 4 and 30 volts AC and DC is used;
e) the Control Module is encased in a weatherproof housing and has an accessible dimming control which can be used to further reduce power consumption from 12 volts DC down and enhance outdoor lighting effects;
f) the Control Module will fit inside our proprietary substantially spherical luminaire with or without a convertible mushroom cap;
g) the proprietary spherical luminaire allows for rapid conversion from up-light to down-light by means of a tube and a mushroom shaped canopy.

Another embodiment would be to use the system with individually dimmed lights, in which:
a) the power supply transformer, which is rated for extra-low voltage outdoor use, has secondary power terminals rated at 24 volts;
b) the secondary transmission conductors would be of sufficient capacity to carry the current if the conductors were instead sized for the standard 12 volts;
c) the Control Modules are placed for easy access and have outputs from 12 volts and below;
d) the proprietary spherical luminaires contain lamps rated for 12 volts;
e) the proprietary luminaires are spherical and can be easily converted from up-lights to down-lights;
f) the above Control Module and proprietary spherical luminaire are constructed as to allow for LED (light emitting diode) lamps.

With regard to long life energy saving lamps, the Bondy et al system can utilize LED (light emitting diode) lamps. We found the multiple LED white 12 volt par 36 lamps can also be dimmed by means of an altered dimming component of our Control Module.

In the current environment encouraging a reduction in power consumption, alternative lighting sources are becoming available. The efficiency of a standard incandescent lamp is around 3%, which means that 97% of the energy used by the lamp comes out as heat. Halogen lamps have a higher efficiency, but the latest generation of high power LED (light emitting diode) lamps has an even higher efficiency. Below are given the differences between using a high power LED lamp instead of a halogen lamp.

If a high power LED lamp was used instead of a 36 watt halogen lamp, the power consumption would be reduced for the same level of light output.

On the present circuitry, the brightness of the halogen lamp varies slightly if the supply voltage is changed over a wide range. The voltage regulator circuitry required for the LED lamp, as described further below, would ensure a steady light output irrespective of the voltage input range. Lamp brightness level would be solely dependent upon the setting of the dimmer control.

When being dimmed, the light produced by a halogen lamp turns from white through amber/yellow and gold. White LED lamps tend to be a blue white color and when dimmed stay the same color and just produce less light. For an LED lamp to produce a similar color shift to the halogen lamp when dimmed would require a red and amber/yellow LED mix, which would dim at a slower rate and therefore make the light shift more to amber/yellow/gold at lower light output levels.

LED lamps can be damaged and fail due to overheating, and high power LED lamps are mounted on a heat sink to aid cooling.

LED lamps can be dimmed in the same way as halogen lamps by varying the on-off time of the lamp; however, the present circuitry for the halogen lamp is not utilized. The peak current through a LED is strictly controlled to prevent failure of the individual LEDs. The LED lamp requires a power supply that produces a steady voltage, and this is achieved by the use of a switching regulator. Operating voltage range is similar to the presently shown embodiment.

After testing LED (light emitting diode) lamps of other colors, we determined that the required lamp must be made up of a configuration of different color LED emitters to form one lamp, so that by means of carefully mixing red, amber/yellow, and white LED emitters, the outcome would be an eye-pleasing color at all dimming power levels. Unlike halogen lamps, LED lamps (in the main) do not change color when dimmed. Thus if the color mixture is pleasing at full rated power, then as power and consequently light output are reduced, then the color will remain substantially the same.

A glass refractory lens is made to both dissipate heat and mix the various colored LED emitters into one homogenous color output.

The combination of the LED Control Module and the LED lamp results in a very long life expectancy for both components. Since some existing par 36 LED lamps draw only 0.5 amps then many other layouts become possible in order to save substantial energy when compared to the halogen embodiment. In short 0.5 amps will produce substantially more lumens in a LED configuration than a halogen configuration.

In an embodiment the LED Control Module and the LED lamp could be packaged and sold together as this would allow for finer tuning of the LED Control Module and LED lamp as described. The uppermost in energy savings potential will be the result of the latter.

This system of outdoor lights that are buried but shining upward to illuminate trees and shrubs, etc., and can be complemented by having some of the individually dimmable lights equipped with housings that each have a ledge and a rim surrounding a lens for a lamp. The ledge and rim are used to support and hold the cylindrical walls of a column supporting a mushroom cap shade that captures light energy shining up from the lamp and reflects it downward.

The Bondy et al system has been designed to cover the needs of up-lighting and down-lighting by means of the so-called mushroom cap and variable light output. The variable light output is made possible by the Control Module. Other luminaires from other manufacturers can be chosen as long as the Control Module is utilized to protect the lamp from over voltage. The end user can very simply lay out the system in the following way.

Having decided what locations are to be lighted for security, safety, and/or beauty, the luminaires are laid out at suitable locations. The power supply transformer (120 volts AC) is placed where it can be supplied with line voltage. Suitable conductors are run. The described proprietary spherical luminaires are placed and/or the Control Modules with luminaires of other manufacture are placed. All connections are made. The entire system is energized during day to ensure proper installation.

After dark, by means of the Control Modules, some or all of the luminaires in the system can be dimmed according to the desire of the end user. Each setting can be adjusted again and again or altered for special occasions.

In the above description it is said that all the lamps may be dimmed. They might also be left at the highest setting. We have found that in most installations the 50 watt halogen described in one embodiment is too bright when set on high, and that the light output of these lamps can be softened in color when dimmed even slightly, thus creating a more aesthetically pleasing lighting outcome, which is one of the commercial advantages of the Bondy et al system. The 50 watt halogen described is very close in output to an automobile headlamp, and this upper end high quality lamp has been chosen because it is hoped that the lamp will be dimmed. Further, these relatively high output lamps with the Control Module compare favorably to components in very much more expensive commercial systems.

Power can be conserved by choosing the lowest light setting while still providing the desired light output. It is also hoped that the above lamp will be dimmed at least slightly because lamp life can be greatly increased in this manner.

Another embodiment of the Bondy et al system that might be included in the overall lighting plan would be the use of the Control Module to control a daisy chain string of lamps of other manufacture. Since the Control Module will safely control 50 watts then several (7) of the typical 7 watt pagoda luminaires could be utilized. Or, as the case may be, any combination of available luminaires up to 50 watts.

In an embodiment a 50 watt Control Module is utilized, however the Control Module is not limited to that power range and could be constructed to control smaller or larger loads.

In another embodiment, as described in the Bondy et al prior application Ser. No. 10/999,917 and disclosed in greater detail in the Bondy et al prior application Ser. No. 11/723,445, the Control Module will also function with DC inputs from 12 to 30 volts, such as alternate energy systems including solar power. Many alternate energy systems make use of a battery or battery array. A common voltage for these arrays is 24 volts DC. The Control Module will accept voltages between 12 and 30 volts DC. For this reason the Bondy et al system can be operated with such alternate energy systems (off the grid). One problem associated with simple alternate energy systems is voltage fluctuations. A 12 volt DC battery can be brought up above 13 volts DC while charging, which can result in lamps burning out. The Bondy et al Control Module levels out this fluctuating voltage and this results in much longer lamp life. Where National Electrical Code allows, the Bondy et al system could be utilized indoors in alternate energy homes.

With respect to energy conservation, at the present time efforts are being made all over North America and the world to reduce energy use and eliminate wasted consumption of power. It could be said that this is a top priority since our future and the future of generations to come will be affected by what we are able to do now to address this problem.

Pertaining to the design of the Bondy et al system, the following detailed explanation will clarify the magnitude of the energy savings available.

Where outdoor lighting is required or desired, and will be installed and utilized, our system offers several methods of reducing to a minimum the energy required to do so, as follows:
a) the ratio of the step down transformer is reduced from 10-to-1 to 5-to-1;
b) the reduction of power losses caused by voltage drop in the secondary transmission conductors;
c) placing the Control Module in close proximity in, at or near each luminaire, further reducing line losses;
d) dimming the light output of the lamps to what is desired or required by the end user, which also extends lamp life;
e) another embodiment of the Control Module is utilized to supply and/or dim LED lamps, which have been color-corrected by the use of a configuration of multi-color LED emitters;
f) the Control Module will also function with DC inputs from 12 to 30 volts, such as alternate energy systems including solar power.

Some existing available systems will not produce full lamp output. It is our contention that many systems are malfunctioning from the start regarding rated voltage and expected output and lamp life. Any attempt to cause dimming at the 12 volt supply will result in even larger power losses.

It is our hope that do-it-yourself extra-low-voltage outdoor lighting systems will come under a regulation authority. Consumers should be made aware of the unseen energy waste, which might occur with some of these systems. In some instances, kits sold by other manufacturers cause early lamp failure in the first lamp in closest proximity to the power supply transformer. The next lamp in line is often next to fail, etc., because the voltage may exceed 12 volts and there is nothing to protect the lamp under this condition.

What follows is a comparison of the energy saving performance of the Bondy et al system as described, with an existing system.

For the first comparison, the length of secondary transmission conductors used will be 200 feet. The size of the conductors will be #12 AWG. The lamp used will be a 12 volt 35 watt halogen par 36, nominal current 3 amps.

For the standard outdoor supply voltage of 12 volts, the percent voltage drop in existing systems is 16.33 percent, giving 10.04 volts at the luminaire. It follows that the voltage drop is 1.96 volts.

In this example there is an under voltage occurring and the lamp cannot be operated to rated power. This is not a reasonable outcome; however, these outcomes occur regularly with standard do-it-yourself extra-low voltage outdoor lighting systems. If a dimmer is located at the power supply then as the voltage is reduced the power losses will be increased.

For the Bondy et al system design the supply voltage will be 24 volts; the percent voltage drop is 8.16 percent, giving 22.04 volts at or very near the luminaire. It follows that the voltage drop is 1.96 volts.

The under voltage situation has been eliminated, and with the use of the regulator in our system, the voltage will in all cases be 12 volts nominal at full power and dimming can be made to occur through 100 percent of the desired light output range of the chosen lamp.

Regarding conductor size, #12 AWG is at the top end for outdoor rated zip cord wire and is at the top of the range for stranded outdoor approved cable found in large building supply outlets. For larger sizes there is NMWU; however this cable is marketed primarily to licensed electricians.

For the second comparison, the length of the secondary transmission conductors used will be 100 feet. The size of the conductors will be #12 AWG. The lamp will be 12 volt 35 watt halogen par 36, nominal current 3 amps.

For the standard outdoor supply voltage of 12 volts, the percent voltage drop is 8.16 giving 11.02 volts at the luminaire. It follows that the voltage drop is 0.98 volts. In this example there is again an under voltage at the lamp. The lamp cannot be operated through its full range. If a dimmer is located at the power supply then as the voltage is reduced the power losses will be increased.

For the Bondy et al system design, the supply voltage will be 24 volts; the percent voltage drop is 4.08, giving 23.02 volts at or near the luminaire Voltage drop is 0.98 volts.

With existing systems, unless the secondary transmission conductors can be kept very short then the 12 volt supply will not provide the full range of the lamp capacity. Power losses increase significantly as the length of the secondary transmission conductors increases. Again, if dimming is made to occur at the power supply then the voltage drop will be further increased because lower supply voltages correspond to increased power losses.

It may be considered that 100 feet of secondary transmission conductors is excessive and is too long to be relevant, however this distance is common. It is instead the fault of some manufacturers who include far too little length of secondary transmission conductors to make professional-looking outdoor lighting a real possibility by end users.

According to the 2000 census, there are over 100 million housing units in the United States. (According to the U.S. Census Bureau, the 2000 census listed 115,902,572 housing units, and the estimated number of housing units in 2005 was 124,521,886. Source: www.census.gov.) We do not have an accurate percentage of homes that make use of some form of extra-low voltage outdoor lighting system, nor do we know the future rate of growth in the sales of do-it-yourself extra-low voltage outdoor lighting systems, however, trends to observe are the increase in consumer spending on outdoor lighting (for security, aesthetics, and enhanced market value), the growth in the residential construction industry, and the expansion in the environmental horticulture industry, also known as the “Green Industry”, which is comprised of a variety of businesses involved in production, distribution and services associated with ornamental plants, landscape and garden supplies and equipment.

There are demographics that show an increase in the number of people who will retire from work due to an aging population. As a group, many retirees very often turn to gardening and beautifying the outdoor portion of their property.

Growth in the outdoor lighting market will be further stimulated by efforts to increase the energy efficiency of new and existing lighting systems, generating residential landscape remodelling and upgrading activities, and non-residential retrofit projects. The growing focus on energy efficiency will also increase demand for high-efficiency products as well as for advanced technologies such as LEDs (light emitting diodes).

Commercial outdoor lighting can also be upgraded by means of the implementation of the Bondy et al system, by means of 50-watt halogen or LED lamps, a result that would be made possible because of the quality and durability of the Bondy et al system.

We estimate that there is, at a minimum, 1 house in 20 that makes use of an extra-low voltage lighting system. Thus, we estimate a minimum of 5 million homes making use of some type of extra-low voltage residential lighting system. Again, we estimate that these numbers will grow.

As we have indicated, the Bondy et al system can be amalgamated into almost all existing systems, both to reduce energy use and also to improve the function of these existing systems. The performance of the Bondy et al system will allow for an ever-increasing market share in the next ten years and beyond. The following indicates an estimate of energy savings made possible by the Bondy et al system.

Using the figure of 5 million homes over the period of 10 years indicates the following:

Where the average existing system consumes 200 watts of energy, it is estimated that with the Bondy et al system, 50 watts of energy might easily be saved at each location giving the following calculation:

50 watts×5 hours “on” time=250 watts or 0.25 kilowatt hours

0.25 kilowatt hours×365 days×5 million homes×10 years=4,562,500,000 kilowatt hours=4.562 gigawatt hours

If the 200 watt consumption seems high, it should be noted that this includes line voltage lighting luminaires attached to buildings or homes, such as floodlights.

We believe that this is a very low estimate of the results of using our system design.

Further energy savings can be obtained by the use of LED (light emitting diode) lamps, as described above in this document. With a color corrected combination of which, when dimmed, will produce similar lighting effects to those of the halogen type, the energy savings beyond go beyond what has been estimated above.

Finally, with the future in mind, the Bondy et al Control Module will also function with DC inputs from 12 to 30 volts, such as alternate energy systems including solar power, as described above.

There are different types of pollution, one of which is light pollution, i.e., excessively bright luminaires which operate from dusk until dawn, in some cases blotting out the stars in the sky. The Bondy et al system design will reduce to a minimum light output for function and beauty, which will both reduce light pollution and increase quality of life.

To summarize, the Bondy et al system provides a system of lighting for energy saving and for providing variably lighted landscapes and walkways, enabling end-users to install and create variable intensity outdoor lighting effects without the use of 120 volt AC (line voltage) luminaires, without running line voltage power transmission conductors or extension cords in moist and difficult ground conditions, and without needing skilled electricians, electrical permits, or extensive excavation to line voltage electrical codes, in which an over-voltage power supply is provided from an extra-low voltage outdoor transformer through a Control Module and then to an extra-low voltage outdoor luminaire.

New Disclosures of this Continuation-in-Part

Remarks: In this section of this Continuation-In-Part, we describe new disclosures and embodiments of the Bondy et al system of low voltage outdoor lighting.

The Bondy et al system of low voltage outdoor lighting provides safety, security, energy savings and aesthetic appeal with a means of eliminating potential light pollution. With safety as the primary consideration, energy conservation is considered the next important feature of the system and each component has been carefully considered as to how it may best be utilized for each purpose. Every component of our system potentially serves the energy conservation purpose. We consider the disclosed low voltage system of aesthetic outdoor lighting control to be easy to install, easy to program, and the most energy efficient system of outdoor lighting that is currently available, whether it is newly installed system or an upgrade of an existing system.

The energy saving potential of the original Bondy et al system has been greatly increased by means of the following principals: As indoor lighting is divided room by room, we have done the same with our outdoor system, creating a division of areas and a division within each area for function. As indoor efficiency is greatly increased by dimmers, we have done the same outdoors. As indoor overnight lighting is typically very low energy for movement, we have done the same outdoors, however, we have solved the path lighting energy waste by causing outdoor passage lighting to function automatically, having replaced what would otherwise require a switch at the beginning and end of every outdoor pathway and stairway, as is done indoors. With dimming of LED lamps and other lamps, the minimum output in the required areas may be optimized by the high lamp efficacy, but added to this is a system designed to begin the process of optimizing efficiency in stages without losing the slightest benefit at any stage during completion.

In the following description, we have divided lighting into four optional categories, with each serving at least one purpose, although there is often an overlap. Lighting requirements at each luminaire location are often varied, and when this condition is considered when the programming is done, then energy conserving adjustments may be made at each lighting area or location. The highest efficiency may be reached by separating the actuating means and lamp supply output terminals for these four types of lighting. Using only Zones 1, 2 and 3 will increase efficiency but lighting for aesthetics may considerably reduce energy requirements if separated into viewable areas as described.

Zone 1: Safety night time staging areas. Beacons for delineation are actuated for energization by a photocell from dawn to dusk, and are intended to be laid out so that all staging areas can be reached safely, and once reached, Zone 2, pathway lighting can be triggered by motion detectors which are placed for this purpose with variable ON delay entered in to the memory of the microcontroller with programmable CPU, if it has been arranged to do so. Zone 3: Area lighting which is illuminated for function is referred to as Zone 3, although it may also be referred to as part of Zone 2 because the actuation means is again by motion detection. For area lighting the delay ON may be set as desired. Zone 4 is scene lighting where the luminaires are placed for aesthetics, although it will overlap other areas. Actuation means is by a programmable CPU which allows programming settings for color and luminous intensity, and/or motion detector with repeated detection count, if desired. In addition to the above four zones, Zone 5 Security may seem the most important of all zones, but because security can be considerably increased with lighting, the means of doing so include the energization of the first four Zones in combination. Zone 5 is a property area or perimeter accessible by uninvited persons. All areas will be fully responsive with optional voice recognition hardware and programming.

For the purposes of clarity, in the main, each area is controlled primarily by one Sentinel Advanced Control Module, and where this Sentinel Advanced Control Module is placed is termed a ‘station’. Stations are defined as an area of outdoor property, including stairway, entranceway, pathway, driveway, patio, sundeck, garage or storage structures, aesthetic garden areas, areas intended for pets or farm animals, outdoor aesthetic features such as sculptures, vegetative ground cover, lounging areas, and socialization or celebration areas.

Multiple stations are interconnected by Sentinel Advanced Control Modules, which when fully optimized provide a means of 4 level programmable lighting, and a control means for single or multiple zones, single or multiple beacons for staging and/or aesthetics, single or multiple pathway luminaires, single or multiple function, path and/or aesthetic luminaires, single or multiple multi-color LED's in luminaires with current modulated dimming, and a second 50 watt voltage modulated dimmer luminaire output.

Since functional passageway lighting requirements are frequently mixed with aesthetic lighting, energy may be needlessly wasted. To reduce this potential, the Bondy et al system of outdoor lighting comprises a Sentinel Advanced Control Module, with a capacity of considerable luminous intensity, and optional pathway luminaire or a plurality of pathway luminaires of much lower luminous intensity, such that the pathway luminaire(s) may be utilized when aesthetic effect is not desired. When the motion detector input data is taken into consideration, there can be very large functional and energy conservation advantages. The motion detectors make functional lighting considerably more energy conserving.

The Bondy et al system may serve as an efficient security system with an optional audio/video security system with voice recognition and interconnection capacity to provide a ‘wall of light’, and a staged security system, including an intercom, an optional audio alarm for audible warning and optional sprinkler actuation, and an entrance security upgrade, which can be utilized for the above purposes. The system also includes an output for the optional actuation of programmed irrigation zone control. If optioned, the system can provide emergency security and lighting with an optimal battery array pack and battery charging system.

The Bondy et al system, in one embodiment, includes multi-stage dimming with variable time segment duration, variable ramp duration and time program choices, as well as variable color output for each time segment in a programmed cycle. Lighting for aesthetics has been separated from other functions and the range of potential function for multilevel output, multiple programmed time segments for each primary aesthetic lamp (including one RGB with dimmer and one 50 watt LED or other with voltage modulated dimmer), while also synchronized, and with variable ramp up or down time, it will be shown that the visual effects which were possible in theatres are now possible outdoors with optimized efficiency.

The Bondy et al system, with an optional means of additional battery capacity, can be optioned for direct connection to solar panel or other alternate energy source, either AC or DC to 30 volts, with charge control by means of the Sentinel Advanced Control Module microcontroller with programmable CPU. The system will accept voltage from any source from 11 to 30 volts AC or DC, thereby potentially eliminating alternate energy supply voltage regulation requirements.

This feature also serves an emergency power failure function and will provide regulation 90 minutes and greater safety/emergency lighting when optioned.

One of the ongoing outdoor lighting problems has been energy losses in supply conductors. Dual or multi-tap transformers are sold to ‘correct’ the function of dim lights but when a 15 volt tap is required for nominal 12 volts at the distant luminaire, then 25% of the energy required for the lamp is being lost in the supply conductors. Conductors can be sized to reduce this ongoing waste but the cost can be considerable and the task of determining and reducing line losses is almost universally neglected. We consider that much of the energy which is lost needlessly occurs without the recognition of the loss itself, or a lack of affordable, workable and suitable system for a homeowner to assemble. Where problems exist, the answer can be found either by continuing with the same power supply and using the battery array option for reduced voltage drop at 12 to 15 volts, as will be described, or optionally to obtain a transformer with a 24 to 30 volt output and isolation of the transmission voltage from contact by persons.

In the main, most branch supply circuits are subject to National Electrical Code rejection when line losses exceed 5%, and although it has not been required to date, we have addressed this problem in three significant ways. First, the Bondy et al system is made to function with supply conductors at 30 volts, which will reduce potential line losses by a nominal 60%. Second, lamp dimming is done in, on, or as close as is practicable to the luminaire, because voltage drop in a conductor in addition to current flow and resistance is directly related to conductor length, and attempts to dim 12 volt luminaires from remote power supply controls results, in our view, in excessive line losses. Third, for existing systems our 24 hour battery charging can be set to hold voltage drop below 6%, and for long pathways the motion detectors can be set to fully illuminate that portion of the path which is being followed and may be set to a reasonable ON time delay, thus the energy required for the path is slowly and very efficiently stored for the next use.

We have created an affordable means of system upgrade of existing components and lamps which may already be in place. Thus functional lighting components need not be discarded but instead optimized. Halogen lamps may be dimmed and utilized until failure, and if these lamps are replaced with more efficient lamps they need not be purchased all at once.

A precise description of a multifunctional device requires much more detail than is required to enjoy the benefits of same. As an analogy, a stereo music system may have a multitude of potential audio inputs but typically only a small number of these are chosen and with clear terminal identification, millions of these systems have been properly assembled by persons without any related training. Our view is that thorough engineering results in simplicity for the end user, and that sophistication is not identified by complexity, rather complexity is often an indication that necessary functions are without an interface which will allow for a simple means of end user assembly and programming for desired function. Logic dictates that persons who have chosen a lighting control system which promises dramatic effects and multilevel efficiency will desire first and foremost to see the dramatic effects in operation, and even to try several variations of in concert lighting aesthetics before moving on to the layout of the more practical infrastructure which creates the efficiency gains which make the aesthetics a viable by-product. Investments in efficiency bring rewarding returns which are only possible with the passing of time. When a project can be completed in steps without losses, the experience gained with each upgrade will improve the outcome when the system is later completed.

However, as will be described, when the supply conductors are chosen correctly and with a good margin for unforeseen potential future requirements, then the Bondy et al system may be installed with due application of safety codes and with a sense of relative permanence. Our system from that point forward may be arranged and rearranged with the very least potential hazard and in our view, the greatest possible available options, and potential for simple alteration and increased performance. With only 2 terminals which are intended to be double insulated, with a sealant and a cover and a warning label, or a sealed insulated covered voltage regulator in the interior of the Sentinel Advanced Control Module, the system can be rearranged without wet contact with voltage which is considered to be hazardous.

How long the described Bondy et al system will take to pay for itself cannot yet be precisely anticipated. It can be stated with certainty, however, that given time, it most definitely will.

### Mainframe, Modules and Sockets

We disclose a new embodiment of the multiple dimmer lighting system, which potentially in some embodiments or groups could be called a “low voltage outdoor lighting systems|.

This embodiment optionally includes a proprietary weatherproof spherical luminaire encasement FIG. 26-208 such that when the spherical luminaire encasement FIG. 26-208 is optimized for the inclusion of the Sentinel Advanced Control Module FIG. 25-200, that the Sentinel Advanced Control Module FIG. 25-200 be fitted via a split shell embodiment of the advantageous proprietary spherical luminaire encasement FIG. 26-208 by means of matching voids in the invertible top and bottom of said shells.

This embodiment is based on the original embodiment in prior U.S. patent application Ser. No. 10/999,917, ‘MULTIPLE DIMMER LIGHTING SYSTEM”, by the same inventors, Bondy et al., and the continuation-in-part prior U.S. patent application Ser. No. 11/723,445, “ENERGY SAVING EXTRA-LOW VOLTAGE DIMMER LIGHTING SYSTEM”, by the same inventors, Bondy et al, in which the original embodiment was comprised of a means of voltage regulation, rectification and modulation/dimming of a low voltage halogen lamp or color control and current modulation/dimming of a 3 color or other LED lamp. In the embodiment of claim 21, these capacities are individually provided for in modules which may be chosen depending on required or desired function. Also, importantly, Bondy et al claimed 3 color control in the original patent application Ser. No. 10/999,917.

Each Sentinel Advanced Control Module, whether fitted in the spherical luminaire or not, will include a dimmer module socket or installation location which will accept a single lamp dimmer module comprised of components for voltage modulation or a multi-color LED driver, and comprised of components for a 3-color LED emitter lamp, and comprised additionally of components for current modulation, and one embodiment is comprised of all of the above components in a single dimmer module.

Each Sentinel Advanced Control Module FIG. 25-200 is comprised of an internal mainframe structure with a greater than zero number of internal modules which will allow for multiple potential control functions, but that in the main the basic state of the embodiment will include:
a weatherproof means of encasement with front and back shells and gasket, and
with voids for required embodiments or voids for all embodiments and blanks for unused optional modules, and
a means of being securely fitted into the proprietary spherical luminaire encasement with top and bottom shell, and/or optionally a means of mounting on a stake or post and/or a means of surface mounting, and
a means of current overload protection, and
a microcontroller with a programmable CPU, and
a printed circuit board with all listed components and potentially sockets for all potential optional modules, and
a 5 volt power supply module, and
a means of power supply output via an output terminal strip or other conductor termination means, and
a means of power supply input via an input terminal strip, and
and via the input terminal strip a third communication conductor and termination means, and/or a fiber optic transmit and receive module including cable connector(s), and/or a wireless transmit and receive module, or alternatively to the above three means, and
a communications module, and
a push button module with accessible momentary contact buttons for the purpose of programming or actuating said microcontroller with programmable central processing unit (CPU), and
a liquid crystal or other display module, and
a means of accepting a switching or other power supply module for the isolation of low voltage greater than nominal 15 volts, and
a means of storing voice recognition programming, and any of the communication options are a means of increasing program and memory capacity, thus as voice recognition improves as it has thus far, the central processing unit (cpu) will be enlarged and with the microphone module and potentially the speaker module, the sentinel advanced control module can be made to recognize/distinguish one voice from another, and this will be a security and function advantage.

The described embodiment may be utilized to control or supply output energy to a greater than zero number of output terminals on the output terminal block and that the programming for the energization of said outputs can in the main be programmed via the described data input means and when fitted into a void or voids in the optional proprietary spherical luminaire encasement, can be made to provide the described outputs, and for the completion of the described luminaire, a lamp and a mounting grommet with supply lead to said lamp.

Importantly, said Sentinel Advanced Control Module FIG. 25-200 is formed and designed for the modular optimization of a greater than zero number of additional components which may be accurately described as function or function supply modules, and that the body encasement and the printed circuit PC board are purposely constructed as is a mainframe for a home computer, whereby modules or cards may be purchased as required or desired but said microcontroller with programmable CPU FIG. 39-242 is in the main supplied with required operating hardware.

In this embodiment, the mainframe with plug-in sockets or attachment locations allows for the inclusion of modules as described in this document but not limited to the modules described in this document. The component sockets or attachment locations may be industry standard and with ample conductor capacity to allow for a continuous addition of function modules, or as new devices are made available, they may be proprietary to Bondy et al or custom ordered to fit the existing sockets. It would also be possible to include an inexpensive patch cord for the purpose of connecting modules which can be utilized most efficiently in this way.

All of the capacities of the connectors and conductors may be upgraded to allow for current flow and ambient temperature ratings exceeding the described modules' capacities and output conductors chosen for maximum possible load as approved by governing agencies, but not less than National Electrical Code allows. A connector (not shown) is placed for a variety of potential cooling devices, if required.

The Sentinel Advanced Control Module FIG. 25-200 forms the operating system to which, as much as desired or required, possible functions may be interconnected. Voids are included with very low cost plastic blanks or a supply entry, and like the mainframe of a computer, increased functions or upgrades are possible. All of the above makes possible a wide variety of lamp control and control of other devices and supply not limited to what is included at time of purchase or assembly.

Thus the functions of the power supply have been brought to, or as close as practicable to, the locality of the lamps, the results of which are energy savings and greater range of energy saving and improved function control options, comprised of but not limited to the following, all of which may be optioned either during assembly or after purchase:
a module comprised of a means to provide a current limiter, over current protection and ammeter FIG. 21-265, and
two resistors to form a voltage divider FIG. 21-269, and
two diodes to cause voltage rectification of the power supply FIGS. 21-270, 271, and
a 12 volt power supply module FIG. 21-232, and
a communications module FIG. 21-234, and
a fiber optic transmit/receive module FIG. 21-236 including two connectors FIG. 252A, 252B for fiber optic data management and connection, and
a wet contact isolation power supply module for supply voltage inputs above nominal 15 volts FIG. 21-295, and
a battery charge control module FIG. 21-266, and
a battery fuel gauge module FIG. 21-267, and
an output over current protection and shutdown module FIG. 21-238, and
a battery array pack assembly module FIG. 253, and
a clock timer module FIG. 22-244, and
an audio video module FIG. 22-246, and
an LED and/or incandescent dimmer module with or without color control drivers FIG. 22-248, and
and switching modules Q1 FIG. 22-281, Q2 FIG. 22-282, Q3 FIG. 22-283, and
and a liquid crystal (or other) display module FIG. 22-220, and
and a narrow angle variable long range motion detector module FIG. 22-229, and
a photocell module FIG. 22-223, and
a wide range variable motion detector module FIG. 22-222, and
a video camera assembly module FIG. 22-224, and
a microphone module FIG. 22-225, and
a speaker module FIG. 22-226, and
a wireless data, audio and video transmit and receive (transceiver) module FIG. 23-227, and
a video monitor module (not shown).

By means of some of the above described components, the Sentinel Advanced Control Module FIG. 25-200 has the capacity to directly connect to an alternate power supply up to a nominal 12 volts, and via an isolating power supply module built for this purpose, a nominal 24 to 30 volts.

The elements, components, modules and sockets of the Bondy et al system selected from the list below are optional and can be combined in a variety of ways. This list of items is not intended to be limiting. Other items can and may be included in the description of various embodiments, including the most complete embodiment. Items on the circuitry panels are numbered and described in the Detailed Description of the Drawings.

Sentinel Advanced Control Module FIG. 25-200: Described in detail later in this document.

0.5 Sentinel Control Module FIG. 16-211: Described in detail later in this document.

Control Module FIG. 1B (9, 103, 113): From our prior application Ser. No. 11/723,445, the original embodiment of the Control Module FIG. 1B (9, 103, 113) is a means of lamp control within FIG. 1B-9 or as near as practicable to the luminaire FIG. 1B-103, 113, with dimmer function for incandescent or LED lamp. One embodiment of this Control Module FIG. 1B (9, 103, 113) is a means of controlling multi-color LED lamp output.

Lamp: An electrical lamp of any type which may be used for the purpose of architectural and/or landscape lighting for safety, security and/or aesthetics, and which is effectively dimmable at this time, or may become dimmable by means of a controlled variation frequency and/or voltage and/or current during the active period of this patent. Otherwise stated, dimming by frequency, voltage or current modulation and any combination of same.

Lamp A FIG. 23-272: A nominal 12 volt output for a multi-color LED lamp maximum 30 watts which is of variable current outputs for, in one lamp control embodiment, RGB LED's with common, and in another embodiment, white, red, amber/yellow LEDs with common, and with a group modulator with a variable means total lamp luminous output while maintaining the selected lamp color output controlled by outputs from the microcontroller with programmable CPU FIG. 39-242. Thus each of 3 power leads has a 10 watt supply capacity. Each share a common 30 volt return.

Lamp B FIG. 23-277: A nominal 12 volt DC terminal pair with a maximum 50 watt output with variable modulation by means of a means of variable voltage with a maximum nominal 12 volts maximum and a selectable minimum voltage output memory.

Lamp C FIG. 23-279: A nominal 12 volt terminal pair which is wide angle motion detector FIG. 30-222 actuated with a means of variable time delay ON. This output is one of all outputs which can be controlled by the microcontroller with programmable CPU FIG. 39-242.

Lamp D FIG. 23-280: A nominal 12 volt terminal pair with a means of photocell actuated output for dusk to dawn lamp function with override from the microcontroller with programmable CPU FIG. 39-242.

Luminaire FIG. 1B-1, 104, 105: A complete lighting unit designed to accommodate the lamp(s) and to connect the lamp(s) to circuit conductors.

Proprietary spherical luminaire encasement with two part housing FIG. 26-208 with the Sentinel Advanced Control Module included.

Proprietary spherical luminaire encasement with two part housing FIG. 12-207 with the 0.5 Sentinel Control Module included.

Proprietary spherical luminaire encasement with lamp only FIG. 43-214.

Pathway luminaire FIG. 41-309: A luminaire containing a lamp which is dimmable, potentially dimmable, or not designed for dimming, and which is designed to illuminate pathways composed of pavement, pavers, gravel, or any other underfoot natural, manufactured or processed material forming a pathway.

Beacon FIG. 41-304: A luminaire typically containing a low energy LED or other lamp which is dimmable, potentially dimmable or not designed for dimming, which serves primarily as an indicator for navigation or for delineation of a boundary.

Auxiliary beacon luminaire (not shown): an optional dusk-to-dawn auxiliary beacon luminaire located on the proprietary spherical encasement, or on the housing of any other lighting fixture, which operates independently, and uses minimal energy to provide safety on pathways, walkways or driveways while allowing other lamps to be de-energized.

Auxiliary beacon luminaire laser (not shown): an optional laser light output which is motorized for rotation or manually adjustable beam direction.

Garden luminaire FIG. 42-306: A luminaire which might also be used for path lighting, but intended for taller plants or to cover more area in a garden zone, it would be equipped with a taller post or stake for down lighting.

A multi color lamp: An electrical lamp of either multi color LED emitters type, or any other type of lamp, which can be made to output a greater than zero number of colours for the purpose of safety, function and/or aesthetics.

Proprietary LED lamp FIG. 9B: A proprietary mix of multi color singular or multiple LED emitters comprised of a means to approximate the color rendering index number and/or approximate the colour temperature of a halogen lamp. With a full range adjustment of each of three LED color or multi color outputs, or other very warm lighting output by other means.

A multi color LED lamp control FIG. 23-272: A control which has means of altering the emitted color or colors of LEDs, typically by altering the ratio of luminous intensity among three colour emitters, and once set as desired will have the dimming potential to shift color output and, due in part to the difference between the chosen emitter color efficacy, said lamp will shift towards red as halogen shifts to infrared.

A lamp driver circuit which produces the results described above by producing a desired ratio relative multiple output current to each of the three LED emitter outputs and also by modulating the percent maximum of each combination. Both color output and luminous intensity can be controlled.

Clock and timer module with multiple timer function FIG. 22-244.

Control assembly FIG. 17-241 for the 0.5 Sentinel Control Module FIG. 16-211 is comprised of the following encased in a substantially weatherproof housing: (i) clock and timer module; (ii) 3 weatherproof momentary contact push-button switches; (iii) a liquid crystal (or other) display module; (iv) a multiple input and a multiple output microcontroller with programmable CPU with memory, a cord and a 12-pin female connector.

Photocell FIG. 17-219: A 3-wire switched supply photo electric device which can be placed to detect a semi-continuous level of ambient light, and which is calibrated to accurately detect the presence of daylight or other light. The photocell may be located at the power supply or at each individual luminaire.

Photocell with V.O.C. (variable output capacity) FIG. 30-223: An electrically powered camera lens or photo-electric cell with a means of input connection, which has a means of detecting ambient light, and further a means of detecting a range of ambient light, and with a variable range of output voltage and means of connection by leads with a connector. A photocell which changes its resistance, or allows more current to flow through it as the light level increases. When made part of a voltage divider, with a resistor at the bottom, this produces a voltage which varies with the light level. The microcontroller has an A-D converter (analogue to digital converter) which converts the measured voltage into 1s and 0s that the microcontroller works with. Common A-D voltage steps are 256, 512 or 1024, possibly even high. All digital code is to the power of 2, which explains these values (i.e., 2 power 8=256 power 10=1024). The more steps in the A-D converter, the finer the resolution of measurement. In most cases, 512 or 1024 steps is adequate. For example, a room temperature thermometer would be more than fine with 256 steps.

Wide angle motion detector FIG. 17-222 and FIG. 30-222: A wide angle electrical motion sensing detector of singular or dual (or more) means of ascertaining the movement of humans or large animals, and with a means of input and output connection by leads with a connector.

Narrow angle variable long range motion detection FIG. 43-229, FIG. 22-229. This is an optional motion detector which may be used in addition to wide angle motion detector FIG. 30-222, allowing the Sentinel Advanced Control Module FIG. 25-200 within or not within a luminaire to be directed into the property for security, and making possible a longer range for the purpose of energy saving.

Microcontroller with programmable CPU (central processing unit) with a nominal 64 bit capacity (or any other capacity above or below 64 bit capacity) FIG. 39-242, FIG. 22-242: Can be programmed to control the actuation means of multiple lamp outputs and other outputs as required for various actuation means and multi-variable time segmentation with memory, and is suitable for memory upgrades via MP3 type or similar storage means, including pre-programmed lighting event control from professional designers.

Liquid crystal display FIG. 30-220.

Weatherproof momentary contact push-button switches FIG. 30-221.

Video camera FIG. 30-224.

Microphone FIG. 30-225.

Audio speaker or annunciator FIG. 30-226: An electrically powered means for producing an audible frequency or range of repeating frequencies purposely designed for the purpose of indicating or warning persons within audible range that there is a potential for loss or injury to persons, animals or property, and a means of connection to a compatible power supply, and the capacity to reproduce audible voice or sound.

Battery array pack(s) FIG. 34-253: A weatherproofed battery array assembly, or an assembly which may be suitably enclosed from weather, with positive and negative wire leads or other contact means. Standard size is 1.4 Amp hours at nominal 12 volts. In one embodiment the battery array pack FIG. 34-253 is easily and quickly removed for charging or replacement. Similar to portable power hand tools, the battery contacts are protected from falling water when upright. An auxiliary large capacity battery array 237 is optional and not shown.

Battery over current protection FIG. 21-238: Comprised of an adjustable means of charge current control for the purpose of limiting current either flowing to or from the battery array FIG. 21-253. Once overloaded, the circuit will open and a program in the microcontroller with programmable CPU FIG. 22-242 will display the current reached and potentially the battery temperature via a thermistor FIG. 22-233.

Battery charge controller module FIG. 21-266: An adjustable or pre-set means of controlling the flow of electrical current and/or voltage to a battery or battery array pack FIG. 34-253 for the purpose of storing electrical energy for use when needed.

Battery control and charger module 268 (not shown): A separate optioned detachable plug-in module comprised of a battery charge controller FIG. 21-266, fuel gauge FIG. 21-267, and battery over current protection FIG. 21-238, could be accessed behind one side of the battery array FIG. 34-253 of the Sentinel Advanced Control Module FIG. 25-200.

Current limiter, over current protection and ammeter module FIG. 21-265, which consists of a current limiter FIG. 21-292, over current protection FIG. 21-293 and ammeter FIG. 21-294.

Wireless data, audio and video transmit and receive (transceiver) module FIG. 23-227: An electrically powered complete assembly with a means of input leads or terminals, a means of detecting signals, and a means of converting audio and video input into wireless signals. The assembly can be fitted to the outer case of the Sentinel Advanced Control Module FIG. 25-200 and connected anywhere on the fibre optic cable, but for convenience, to a Sentinel Advanced Control Module FIG. 25-200 via a suitable fibre optic connector.

Remote control: A fibre optic remote control transmit receive (transceiver) module FIG. 21-236, or wireless remote control transmit and receive (transceiver) FIG. 23-227, or conductor connected remote control with programming capacity of one or more Sentinel Advanced Control Modules FIG. 25-200 for the purpose of turning ON or OFF the luminaire(s), increasing or decreasing the luminous intensity of the multi colored LED lamp(s), and/or a halogen or other lamp(s), and for the purpose of controlling the color output of the above LED lamp(s), and to control all functions of the Sentinel Advanced Control Module FIG. 25-200(s) by address, by program input or by default (where the default is the order as a measure of unloaded supply voltage in a string of Sentinel Advanced Control Modules) to each Sentinel Advanced Control Model microcontroller with programmable CPU FIG. 39-242.

Fibre optic terminal connectors FIG. 21-252A, FIG. 34-252A, and FIG. 21-252B, FIG. 34-252B, which form part of the optional fibre optic transmit receive module FIG. 21-236.

A means of adding portable or weatherproof speakers, power supply and signal, which may in future embodiments include a built-in amplifier by other. (Not shown.)

An internal voice recognition assembly with digital output, after market or of other manufacture. (Not shown.) The voice recognition assembly is placed in any convenient location and accessible by conductor, fibre optic cable or wireless transmit and receive (transceiver) FIG. 23-227.

Intercom (not shown): An optional function of the Sentinel Advanced Control Module FIG. 25-200 via the speaker FIG. 30-226 and microphone FIG. 30-225 and other component parts.

Power supply conductor (not shown): A conductor with a voltage and current rating, and an insulating and protective covering which is acceptable by National Electrical Code and marked for the purpose of outdoor power supply.

A double insulated cable such as NMWU, NMDU, or other appropriate cable. (Not shown.)

Power supply: An electrical power supply which is arranged with output terminals or leads for the purpose of safely supplying electrical energy, either AC or DC, but within the range of voltage described as extra-low voltage, and which at time of writing is from 0 to 30 volts AC or DC, and which is arranged to safely the supply voltage. National Electrical Code has designated 30 volts nominal (42.4 nominal momentary) to be the maximum for safe voltage not subject to wet contact.

Weatherproof power supply input terminal cover FIG. 35-255 for double insulation supply, and a data termination screw FIG. 35-235, and a means of double insulation via hardened gel, a gasket and cover. (Not shown.)

Isolated switch mode power supply SMPS module FIG. 24-295 with isolated SMPS encasement FIG. 24-296: Proprietary means of continuous isolation from wet contact to a maximum of 30 volts AC or DC.

Weatherproof PVC (or other) cable/box connector FIG. 35-261 for sealed cable entry.

Two 12 volt power output terminals with overload protection for use with a portable speaker or other device such as a portable PC (personal computer).

Power supply input terminals FIG. 20-256 for the 0.5 Sentinel Control Module FIG. 16-211.

Power supply input terminals FIG. 34-250 for the Sentinel Advanced Control Module FIG. 25-200. The said terminals are for conductors from the weatherproof supply conductor through a weatherproof PVC (or other) cable/box connector FIG. 35-261. Two outer terminals L1 and L2 FIG. 34-273, 274 are power inputs, the third in the center COMM FIG. 34-275 is for optional communication interconnection conductor.

Printed circuit PC board FIG. 29-210 for Sentinel Advanced Control Module FIG. 25-200.

Printed circuit PC board FIG. 19-249 for the 0.5 Sentinel Control Module FIG. 16-211.

Output terminal strip FIG. 34-251 for the Sentinel Advanced Control Module FIG. 25-200.

Output terminal strip FIG. 20-228 for the 0.5 Sentinel Control Module FIG. 16-211.

An alternate means of voice recognition input interface, if required, via communication terminal FIG. 34-COMM or via fibre optic connectors FIG. 34-252A, 252B which form part of the fibre optic transmit receive module FIG. 21-236.

A PC (personal computer), not shown, either stationary or portable, as for example, a laptop connected via fibre optic patch or into fibre optic connectors FIG. 34-252A, 252B which form part of the fibre optic transmit receive module FIG. 21-236.

Private or personal PA public announcement (not shown) via built in audio speaker FIG. 30-226 or via auxiliary output from audio (not shown).

Video monitor.

### Proprietary Multi-Emitter LED Lamp for Halogen Effect

From the Bondy et al prior application Ser. No. 11/723,445, our PAR 36 proprietary LED lamp FIG. 9B features one or more white LED, red LED and amber/yellow LED emitters. Thus by beginning with the appropriate white and adding red and amber/yellow emitters in correct proportions, light produced can be made to approximate results similar to halogen, and with dimming across all three colour outputs proportionately, the light color output because of varied LED efficacy will shift towards amber/yellow and red. The difference is great enough in the efficacy between white LED emitters and red and amber/yellow LED emitters that, with the reduction of current flow through all of the varied emitters, the white emitters would when compared to red emitters, produce proportionately less lumens per watt than the red, resulting in a color shift, and in doing so, approximate the shift which may be seen when dimming halogen lamps in which a similar color change results from energy for visible light, moving when dimmed closer to infrared.

However, this proprietary lamp or any multi-array 2 or 3 color multi-LED lamp can be precisely adjusted for each segment of output in a choice between 1 and 10 to 1 and 20, etc., so that dimming the lamp will produce a color shift which is most desirable to the user. We do not set any limits on the potential of multicolour lamps which may become available. We have described two options, including RGB LED lamps, but with 3 current modulated outputs, and any lamps which can be made to produce required or desired outputs by this means are included as potential function.

Reaching the desired light output, incandescent lamps with the best color rendering index (97 plus) typically have short life, ie., 1200 hours, and with efficiency of 16 lumens per watt produce a nominal 90% or more heat loss. The desired color rendering index is actualized with a near linear increase of spectral power across the 380 to 680 band. Thus the desired color rendering index is not reached with a rainbow array of color emitters, each at the same luminous intensity. Thus emitters of equal output may be grouped into relative fractions.

Our lamp embodiment shown in FIG. 9B indicates a proprietary mix of white, red and amber/yellow, and the output module is intended to function as a means of producing the same effect. At the time of the writing of our prior application, this was the chosen route to produce the relatively high color rendering index, but most importantly to imitate the halogen light effect for the purpose of the Intellectual Property associated with the re-creation of the halogen effect with multiple emitters. The intent was to be the first in the industry to claim said lamp, and with a glass lens to blend the emitter output to increase the similarity of a halogen lamp (and most definitely in the embodiment to 50 watt halogen).

In this Continuation-in-Part, beyond the Intellectual Property claimed of dimmers near, at or within luminaire (and of those embodiments, one which teaches 3 LED driver circuits), we increase the scope of the lamp dimmer and driver to include multi-colour output lamps within the outdoor luminaires such that the multi-colour outputs lamps or combination of lamps will, with either the driver in the lamp or in the Sentinel Advanced Control Module FIG. 25-200, but either way of remote control capacity, we combine the colour output component with the luminous intensity capacity and further with multi output staging and ramping.

The spectral power distribution of the lamps have outputs which range from ≧0.2 at 380 wave length nanometers, at a midpoint ±0.55 at 580 nanometers, to ±0.7 at 680 nanometers. The above indicates the desired color rendering index. It can be clearly seen that our Intellectual Property includes such lamps by nature of the simple fact that lamps are placed in luminaires, and if the lamps contain the capacity then this is an embodiment of our Intellectual Property.

### Brief Outline of the Different Control Modules

For clarity we offer the following: In our prior application Ser. No. 11/723,445, the original embodiment of the Control Module FIG. 1B (9, 103, 113) is a means of lamp control within or as near as practicable to the luminaire, and one embodiment of the Control Module is a means of controlling multi-color LED lamp output. These and all other original embodiments of the Control Module are still a viable means of lamp control.

In this Continuation-in-Part we further disclose, among others, two new embodiments (with variations and optioned elements, components, modules and sockets) of the original multiple dimmer lighting system. First, and of primary consideration in this application, the Sentinel Advanced Control Module FIG. 25-200 is the preferred embodiment, and the disclosures in this Continuation-in-Part are predominantly composed of material pertaining to the Sentinel Advanced Control Module FIG. 25-200. Second, the 0.5 Sentinel Control Module FIG. 16-211 describes a greatly simplified secondary embodiment. Both the Sentinel Advanced Control Module FIG. 25-200 and the 0.5 Sentinel Control Module FIG. 16-211 are encased in the same substantially weatherproof housing to be described later in this document.

In another embodiment, the Sentinel Advanced Control Module FIG. 25-200 functions are separated into a Master Sentinel Advanced Control Module (not shown) and a Remote Sentinel Advanced Control Module (not shown). The purpose for this embodiment is to reduce redundancy and manufacturing costs, and potentially to simplify programming, however the cost difference between a master microcontroller with programmable CPU and a remote processing unit is not estimated to be worth creating a two Sentinel system for interconnection. However, a so called ‘Master and Remote’ system can optionally be interconnected wherein the Master contains all of the input actuation components such as photo cell, motion detector or dual motion detectors (wide and narrow angle) and including all other described means: in short, a fully optioned Sentinel which sends data to microcontrollers with programmable CPUs in remote Sentinel Advanced Control Modules, thus potentially one or two Master Sentinel Advanced Control Modules, and the others Remote Sentinel Advanced Control Modules.

### 0.5 Sentinel Control Module

We disclose the 0.5 Sentinel Control Module FIG. 16-211 for outdoor lighting, and optionally irrigation, comprising a luminaire with a control assembly FIG. 17-241, a photocell FIG. 17-219, and a motion detector FIG. 17-222. The control assembly FIG. 17-241 for the 0.5 Sentinel Control Module FIG. 16-211 is comprised of the following encased in a substantially weatherproof housing: (i) clock and timer module; (ii) 3 weatherproof momentary contact push-button switches; (iii) a liquid crystal (or other) display module; (iv) a multiple input and a multiple output microcontroller with programmable CPU with memory, a cord and a 12-pin female connector. The 0.5 Sentinel Control Module may, when optioned, include the isolated switch mode power supply SMPS module FIG. 21-295 and isolated SMPS encasement FIG. 30-296.

With a voltage suitable for the intended lamps, the lamp outputs for other devices from the 0.5 Sentinel Control Module FIG. 16-211 may be further adjustable by means of the Control Module FIG. 1B (9, 103, 113) added to the lamp and supply conductors, providing a means for dimming of LED, incandescent or other lamps. Alternatively, a more simplified dimmer may be included in the 0.5 Sentinel Control Module FIG. 16-211, or alternatively outside the enclosure. Voltage regulation is also disclosed as a potential embodiment. As best seen in FIG. 21, an over-current module or fuse and a nominal 12 volt power supply would make possible voltages to nominal 15 volt AC and above with voltage regulation. The internal transmission voltage isolation power module would be mounted on the printed circuit PC board FIG. 19-249.

The 0.5 Sentinel Control Module FIG. 16-211 can be used to advantage where: area lighting is controlled independently; where there is no requirement of interconnection; where there is no requirement for security; and, where the 0.5 Sentinel Control Module FIG. 16-211 controls luminaires at a distance due to ground cover. For the above conditions the original Control Module FIG. 1B (9, 103, 113) could be utilized for either incandescent or LED without line losses associated with dimming over a distance at nominal 12 volts, but would be modified to allow the form fitting over voltage isolator.

In the main, this 0.5 Sentinel Control Module FIG. 16-211 is intended as a means of multiple lamp control, but may include multiple time set controlled for irrigation outputs. The 0.5 Sentinel Control Module FIG. 16-211 may be fitted into the proprietary spherical luminaire encasement FIG. 12-207 and/or energize other additional luminaires. The 0.5 Sentinel Control Module FIG. 16-211 may also be remote from the luminaires which it controls, and mounted on a garden stake or pole FIG. 20-260, fastened to a vertical or horizontal surface (including entrance ways), or in any other suitable manner. Since the 0.5 Sentinel Control Module FIG. 16-211 may be utilized without an attached or adjacent dimmer, it need not be located as close as practicable to the luminaires, but it is intended in the main, to be remote from the power supply. However the option provided by the 0.5 Sentinel Control Module FIG. 16-211 may be sufficient to upgrade existing systems.

The 0.5 Sentinel Control Module FIG. 16-211 provides an economical means of decentralizing lamp control from the power supply source to the individual luminaires, and to any number of required zones. The zones may then be set up for energy efficiency. Thus, one timed output may be utilized to provide aesthetic lighting. The motion detector FIG. 17-222 may be utilized to actuate the 0.5 Sentinel Control Module FIG. 16-211 for pathway, driveway or area luminaires, and the photocell FIG. 17-219 may be utilized to actuate low energy dusk to dawn beacons FIG. 41-304 all via the control assembly FIG. 17-241. Though very inexpensive to produce, when there are zones and multi-functions, the 0.5 Sentinel Control Module FIG. 16-211 can nevertheless provide purpose driven outdoor lighting at a fraction of the cost of systems of the same capacity controlled by a central power switching supply.

The power supply does not control the various potential luminaires. Instead the supply is run to zones and connected to the 0.5 Sentinel Control Module FIG. 16-211. Input to the control assembly FIG. 17-241 from the photocell FIG. 17-219 could be utilized, when actuated, to control the energization and de-energization of the primary luminaire via the control assembly FIG. 17-241, and optionally the pathway luminaire(s) FIG. 41-309, and optionally, by the same means, the beacon(s) FIG. 41-304. Each luminaire can be pre-set for desired function ON/OFF times. Some advantages which are made possible are the means to separate those luminaires, such as beacon(s) FIG. 41-304 in staging areas, which are desired or required to remain energized from dusk until dawn, from others which may be required or desired for settable periods of the evening for function or path lighting, and between the two are many variable options. Both control systems mentioned have a means of temporary over-ride. The optional motion detector FIG. 17-222 provides a further means of actuating the energization of the luminaire(s) and/or pathway luminaire(s) FIG. 41-309.

For the purpose of simplification the back of a printed circuit PC board FIG. 19-249 is shown with the following components:
i. Power supply Line 1 and Line 2 at input terminals FIG. 34-250 are distributed to the components as power supplies via the PC (printed circuit board) FIG. 19-249 and male pin connectors shown on the front of the printed circuit PC board FIG. 19-249.
ii. Switched outputs from motion detector FIGS. 17-222 and 3-wire photocell FIG. 17-219 are also routed from the cords and female connectors to the male connectors on the printed circuit PC board FIG. 19-249 and via printed circuits to the control assembly FIG. 17-241.
iii. All L#1 outputs to the output terminal strip FIG. 20-228 are routed via the printed circuits on the printed circuit PC board FIG. 19-249 from the control assembly FIG. 17-241 and again to the output terminal strip FIG. 20-228 pairs. Line 2 from the input terminal is routed by the printed circuit PC board FIG. 19-249 via printed circuits to all Line 2 outputs for each output terminal pair on the output terminal strip FIG. 20-228. The result is 6 pairs of output terminals on the output terminal strip FIG. 20-228.

Located on the printed circuit PC board FIG. 19-249 is a 3-pin male connector FIG. 19-243 for the photocell FIG. 17-219, a 5-pin male connector FIG. 19-245 for the motion detector FIG. 17-222, and a 12-pin male connector FIG. 19-247 for the control assembly FIG. 17-241.

The Control Module FIG. 1B (9, 103, 113) may be connected to any lamp output to provide dimming for incandescent, or the multi-color LED version of the Control Module FIG. 1B (9, 103, 113) may also be utilized to provide dimming for single, multiple or tri-color LED lamps.

The control assembly FIG. 17-241 outputs are designated T1, T2, T3, T4, T5 and T6. Each has multiple programmable ON and OFF set times for each day of the week. However, Line 1 (L1) output terminals may be pre-set to energize only when the described switching photocell Line 1 (L1) output supply conductor is energized, thus will not be energized during daylight. The output otherwise may be set night or day and will provide Line 1 output power to the terminal strip FIG. 20-228. The motion detector FIG. 17-222 input conductors are also connected to Line 1 and Line 2. The output lead from the motion detector Line 1 will only be energized when the motion detector FIG. 17-222 is activated for a pre-selected period of time. Because in the current description the supply power is nominal 12 volts AC, the supply leads are numbered Line 1 and Line 2. There are provisions for the connection of 6 conductors to Line 2. All the remaining terminals from 1 to 6 are energized via the control assembly FIG. 17-241. This provides for overnight staging area lighting, motion detector FIG. 17-222 actuated path or area lighting with time ON delay, and all outputs may be programmed ON for the preselected time set for each lamp each day of the week in concert with potential actuation from the photocell FIG. 17-219.

### Sentinel Advanced Control Module

We disclose a Sentinel Advanced Control Module FIG. 25-200. Each Sentinel Advanced Control Module FIG. 25-200 includes, or may optionally include, many control and function capacities and options, as follow but not limited to the following: (i) a means of transmission isolation and reduction of voltage input with an isolated switch mode power supply SMPS module FIG. 21-295; (ii) dual dimmers as part of the LED and/or incandescent dimmer control module FIG. 22-248; (iii) photocell with V.O.C. (variable output capacity) FIG. 30-223; (iv) wide angle motion detector FIG. 30-222; (v) a narrow angle variable long range motion detector FIG. 22-229, (vi) a clock and timer module FIG. 22-244 with multiple timer functions; (vii) a microcontroller with programmable CPU FIG. 39-242; (viii) audio/video security options; (ix) remote control via optional fibre optic transmit receive control module FIG. 21-236, wireless transmit and receive (transceiver) FIG. 23-227, or conductors; (x) voice recognition; (xi) optional single zone irrigation control FIG. 22-278; (xii) optioned battery array pack FIG. 34-253, battery charge controller module FIG. 21-266, and battery over current protection FIG. 21-238, and optional auxiliary large capacity battery array 237 (not shown).

The microcontroller with high capacity programmable CPU FIG. 39-242 of function and programmable large memory function serves as a means of storing lighting programs, irrigation programs, security programs, voice recognition programs, private or personal PA (public announcement), auto-on intercom communications, and a means of sending function data via wireless, fibre optic or wire conductors for synchronized lighting display and also for connection to existing or future security systems and home energy function control systems.

A completed system will provide for a myriad of functions but each Sentinel Advanced Control Module FIG. 25-200 may be optimized according to requirements. A ‘station’ is defined as a Sentinel Advanced Control Module FIG. 25-200 which fans out with supply conductors and makes possible the delineation of one area from another, either to limit area illumination or to ensure security coverage where the area to secure requires one or more audio/video placements. The term ‘station’ would therefore be considered a lighting, security, irrigation ‘area’.

Each station has the potential for the following and other programmable functions and options:
i. Output voltage regulation;
ii. Multiple output lighting control system:
   i. With a multicolour LED output control FIG. 23-272 and current modulated dimmer control as part of the LED and/or incandescent dimmer control Module FIG. 22-248;
   ii. An incandescent lamp control FIG. 23-277 with a voltage modulated dimmer control as part of the LED and incandescent control Module FIG. 22-248;
   iii. A motion detector output control FIG. 23-279; and
   iv. A photocell lamp output control FIG. 23-280.
iii. When optioned, dual dimmer capacity as part of the LED and/or incandescent dimmer control module FIG. 22-248;
iv. All the multiple output supplies which may be optioned may be actuated in multiple ways and by multiple means.
v. Various means of actuation of lighting: i.e, when optioned, wide angle motion detector FIG. 30-222 and, when optioned, a narrow angle variable long range motion detector FIG. 22-229; a microcontroller with programmable CPU FIG. 39-242; when optioned, photocell with V.O.C. (variable output capacity) FIG. 30-223; and a clock and timer module FIG. 22-244 with multiple timer functions;
vi. When optioned, an audio/video security system with, when optioned, voice recognition and, when optioned, interconnection capacity to provide a ‘wall of light’;
vii. When optioned, a staged security system, including an optional intercom, an optional audio alarm, and an optional entrance security upgrade;
viii. An output for the actuation of programmed irrigation zone control which can also be programmed as one stage of the security system;
ix. When optioned, an emergency security and lighting system with, when optioned, a battery array pack FIG. 34-253, battery over current protection FIG. 21-238 and battery charge controller module FIG. 21-266;
x. When optioned, interconnection via optional fibre optic cable and/or optional wireless transmit and receive (transceiver) and/or optional electrical connection conductor;
xi. Dramatic theatre-style programmable lighting for outdoor use;
xii. ‘Smart home’ or ‘smart building’ integration;
xiii. When optioned, PA public announcement capacity and security and music;
xiv. When optioned, intercom capacity;
xv. A voltage drop reduction and limiter control of considerable potential value on long pathways and other greatly extended path lighting, with optional auxiliary large capacity battery storage;
xvi. When optioned, a means for additional battery capacity for direct connection to solar panel or other alternate energy source, either AC or DC to 30 volts;
xvii. A weatherproof means of battery protection;
xviii. When optioned, a means of long distance functional lighting which reduces line losses by means of rechargeable battery arrays which charge during day and night.
xix. When optioned, an isolated switch mode power supply SMPS module FIG. 35-295, which provides a means of transmission overvoltage control, such that voltage which is considered unsafe for wet contact conditions can be double insulated and sealed during installation by authorized persons, leaving only voltage of nominal 15 volts or less accessible for alteration, and providing a means of determining voltage drop percentage, either on local display or remote.

The Sentinel Advanced Control Module FIG. 25-200 will provide for programming capacity for color output and luminous intensity control with dimming for a primary lamp A FIG. 23-272, and a secondary lamp B FIG. 23-277 which is also dimmable, to provide precisely what is required or desired for aesthetic purposes, and functional lighting for paths or areas which may be wide angle motion detector FIG. 30-222 actuated, or dusk till dawn via photocell with V.O.C. (variable output capacity) FIG. 30-223. The photocell with V.O.C. FIG. 30-223 can be utilized to create a program such that, as dusk is followed by night, the luminous intensity is reduced to provide a similar effect and energy saving.

Thus each Sentinel Advanced Control Module FIG. 25-200 may become a part of an expanding provision of dramatic lighting affects which is comparable to scene lighting experienced in live theatre performance, for special occasions, and now made affordable for residential enjoyment. With an ultimate capacity for refinement and subtle lighting, the system can also be pre-programmed for impressive lighting shows. With a number of Sentinel Advanced Control Modules FIG. 25-200 (for example, 5 said Modules) providing synchronized color and intensity timed changes, and each with the capacity to ramp up or down at the same or complementary speeds, the potential luminous intensity (when LED is chosen for the secondary lamp or lamps) of 20×50 watt halogen flood and spot lamps, and virtually unlimited choice of changing color combinations. In addition, path and beacon outputs may be utilized for scene lighting. The microcontroller with programmable CPU FIG. 39-242 and the optional remote connection to a central PC (personal computer), etc., makes estimating the size of the programming outputs and sequences too numerous to estimate.

The Sentinel Advanced Control Module FIG. 25-200 includes optional dual dimmers as part of the LED and/or incandescent dimmer control module FIG. 22-248, as will be described, and these include:
i. An LED lamp color control for multiple LED emitters and also luminous intensity control by current modulation, as will be described; and
ii. A dimmer which functions for a lamp or lamps, which may by dimmed by voltage modulation. At the time of this disclosure, this includes many types of lamps, including among others, halogen, LED and fluorescent lamps.

The Sentinel Advanced Control Module FIG. 25-200 has multiple nominal outputs as follow (but not limited to the following):
Lamp A FIG. 23-272 and/or Lamp B FIG. 23-277 within a luminaire can be made to serve aesthetic, path, area lighting function with the advantage that the luminous intensity of the lamp or lamps is adjustable.
Lamp A FIG. 23-272, actuated by means of an optional narrow angle variable long range motion detector FIG. 22-229, or by means of an optional wide angle motion detector FIG. 30-222, or by means of an optional photocell with V.O.C. (variable output capacity) FIG. 30-223, is a 4-wire multi-color LED control with a 30 watt (3×10 watt) maximum capacity. The lamp is dimmed by means of current flow modulation or variation. It can be utilized to energize multiple lamps of multi color with the advantage that only the desired or required luminous intensity need be selected. By default, Lamp A FIG. 23-272 is energized via the clock and timer module FIG. 22-244 program with microcontroller with programmable CPU FIG. 39-242 for days of the week and multiple periods for each day, by default, but it may also be energized by means of the wide angle motion detector FIG. 30-222 with or without the time set. The microcontroller with programmable CPU FIG. 39-242 may be programmed to alter the aesthetic luminaire output.
Lamp(s) B FIG. 23-277, actuated by means of an optional narrow angle variable long range motion detector FIG. 22-229, or by means of an optional wide angle motion detector FIG. 30-222, or by means of an optional photocell with V.O.C. (variable output capacity) FIG. 30-223, is any 12 volt lamp(s) with dimming by voltage variation or modulation, with the following options, to a 50 watt combined maximum: (i) A single halogen or similar lamp; (ii) Multiple lower energy lamps; (iii) Both (i) and (ii) but potentially LED or fluorescent or any lamp or lamps which may be dimmed by means of voltage output variation or modulation. Lamp(s) B FIG. 23-277 is intended to be energized for pre-selected time periods for each day of the week, by default. However the Lamp B FIG. 23-277 output may be programmed for energization by means of both optional motion detectors.
Lamp(s) C FIG. 23-279, energized by the optional photocell with V.O.C. (variable output capacity) FIG. 30-223, serves pathway or area lighting and has a total capacity of not more than 50 watts. By default, it is energized by means of a wide angle motion detector FIG. 30-222 by default, and can be set for an ON delay for a pre-selected period. Lamp(s) C FIG. 23-279 may be actuated by the wide angle motion detector FIG. 30-222. The clock and timer module FIG. 22-244 with microcontroller with programmable CPU FIG. 39-242 can be time set for these luminaires with or without the wide angle motion detector FIG. 30-222 function. Lamp C FIG. 23-279 may be a pathway luminaire FIG. 41-309 as described in this document, or it may be a lamp/luminaire for area lighting.

Lamp(s) D FIG. 23-280 attached to a luminaire(s) operates as a beacon FIG. 41-304 either for path delineation or as a staging for path or area lighting. It has a capacity of not more than 20 watts. By default, the dusk to dawn energization is controlled by the photocell with V.O.C. (variable output capacity) FIG. 30-223. The microcontroller with programmable CPU FIG. 39-242 can be programmed for time ON/OFF function, or it is possible to energize the output by means of the microcontroller CPU FIG. 39-242 by any of the means described in this document.

The microcontroller with programmable CPU FIG. 39-242 with daylight sensed by the photocell with V.O.C. (variable output capacity) FIG. 30-223 will de-energize any lamps which are still energized during daylight. This default can be set to override from default. There are other optional means of lamp control for Lamps A, B, C, and D, and these include but are not limited to: voice recognition; wireless remote; wireless or fibre optic or electrical conductor remote monitor and control station. The Sentinel Advanced Control Module FIG. 25-200 also has the capacity to accept digital and analog commands. Further control and function capacities and options will be described later in this document.

The Sentinel Advanced Control Module FIG. 25-200 can be form fit mounted in the proprietary spherical luminaire encasement, and has the capacity to energize other additional luminaires. The Sentinel Advanced Control Module FIG. 25-200 may be remote from the luminaires which it controls, and mounted on a garden stake or pole 260, fastened to a vertical surface (including entrance ways), or in any other suitable manner. However, for dimming, the Sentinel Advanced Control Module FIG. 25-200 must be located as close as practicable to dimmed lamps, or care must be taken to select appropriate conductor size.

Throughout this application, with respect to the Sentinel Advanced Control Module FIG. 25-200, a photocell 219 may be used in the Sentinel Advanced Control Module FIG. 25-200 instead of a photocell with V.O.C. (variable output capacity) FIG. 30-223, which is optional. The disclosed embodiment is not intended to be limited to a photocell with V.O.C. (variable output capacity).

### Irrigation

Some of the options provided for as listed may appear as a form of over engineering but one example to indicate otherwise is irrigation. As is known in the landscaping industry and best practice for watering and water conservation, and also for compliance with irrigation by-laws, typically, water piping is laid out to provide various types of irrigation including sprinklers and drip systems. These automated systems have actuated water valves of one type or another and the actuating devices are placed to most efficiently control the irrigation. Irrigation devices very often include the following: (a) suitable pipe; (b) pop-up sprinklers; (c) drip irrigation; (d) actuated water valves; (e) power supply conductors; (f) a low voltage power supply; (g) a means of programming the number of days of the week, which will include watering and a means of pre-selecting the day and hour or minutes for each irrigation zone.

Thus a moderate size security lighting system can be utilized to cover the requirements listed in item (g) above. The increased manufacturing cost for an additional switched output in the power output supply module may add an estimated $0.50 to the production cost, eliminating the cost of supply conductors from a distant supply location, an additional power supply; and an additional means of programming. The reduction of redundancy is a reduction of wasted energy.

We disclose an additional pair of 12 volt terminals for the timed irrigation water valve FIG. 23-278 on the Sentinel Advanced Control Module FIG. 25-200, which is controlled by means of the microcontroller with programmable CPU FIG. 39-242 for day(s) of the week, hours, minutes, etc., to actuate the irrigation water valves for a single zone or multiple zones depending on pressure requirements and other factors. The Bondy et al disclosure is suited for this irrigation purpose, as it includes the following improvements, some of which are not otherwise available: wide angle motion detector FIG. 30-222 delay override; voice command override and high limit temperature override with ON function reset with overcast input from the photocell with V.O.C. (variable output capacity) FIG. 30-223, additional battery storage and battery charge controller module FIG. 21-266 rated for 50 watts/hour. The proprietary spherical luminaire encasement housing provides for weatherproof and non-conducting safety enclosure or may be lined with equivalent if metal. And as-built venting potential. Thus the automated irrigation system is made available in off-grid locations with any number of the optional Sentinel Advanced Control Module FIG. 25-200 components.

The Bondy et al irrigation control can also be interconnected with an existing sprinkler system on the property. The Sentinel Advanced Control Module FIG. 25-200 will send a signal to activate or deactivate the portion of the sprinkler system not directly controlled by the Sentinel Advanced Control Module FIG. 25-200.

### Pathway Luminaires

A pathway luminaire FIG. 41-309 is a luminaire containing a lamp which is dimmable, potentially dimmable, or not designed for dimming, and which is designed to illuminate pathways composed of pavement, pavers, gravel, or any other underfoot natural, manufactured or processed material forming a pathway. By separating the provision of aesthetic illumination from the provision of illumination for safety, function and security for pathways, driveways, or any area, considerable additional energy may be saved because each lighting area can be provided, if required, with a means of area and or pathway illumination which and can be separately controlled.

The primary luminaire output is designed for a lamp(s) which is dimmable, and to provide light for aesthetics, however, it may also produce illumination for safety and function. The pathway luminaires FIG. 41-309 are designed for safety and function but may also produce pleasing aesthetic effects. The pathway luminaire FIG. 41-309 is intended to allow vision of paths, walkways and driveways such that tripping or stumbling or any type of visible hazard might be avoided. However, a pathway luminaire FIG. 41-309 may serve to illuminate low lying plants and landscape sculptures, etc., and while energized in some areas lighting can be provided for aesthetic effect. Thus pathway luminaires FIG. 41-309 in these aesthetic areas may be supplied by terminals intended for aesthetic lamps or be supplied with the designated motion detector terminals, but during pre-set evening hours some of the pathway luminaires FIG. 41-309 will be integrated with aesthetic lighting until the set time lapses.

The pathway luminaire FIG. 41-309 typically consumes less energy than a luminaire for intentional aesthetic effect, for example, 2.5 watt/hour LED (for comparison 7.5 watt/hour halogen), which typically can be placed to illuminate one meter of a pathway, although in some placements lamps of higher energy capacity may be required. The maximum capacity for a combination of lamps must be within the load capacity of the power output components and modulators within the Sentinel Advanced Control Module FIG. 25-200. Regardless of the number of luminaires, each output terminal pair has a maximum limit which cannot be exceeded. The described Sentinel Advanced Control Module FIG. 25-200 is representative of one power output capacity and increased capacity is a likely requirement. With a combined capacity of 200 watts it may be most efficient to use all four terminal pair outputs for path and area illumination.

Each portion of a path, walkway, stairway or patio may be provided with the luminous intensity which will provide ground illumination as required or desired. Pathway luminaires FIG. 41-309 are purpose designed for this application. Once chosen and placed, the illumination cast on the path or gravel may be completely automated, to be actuated for energization by the time set capacity of the clock and timer module 244 and the programmable CPU FIG. 39-242, or the wide angle motion detector FIG. 30-222, or the photocell with V.O.C. (variable output capacity) FIG. 30-223, or any combination of the above, when used with a Sentinel Advanced Control Module FIG. 25-200.

With the Sentinel Advanced Control Module FIG. 25-200 all pathway luminaire(s) FIG. 41-309 lamp outputs are energized by the setting of the microcontroller with programmable CPU FIG. 39-242, although the output terminals designated for path and area luminaires default to wide angle motion detector FIG. 30-222 actuation. With the 0.5 Sentinel Control Module FIG. 16-211, pathway luminaires FIG. 41-309 are energized by the wide angle motion detector FIG. 30-222, the control assembly FIG. 17-241, or the photocell 219, as these are the actuation means for energization via the control assembly.

### Beacons

A beacon FIG. 41-304 is a luminaire typically containing a low energy LED or other lamp which is dimmable, potentially dimmable or not designed for dimming, and which serves primarily as an indicator for navigation or for delineation of a boundary. Thus, persons making an approach to a pathway may find the entrance clearly delineated. The power to supply a beacon FIG. 41-304 is considerably less than a typical luminaire because the beacon FIG. 41-304 is not intended or constructed to illuminate other objects, but to serve as a marker for direction and location.

The pathway and driveway entrance can be delineated with a number of beacons FIG. 41-304, for example, 20 LED beacons FIG. 41-304 of 0.5 watt/hour. Thus, with these energized and connected to the dusk to dawn output, then a 10 watt/hour nightly energy draw results in a very small amount of energy consumption.

Low energy beacons FIG. 41-304 can be made to serve a dual purpose for staged lighting and decorative aesthetics. The beacons FIG. 41-304 may be of a variety of designs, and can be fastened to surfaces, horizontally and vertically. They may serve to mark yard or garden items which might be damaged if accidentally stepped upon, such as Sentinel Advanced Control Modules FIG. 25-200. They also can be made to serve aesthetic purposes (for example, as Christmas lights), or to light key locks, etc. With as few as 5 Sentinel Advanced Control Modules, seasonal lighting may require only some color output adjustment and/or color lenses for the maximum 50 watt lamp.

The beacon may serve to delineate the path, walkway or driveway such that persons navigating such byways may avoid during darkness straying from the intended path, similar to the purpose served by runway beacons at airports. Those persons on foot who arrive at a time when the staged area aesthetic luminaires are de-energized will, with correct placement and intensity, find some safety in the limited light provided for this purpose by the beacons FIG. 41-304.

By default, the beacon(s) FIG. 41-304 dusk to dawn operation is controlled by the photocell with V.O.C. (variable output capacity) FIG. 30-223, when used with a Sentinel Advanced Control Module FIG. 25-200, or a photocell 219 when used with a 0.5 Sentinel Advanced Control Module FIG. 16-211. The clock and timer module FIG. 22-244 with the microcontroller with programmable CPU FIG. 39-242 can be programmed for time ON/OFF function when used with a Sentinel Advanced Control Module FIG. 25-200, or a control assembly FIG. 17-241 when used with a 0.5 Sentinel Control Module FIG. 16-211.

The beacons FIG. 41-304 can be fastened to the proprietary spherical luminaire encasement or to the Sentinel Advanced Control Module FIG. 25-200. In the embodiment with the Sentinel Advanced Control Module FIG. 25-200 located outside the luminaire, the beacon FIG. 41-304 is mounted on the upper surface of a Sentinel Advanced Control Module FIG. 25-200 for decorative or practical purposes.

### Auxiliary Beacon Luminaire

We disclose an optional dusk-to-dawn auxiliary beacon luminaire (not shown). The auxiliary beacon luminaire can optionally be located on the proprietary spherical encasement, a location which will allow for the auxiliary beacon luminaire to be seen when the spherical encasement is partially covered with ground cover. In other embodiments, the auxiliary beacon luminaire is located on the housing of any other lighting fixture.

The auxiliary beacon luminaire is additional to, and operates independent of, the primary lamp, the LED lamp, the pathway and beacon luminaire(s), but would serve well if also connected to the output terminals for Lamp D for photocell actuated output for dusk to dawn lamp function with override from the microcontroller with programmable CPU FIG. 39-242. The auxiliary beacon luminaire can be either of blue light for security enhancement, or blue as desired, or any other color.

The auxiliary beacon luminaire serves two purposes. The main and first purpose is to cast light on pathways in order to allow for pedestrian or vehicular passage with increased safety. The auxiliary beacon luminaire is most intended to allow or improve vision of pathways, walkways and driveways such that tripping or stumbling or any type of visible hazard might be avoided. The auxiliary beacon luminaire also serves to delineate the pathway, walkway or driveway such that persons navigating such byway during darkness may avoid straying from the intended pathway, walkway or driveway, similar to the purpose served by runway beacons at airports. As above, however, those persons on foot who arrive at a time when the primary lamp is de-energized will, with correct placement, illumination and intensity of the auxiliary beacon luminaire, find safety in the limited light provided for this purpose. The independent operation of the auxiliary beacon luminaire, which uses minimal energy, allows for energy savings by providing safety on pathways, walkways or driveways while allowing the main lamps to be de-energized.

### Auxiliary Beacon Luminaire Laser

We disclose a second type of auxiliary beacon luminaire for laser light, such as may be best described in comparison to a lighthouse wherein a beam of light is motorized for continuous rotation. The source of light for can be any of the available laser light sources, of any color, now available or available in the future, however with the inclusion of, as said, a means of motorized or manually adjustable beam direction. Pathway, walkway, driveway and roadway(s) can be delineated in this way. The laser light output can be actuated by a greater than zero number of devices, and also, the movement of the laser light can be made to follow a pre-selected path for a pre-selected duration by means of said actuator(s), and programming of the Sentinel Advanced Control Module FIG. 25-200 microcontroller with programmable CPU FIG. 39-242, and the electric or electromechanical beam direction mechanism, for a greater than zero number of purposes, and motion detection and other actuation can be utilized to prevent injury for safe function. Security can be increased to great advantage by said light beams owing to the distance from which an erratic beam movement would become noticeable from a great distance, and also that homes or locations in any way secluded, or otherwise, would be far more likely to be noticed by law enforcement or even simply the general public from said distance. One color such as blue or red, for example, could become recognized for this purpose, and the ON/OFF duration or flash frequency and interval periodicity could be established and used only for the purpose of security warning and indication of danger and/or a need for help, as has historically been indicated by the signal S.O.S. The laser light output can optionally also be utilized or included during a light show for dramatic aesthetic effect.

Staging Examples with Pathway Luminaires and Beacons

As described in this document there are several options available for the control and energization of the pathway luminaires FIG. 41-309. We provide an example of energy conservation as follows: With a provision made for reaching the illuminated area, then once this staging area is reached the Sentinel Advanced Control Module FIG. 25-200, either within the proprietary spherical luminaire encasement or mounted apart from it, the wide angle motion detector FIG. 30-222 can be placed such that, once illuminated, the path can be safely followed and, if required, another Sentinel Advanced Control Module FIG. 25-200 wide angle motion detector FIG. 30-222 may be actuated. Or, with a Sentinel Advanced Control Module FIG. 25-200 at either end, the path may be illuminated from end to end, but importantly the path may also be illuminated by power supplied from a Sentinel Advanced Control Module FIG. 25-200 which is not in any way located for motion detection. This is made possible by the interconnection of the microcontroller with programmable CPU FIG. 39-242 and any of the 3 actuation means described.

Thus, the outdoor lighting is staged:
i. Beacon(s) FIG. 41-304 for delineation, decorative aesthetics and path staging;
ii. Pathway luminaire(s) FIG. 41-309 for pedestrian pathways or vehicular driveways;
iii. Area lighting for any purpose;
iv. Aesthetic lighting (Lamp(s) A, FIG. 23-272) with variable color output, variable luminous intensity, for aesthetic and potentially for path and area lighting.
v. Aesthetic lighting (Lamp(s) B, FIG. 23-277) for variable illumination, and can also serve as path or function illumination.

The light staging results in considerable energy conservation while providing nearly limitless potential combinations for aesthetic, delineation and functional lighting. The beacons FIG. 41-304 might be very close to the property line and thus only a step or two into the stage area would result in a wide angle motion detector FIG. 30-222 energizing pathway illumination. Independent operation via the wide angle motion detector FIG. 30-222 of the primary lamp/luminaires or pathway luminaire FIG. 41-309 uses minimal energy and allows for energy savings by providing safety on paths, walkways or driveways only for the required time the primary lamp/luminaire is energized.

The beacon FIG. 41-304, followed by the pathway luminaire FIG. 41-309, is an energy saving staged system, where the primary lamp/luminaires are ON for a certain number of hours and then are de-energized, while the low energy beacon(s) FIG. 41-304 by default remain ON. When the primary lamp(s)/luminaire(s) supply power is interrupted, the beacons FIG. 41-304 continue to be fully energized until the photocell with V.O.C. (variable output capacity) FIG. 30-223 de-energizes the beacons FIG. 41-304.

12 Volt Lamp Dimming with a 12 to 15 Volt Transformer

The use of a dimmer or dimmers at the power supply location for 12 volt lamps will require ever larger supply conductors with increased distance. With our system a voltage regulator allows for nominal 15 volts. In addition, the battery array pack method not only makes very long runs practical, but it makes adhering to National Electrical Code limits on conductor line losses a realistic expectation. This portion of National Electrical Code has not been applied to extra-low voltage lighting but this could change.

We do not see how it could be possible to control the waste of energy for lighting systems if the luminous intensity in each area cannot be controlled. The lamp either matches the need perfectly off the shelf or, more likely, produces either more or less luminous intensity than desired or required. Thus we have designed a system to completely decentralize the area lighting and function control.

The primary lamp is connected to a terminal strip on the back of the Sentinel Advanced Control Module FIG. 25-200, and there is a second dimmer for a secondary lamp. The former terminals have provisions for a 4-conductor lamp supply for multicolour LED or future lamps which may be suitably provided for via current control. The pathway luminaire supply terminals are not dimmed at a nominal 50 watts 12 volts for one or multiple pathway luminaires FIG. 41-309, limited only, in future embodiments, by the National Electrical Code for extra-low voltage current maximum.

The Sentinel Advanced Control Module FIG. 25-200 is a 200 watt embodiment. The National Electrical Code limit for low voltage outdoor lighting systems is 20 amps and nominal 15 volts, and requires that there be no conductors from the Sentinel Advanced Control Module FIG. 25-200 which exceed the above current. We believe it to be self-evident that each embodiment of the Bondy et al system can range in power handling capacity from a very small unit of 5 watts to the maximum allowable by National Electrical Code. With the nominal 15 volt calculation, the capacity of the Sentinel Advanced Control Module FIG. 25-200 would be as high as 300 watts, and with 30 volts it would be 600 watts. Systems of this capacity may become desirable for energy conservation for special applications. Transmission voltage isolation FIG. 21-295 is provided above nominal 15 volts to maximum nominal 30 volts.

### Energy Savings Example

With respect to energy savings, the following example illustrates an aspect of the energy saved by a staged system. For the purpose of this example, the residential outdoor lighting layout has 20 PAR 36 LED lamps in luminaires, with 20 LED pathway luminaires FIG. 41-309. The estimated energy usage of each pathway luminaire FIG. 41-309 is 2.5 watt/hour from dusk-to-dawn. When staging is included, the beacon(s) FIG. 41-304 is employed, requiring for example, 0.5 watt/hour LED.

All luminaires are programmed to turn ON at 8:00 pm. All pathway luminaires FIG. 41-309 will remain ON from 8:00 PM until 6:00 AM Luminaires #1, 2, 3, 4, 5, 6, 7, 8 are placed to illuminate the driveway, however, luminaires #2, 6, 7, 8 are floodlight embodiments and so they are programmed to be ON for 3 hours until 11:00 PM, while luminaires #1, 3, 4, 5 are down lights and are programmed to be ON for 2 hours until 10:00 PM. Luminaires #9, 10 are mounted as down lights under shed eaves, and are programmed to be ON for 4 hours until 12:00 PM. Luminaires #11, 12 are step mounted down lights and they are programmed to remain ON for 6 hours until 2:00 AM. Luminaires #13, 14, 15, 16, 17, 18 are pathway lights with a similar mix of up lights and down lights such that Luminaires #13, 15, 17 and 19 are up lights and remain ON for 3 hours until 11:00 PM, while Luminaires #14, 16, 18 and 20 are down lights and remain ON for 2 hours until 10:00 PM. Thus a total of 2 luminaires are ON for 6 hours, 2 luminaires are ON for 4 hours, 8 luminaires are ON for 3 hours, and 8 luminaires are ON for 2 hours. (Note that these ON and OFF times are chosen by way of example. Other ON and OFF times might be specified.)

All of the 20 LED lamps in the luminaires have a maximum draw of 16.66 watts with 48 lumens per watt, thus 799.68 or a nominal 800 lumens per lamp. The maximum energy of the primary lamp/luminaire system is 20 lamps×16.66 watts=333.2 watts. At 800 lumens per lamp, the total luminous intensity of 20 primary lamp/luminaires would equal 16,000 lumens, which is the approximate equivalent of 20×50 watt halogen lamps assuming 16 lumens per watt. However, because each lamp in the luminaires is dimmable, we assume for the purposes of this example that when dimmed, the average lumen output is 600 lumens per lamp and the average energy consumption per dimmed LED lamp is thus 12.5 watt/hour. Additional dimming would further decrease average luminous intensity and energy consumption.

For the purpose of clarity and with the view that marketing of LED products has given rise to a very wide range of claims made with regard to the efficacy of LED lamp light as measured in lumens, the following describes the assumptions and calculations we have made with respect to the efficacy of our proprietary LED lamp FIG. 9B design. First, we consider it reasonable to assume 16 lumens per watt as an average from nominal 12 volt halogen lamps. Second, for the purpose of calculating the efficacy of our proprietary LED lamp FIG. 9B design, we think that, owing to the simple design of the proprietary LED lamp FIG. 9B in our embodiment, composed of three colors (red, white and amber/yellow) of multiple LED's which make up the total, the following calculation is reasonable. Our first colour, red, is rated at the highest efficacy when produced by LED emitters. Our second color, amber/yellow, is less productive than red, but the third colour, white, is considerably less productive than the prior two, red and amber/yellow. The ratio is estimated as follows: Given the RGB sources of white light, the ratios of the three colours stand in proportion (eg., 20 red, 6 blue and 10 green). Our proprietary LED lamp is composed of a proprietary mix of white, red and amber/yellow emitters. Thus we consider it reasonable that when our proprietary lamps are compared to RGB, the output will be equal or greater than that of this RGB combination. Given that RGB combination LEDs are claiming considerably more than 60 lumens per watt, we think that at the time of this writing, we may safely claim 48 lumens per watt. Thus for the purpose of this document, halogen will be stated as nominal 16 lumens per watt, and our combination multi-LED lamp as nominal 48 lumens per watt. The ratio will then be calculated as 1 to 3. Thus a nominal 12 volt 50 watt halogen will produce a nominal 800 lumens, and the nominal 800 lumens will be developed by our 16.66 watt proprietary LED lamp FIG. 9B.

The power consumption of the staged system is estimated as follows: Each lamp is a nominal 800 lumens or 16.66 watts/hour, however when dimmed, each lamp is a nominal 600 lumens or 12.5 watt/hour. Thus, 20 dimmed lamps is equal to a nominal 250 watt/hour. From our example, with dimming, a total of 2 luminaires are ON for 6 hours, luminaires are ON for 4 hours, luminaires are ON for 3 hours, and 8 lamps/luminaires are ON for 2 hours. Thus:
2 lamps at 12.5 watt/hour for 6 hours is equal to 150 watt/hour;
2 lamps at 12.5 watt/hour for 4 hours is equal to 100 watt/hour;
8 lamps at 12.5 watt/hour for 3 hours is equal to 300 watt/hour;
8 lamps at 12.5 watt/hour for 2 hours is equal to 200 watt/hour;

From the above the total nightly power requirement of the 20 primary lamp/luminaires can be approximated as: 750 watt/hour or 0.750 kilowatt/hour per day; thus 273 kilowatt/hour per year.

Therefore, comparing to equivalent halogen energy consumption:
1^{st} hour total: 20 lamps/luminaires, 250 watt/hour, 12,000 lumens: equivalent to 750 watt/hour halogen;
2^{nd} hour total: 20 lamps/luminaires, 250 watt/hour, 12,000 lumens: equivalent to 750 watt/hour halogen;
3^{rd} hour total: 12 lamps/luminaires, 150 watt/hour, 7, 200 lumens: equivalent to 450 watt/hour halogen;
4^{th} hour total: 10 lamps/luminaires, 125 watt/hour, 6,000 lumens: equivalent to 375 watt/hour halogen;
5^{th} hour total: 2 lamps/luminaires, 25 watt/hour, 1,200 lumens: equivalent to 75 watt/hour halogen;
6^{th} hour total: 2 lamps/luminaires, 25 watt/hour, 1,200 lumens: equivalent to 75 watt/hour halogen;

From the above the total nightly power requirements of 20 halogen lamps can be approximated as: 2,475 watt/hour or 2.475 kilowatt/hour per day, and thus 903 kilowatt/hour per year.

Considering 20 primary lamp/luminaires only, with an average daily run time of 5 hours, this would result in an annual energy reduction of approximately 630 kilowatt/hour per year. Further, by reducing the average luminous intensity with further dimming to say 400 lumens (8.33 watt/hour), then an additional 33% reduction of energy use would be realized.

In addition, the nightly energy consumption of the 20 pathway luminaires FIG. 41-309 in our example is calculated as 20 pathway luminaires FIG. 41-309 at 2.5 watt/hour for 10 hours, or 500 watt/hour per day. The total daily draw of our example of 20 lamps in luminaires, plus 20 pathway luminaires FIG. 41-309, which produces safe passage all night, is thus 750 watt/hour per day plus 500 watt/hour per day equaling 1250 watt/hour per day or 1.250 kilowatt/hour per day and thus 456 kilowatt/hour per year, approximately. Compared to the equivalent of 750 watts halogen at 2.475 kilowatt/hour per day (903 kilowatt/hour per year), this would result in an annual energy reduction of approximately 447 kilowatt/hour per year with an average daily run time of 5 hours for the 20 primary lamp/luminaires, and 10 hours for the 20 pathway luminaires FIG. 41-309. Further, by reducing the average luminous intensity of the lamps in the luminaires with further dimming to 400 lumens (8.33 watt/hour), then an additional 33% reduction of energy use would be realized.

This system for a residential application would be considered very large by residential outdoor lighting industry standards. By comparison, the first two hours of luminous intensity would approximate 20 automobile headlights dimmed by 75%, but the above comparison is based on the average luminous intensity of the lamps, whereas each individual lamp/luminaire in our system would be set according to the required or desired luminous intensity at each lamp/luminaire location.

The described comparison of two methods of lighting does not include the use of the optional wide angle motion detector FIG. 30-222 and/or beacon(s) FIG. 41-304. Since this staged lighting method will be described in detail later in this document, the improvement in efficiency can be made very precisely and concisely. The pathway luminaires FIG. 41-309 are moved from the dusk to dawn output of the Sentinel Advanced Control Module FIG. 25-200, and connected to the motion detector output terminals. Next, four 0.5 watt/hour beacons FIG. 41-304 are connected to the dusk to dawn output terminals. With strategic placement, the beacons FIG. 41-304 allow for visual direction onto the path and driveway areas. Then, opening the door to leave the residence actuates an energization of all of the pathway luminaires FIG. 41-309. We estimate 30 minutes per day of required illumination along the pathway after dark.

Thus the energy consumption of the pathway luminaires is:

20 luminaires×2.5 watt/hour×0.5 hours=25 watt/hours per day.

The energy consumption of the beacons is:

4 beacons×0.5 watt/hour×10 hours=20 watt/hours per day.

Total energy consumption=45 watt/hours per day.

This results in an additional reduction in energy consumption of 455 watt/hours per day, or 166 kilowatt/hours per year. The entire system in this example would then have a total energy consumption of 456 kilowatt/hours per year (from earlier calculation) minus 166 kilowatt/hours per year, equaling 290 kilowatt/hours per year. When compared to the total energy consumption of the comparable halogen calculation of 903 kilowatt/hours per year, this results in energy savings of 613 kilowatt/hours per year, with further energy savings possible with the dimming of the primary luminaires.

In addition, we disclose in this document a means of energy saving aesthetic light actuation of the 20 primary lamp/luminaires via sensitive wide angle motion detectors FIG. 30-222 and a ramping speed which may be quite subtle. The lamps/luminaires are set for the chosen effect, and this is regarded as 100%. A second setting is chosen for interim periods, as for example 50% of the above chosen output. This will be the ‘ready’ luminous intensity. When persons are detected approaching the lighted area, the microcontroller with programmable CPU FIG. 39-242 is triggered to ramp up the luminous intensity to 100%, resulting in the full enjoyment of the aesthetic lighting. Once the persons have passed the illuminated area, the microcontroller with programmable CPU FIG. 39-242 will again ramp the full ON luminous intensity back down to ‘ready’ at 50% luminous intensity.

Thus, the energy consumption of the total aesthetic illumination of the 20 primary lamps/luminaires would be reduced by 50% from 750 watt/hour or 0.750 kilowatt/hour per day to 375 watt/hour or 0.375 kilowatt/hour per day, with an additional estimated total of 1 hour full ON at 100% luminous intensity (20 lamps at 12.5 watt/hour for 1 hour is equal to 250 watt/hour), the result would be a final total of 375 watt/hour plus 250 watt/hour equal to 625 watt/hour or 0.625 kilowatt/hour per day, or 228 kilowatt/hours per year, compared to 903 kilowatt/hours per year of the halogen equivalent, for an energy savings of 675 kilowatt/hours per year.

Microcontroller with Programmable CPU

The microcontroller with programmable CPU FIG. 39-242 in the Sentinel Advanced Control Module FIG. 25-200 is intended to control lamp outputs and other loads with a nominal input from 12 to 30 volts AC or DC via the overvoltage isolated switch mode power supply SMPS module FIG. 21-295. The CPU (central processing unit) has a nominal 64 bit capacity (or any other capacity above or below 64 bit capacity).

The microcontroller with programmable CPU FIG. 39-242, with voice recognition capacity, has any number of optional daily time segments which can be set for variable duration, each of which can be set for percent of total luminous intensity and each luminous intensity time segment can be set for individual ramp up and/or ramp down speed, luminous intensity, segment duration, and with a programmable means of color selection for each daily time segment, and with an optional wide angle motion detector FIG. 30-222 input and power output for the purpose of security and/or safety and/or energy savings and aesthetics.

The microcontroller with programmable CPU FIG. 39-242 of high capacity function and programmable large memory function serves as a means of storing lighting programs, irrigation programs, security programs, voice recognition programs, private or personal PA (public announcement), auto-on intercom communications, and a means of sending function data via wireless, fibre optic or wire conductors for synchronized lighting display and also for connection to existing or future security systems and home energy control systems.

The function and features of the microcontroller with programmable CPU FIG. 39-242 include the following: Offers the ability to customize a lighting setup, the ability to choose color and brightness levels, the ability to create a theatrical experience by setting the scene, for example, to “party” or “dramatic”, etc., the ability to launch various lighting scenarios with a simple voice recognition or remote activation process, the ability to control multiple scenes. Clock time in the Sentinel Advanced Control Module FIG. 25-200 and all of the other interconnected Sentinel Advanced Control Modules FIG. 25-200 is synchronized and may be set by the user. Wireless connection to a PC (personal computer) would allow for automatic time clock synchronization. Brightness can be adjusted remotely by using a hand held remote control, or by voice recognition that sends signals to brighten or dim the light, with several brightness levels (percent number on the liquid crystal (or other) display module FIG. 30-220) indicating the current percent of maximum brightness of the light. It is possible to adjust the speed at which the controlled lamp is raised to the increased output setting or lowered to a decreased output setting, also known as the ramp rate. The ramp rate is adjustable between 0.1 seconds and 10 seconds, plus 10 second increments to 1 minute, and can extend as much as required or desired. All lights can be set to ramp at a synchronized rate to independently specified brightness levels. Or, or for example, one light can dim slowly while another can be set to de-energize nearly instantly, and many other combinations of effects. It is a simple process to adjust the dimmers FIG. 22-248 in each Sentinel Advanced Control Module FIG. 25-200 wherever needed. Dimmer settings are stored in memory and are not lost during power failures. A watt meter at the power supply input is a comprised of a voltage divider FIG. 21-269 and an ammeter FIG. 21-294, with a further advantage that kilowatt/hours can be monitored.

With respect to the complexity of the programming, as an example and thus not intended to be limiting as to size of increments, etc., some of the variables are:

(1) ON time: Auto photocell with V.O.C. (variable output capacity) FIG. 30-223 or set time.
(2) OFF time: Auto photocell with V.O.C. (variable output capacity) FIG. 30-223 or set time.
(3) Time segmentation (minutes): 1-4, 1-12, 1-24, 1-20, 1-30, 1-60, then plus 1 hour to daylight.
(4) Color choice: 1-2, 1-3, 1-4, 1-5, 1-6, 1-7 . . . 1-100, 100-1000.
(5) Luminous intensity (output in lumens): 1-10, 1-20, 1-30.
(6) Ramp speed: Seconds: 1-10, 1-20, 1-30 . . . 1-60 Minutes: −10, 1-20, 1-30, 1-40, 1-50, 1-60.
(7) Motion sensitivity: 1-20.
(8) Ambient light sensitivity: Auto or with a minimum and maximum percentage luminous intensity set for desired effect.

The components for this potential upgrade are relatively inexpensive and yet residential lighting systems with this capacity have up to this time been taken from very much more expensive 120 (and greater) volt commercial systems purposely designed by experienced lighting system engineers and lighting specifiers for large commercial buildings. However, very similar much reduced scale systems could be composed of 120+ volt multiple dimmer programmable controllers designed for indoor applications but conceivably made to control outdoor 120+ volt luminaires at relatively extremely high cost. These systems are almost exclusively installed during the original building construction in concert with professional landscape designer and/or architect teams. Thus the outcome is preconceived and planned for so that the extensive excavation required for the purpose of burying the supply conductors to the depth required by national electrical code can be done prior to the landscaping process. We disclose a module FIG. 21-295 for the input voltage conversion to 30 volts. This allows for a greatly increased potential for control and energy use reduction. Once connected and closed, only the nominal 15 volt maximum will be accessible. Other potential voltage conversion modules above 30 volts are intended to be installed by qualified persons. The Sentinel Advanced Control Modules FIG. 25-200 would be interconnected via wireless transceivers, fibre optic cables, or conductors.

From the above it can be seen that what can be accomplished with one of the embodiments can be far less expensively accomplished by persons with little experience even after the yard buildings and gardens are completed. It might also be accomplished as an upgrade to an existing inefficient system without running additional supply conductors because, for example: An existing nominal 12 volt 50 watt PAR 36 halogen lamp/luminaire providing a nominal 800 lumens (drawing approximately 4 amps) and with a correctly sized supply conductor pair can, along with any other existing correctly sized supply conductors and luminaires in the system, be inexpensively upgraded to 24 volts such that the original halogen lamp is utilized with the dimmer until failure or the lamp is replaced immediately. The Sentinel Advanced Control Module FIG. 25-200 and proprietary LED lamp FIG. 9B providing a nominal 800 lumens but drawing only a nominal 0.83 amps at 24 volts or 16.66 watts/hour. Other embodiments employ other luminaires and lamps that produce a similar result.

Additional Sentinel Advanced Control Modules FIG. 25-200 and luminaires may be added to the system providing a nominal aggregate 3,200 lumens but without increasing the nominal 4 amp current flow in the supply conductors. The luminaires can then be programmed to provide a nightly light show with almost infinite possible combinations of light intensity and duration with the ten proprietary luminaires (or other luminaires). The opinion of Bondy et al is that the most pleasing results may be obtained by providing the soft, warm color of dimmed halogen effect and relying upon the natural color of the surrounding plant life and other features, or by means of existing RGB LED multi-color output lamps (or any lamp which may produce any number of light colors) and the 3 color LED driver, the lighting outcome becomes exponentially more variable and may be produced without the luminous intensity losses caused by the above color filters.

### Wide Angle Motion Detector

We disclose a group of embodiments with the further inclusion in the Sentinel Advanced Control Module FIG. 25-200 of a wide angle motion detector FIG. 30-222 which actuates by default Lamp C and/or the designated pathway luminaire(s) FIG. 41-309. The wide angle motion detector FIG. 30-222 is of two stage design, first detecting heat, and then pulsing microwave or ultrasonic waves, and measuring any change in the reflected image. Future embodiments will include updated motion detection means, including video cameras, with this capacity.

The wide angle motion detector FIG. 30-222 input to the Sentinel Advanced Control Module FIG. 25-200 allows for the additional programming capacity of the microcontroller with programmable CPU FIG. 39-242 to energize some or all of the other lamp output terminals of the system. This is an effective way to actuate the energization of the a plurality of lamps along a pathway which may be supplied by additional Sentinel Advanced Control Modules FIG. 25-200, or the lamps are energized by Sentinel Advanced Control Modules FIG. 25-200 with commands preceded by the associated addresses.

The described system makes possible dusk to dawn staging area illumination. This allows for wide angle motion detector FIG. 30-222 actuation in each staging area. Staging area illumination will often be of low energy demand because it is, in the main, of limited dimensional area. When motion is detected, the pre-programmed luminaires are energized to provide needed light for function or pathway lighting.

An example of system integration would be a single wide angle motion detector FIG. 30-222 activating and energizing all of wide angle motion detector FIG. 30-222 actuated lamps, including pathway luminaires FIG. 41-309, from a dusk to dawn beacon FIG. 41-304 delineated staging area. Each Sentinel Advanced Control Module FIG. 25-200 is given an address and will follow ON/OFF and other commands which it receives via a wireless device or conductor or fibre optic cable for that address from any other Sentinel Advanced Control Module FIG. 25-200. All Sentinel Advanced Control Modules FIG. 25-200 have the capacity to be programmed to nearly instantaneously send instruction data into the communication stream with a pre-programmed address or addresses to actuate the desired function. The Sentinel Advanced Control Module FIG. 25-200 could be programmed to energize the motion actuated Lamp C at a selected luminous intensity, and to remain energized for a pre-selected period of time. The above luminous intensity can be programmed to produce or increase illumination as one after another of the wide angle motion detectors FIG. 30-222 are activated.

In this way a planned number of lamps in the system could be made to be energized from persons entering the area from various entrance locations. This would allow for the full lighting of walkways, and optionally enjoyment of the aesthetics, without any or very little energy use when not required or desired, thereby reducing energy use to a considerable extent. In fact, outdoor motion detector actuated lights are often set to manual ON because the system is only activated from one of the potential approaches. This problem is overcome in the Bondy et al system by means of at least two Sentinel Advanced Control Module FIG. 25-200 wide angle motion detectors FIG. 30-222 that will energize the length of the pathway. Wiring for these components is below 30 volts and can be installed with much less difficulty and expense than typical nominal 110 volts and above.

In the case of a very long pathway or large area, wide angle motion detectors FIG. 30-222 could be utilized which allow for overlapping illumination motion detector actuators to ensure continuous illumination along a path or area without the requirement that all luminaires remain energized when, for example, the path is very long or persons stop along a path for prolonged periods. Persons experienced with the placement of wide angle motion detectors FIG. 30-222 understand the potential difficulty involved with the attempt to allow for multi-directional approaches through passageways or walkways. The Bondy et al system greatly simplifies this process as follows: Since each Sentinel Advanced Control Module FIG. 25-200 and luminaire are extra-low voltage, the power supply or conductors may be strapped under railings, steps and many other areas which are considered protected by location.

Variable luminous intensity output capacity allow for the use of a greater number of luminaires and wide angle motion detectors FIG. 30-222 because the energy requirements can be reduced when the required area lighting is provided for more evenly along the pathway, stairway, driveway, etc. Again, a long path may be segmented so that once persons, etc., have passed a designated point then lamps further behind may be de-energized, and this results because the duration of lamp or multiple energization after actuation by a wide angle motion detector FIG. 30-222 may be set from one minute to any duration, except when photocells 219 or photocells with V.O.C. (variable output capacity) FIG. 30-223 detect daylight. And thus lighting requirements are met, and luminaires placed outside of the area need not consume energy, thereby resulting in energy savings.

The system is designed to produce practical results with much reduced energy requirements. The by-product is aesthetically pleasing lighting effects of potentially very subtle nature, and an intentional elimination of light pollution. The result would greatly differ from typical motion detection systems where harsh floodlights flash ON, potentially disturbing neighbours. Another advantage is the potential to completely eliminate temporary blindness when a bright light is suddenly energized, much like the temporary blindness caused by photo camera flash. Also, the flash of light caused by the sudden energizing of a relatively bright lamp (e.g., dual 75 watt halogen flood lamps) where the prior ambient illumination was limited, is not only an irritation but often causes temporary blindness of persons facing into such lamps. Additionally, sudden changes in outdoor light levels can and do interrupt sleep for sensitive individuals.

Energy will be conserved when only staging areas of the pathway or required area lighting is illuminated. The motion detector(s) FIG. 30-222 can be set to actuate energization of aesthetic lamps/luminaires, the pathway luminaire(s) FIG. 41-309, or both, for a pre-selected duration of time. We consider the most energy efficient method of illumination is to energize only a minimum number of dusk-to-dawn lamps or beacons FIG. 41-304, and these will serve the purpose of guiding a person to the path or area, and once near, the motion detector(s) FIG. 30-222 can then be utilized to energize the remainder (or segment) of the pathway, and in this way there can be safety but with a mere fraction of energy required compared to a porch light or other potential safety means of illumination.

Another potential is that for the first several passes only, the pathway luminaires FIG. 41-309 for path light may be pre-set for energization, but if the motion is of longer duration then a stage can be pre-set such that after the pre-set period, the primary lamp/luminaire and any other lamps/luminaires may be set to be energized. This is a logical potential outcome because person(s) who remain in an area within range of any wide angle motion detector FIG. 30-222 for an extended period of time might benefit from the additional light for function, or simply to enjoy the scene lighting. Programming will be available to opt for energization of aesthetic lighting only when people are within a predetermined range for viewing the associated aesthetic illumination. If the system is programmed in this way, then the pre-set luminous intensity will perform as intended, and afterwards, following a pre-set delay after a period of undetected motion, these lamps would be de-energized. Thus a convenient means of illumination and the greatest possible energy conservation method and logistics are provided for, in varied situations.

Additionally, we disclose that the Sentinel Advanced Control Module FIG. 25-200 has a variable luminous output programming capacity such that wide angle motion detectors FIG. 30-222 may be placed near the outer edges of an area such that the luminous intensity desired can be set, and then a percentage of that output can also be set. The latter setting would then be the ‘ready’ setting. Thus, when persons approach as from a sidewalk, the Sentinel Advanced Control Module FIG. 25-200 may be programmed to ramp up from the ‘ready’ setting to the full luminous intensity setting. Because the ramp speed can be pre-selected and variable, then the lamps may be almost imperceptibly ramped up as said, and with much reduced daily energy required, the full enjoyment of the scene lighting may be enjoyed. We disclose the use of a very sensitive and precisely adjustable motion detector chosen or manufactured for this purpose. In another embodiment, the photocell might be a stand-alone cord connected type, by licence, if need be.

### Narrow Angle Variable Long Range Motion Detector

One of the greatest energy saving means of the Bondy et al system is the variable ramp speed of the ramping narrow angle variable long range motion detector FIG. 43-229 with very high efficiency lamps. Persons walking down a residential street would, when close enough, be detected. This narrow angle variable long range motion detector FIG. 43-229 does not point the Sentinel Advanced Control Module FIG. 25-200 towards the street, but simply, the motion detector/sensor itself.

Utilizing only one variable long range motion detector FIG. 43-229 for each direction within the hours of full setting run time of all lamps/luminaires included in the scene lighting plan, the result eliminates disturbances, is aesthetically beautiful and 75% less energy is required. The lamps would be seen only as sources of light, while consuming approximately 25% or less energy on average, but each can be made to ramp from more or less than 20% to increase the effect or larger lamps, but ramp to full at the same pace as the other. The ramp speed can be nearly or completely imperceptible, yet when the approaching person reaches the property, in 20 seconds or less, for example, the lamps have ramped to set scene lighting. Once the other end of the property is reached, the process is reversed. It may be hard to imagine how dramatic the effects could be with so little power consumed nightly.

An additional and optional narrow angle variable long range motion detector FIG. 43-229, FIG. 22-229 differs from the wide angle motion detector FIG. 30-222 located on the front shell FIG. 30-215 of the Sentinel Advanced Control Module FIG. 25-200. It serves the following potential purposes:
i. It allows the Sentinel Advanced Control Module FIG. 25-200 to be directed into the property for security, and makes possible a longer range for the purpose of energy saving. A low level standby light output can be maintained and programmed for a slow ramping up when persons are detected approaching the property.
ii. For described staging areas leading to pathways, a nearby motion detector may be logistically difficult to place.
iii. Thus a more distant narrow angle variable long range motion detector FIG. 43-229, FIG. 22-229, once correctly aimed, could serve the purpose of actuating via the microcontroller with programmable CPU FIG. 172-242 the energization of the path or area luminaires.
iv. Street lamps, park pathways, etc., could be set to accurately serve the end purposes from item (ii).
v. In residential or other areas it would be, in our view, an invasion of privacy to direct video or audio equipment from private property outward to other areas where persons have the right to an expectation of privacy.

This additional and optional narrow angle variable long range motion detector FIG. 43-229, FIG. 22-229 may be mounted on the proprietary spherical luminaire encasement FIG. 26-208 which includes the Sentinel Advanced Control Module FIG. 25-200, or on the proprietary sphere with lamp only FIG. 43-214, or on the body of the Sentinel Advanced Control Module FIG. 25-200 which is attached to a tube on top of a post and tube FIG. 43-260 or mounted in another way, etc., as seen most clearly in FIG. 43. We have not included an illustration of narrow angle extended distance motion detectors because they are widely available from original equipment manufacturers (OEM) and public purchase.

The narrow angle variable long range motion detector FIG. 43-229 includes a means of independent horizontal range for aim.

### Perimeter Motion Detection Energy Conservation Aesthetic Lighting System Layout Design

The Bondy et al system of outdoor lighting is a means of reducing aesthetic lighting energy output via perimeter motion detection. One embodiment is a system of interconnection of Sentinel Advanced Control Modules FIG. 25-200 by conductor, wireless transceiver, or more optimally via fibre optic cable.

The method offers multiple options but an example follows: The system of aesthetic lighting is laid out. The hours of operation are preselected. The areas from which motion may be detected are chosen, specifically, persons walking nearby, possibly on a public sidewalk or road may be included in the choice of actuation zones, thus wide angle motion detectors FIG. 30-222 may be positioned to detect persons and may do the following: With some aesthetic lighting already energized, the detection can be set to send an actuation command to any other Sentinel Advanced Control Modules FIG. 25-200 in the group and thus, by means of the ramp speed setting, bring the remaining aesthetic lamps to the pre-set luminous intensity and/or color output. By making use of the ramp delay the additional illumination can be brought to full without a stark or sudden scene change, thus the purpose of the aesthetic lighting is served but can be moderation to function when persons are present to enjoy it. The same result can be programmed to occur in other areas.

### Primary, Secondary and Tertiary Actuation and Functional Overlap

The Bondy et al system is very effective when activated by wide angle motion detectors FIG. 30-222 and when consisting of efficient low energy pathway and functional pathway luminaires FIG. 41-309 in addition to the lamps in the luminaires which may serve secondary and tertiary purposes. This result may be obtained when the capacity of the microcontroller with programmable CPU FIG. 39-242 is relied upon to energize lamps which have been set for aesthetic illumination. These lamps may also be programmed for wide angle motion detector FIG. 30-222 actuation but the chosen luminous intensity and color output once energized by this alternate device may be selected from the full range available within the performance parameters of the lamp and lamp control.

The capacity of the microcontroller with programmable CPU FIG. 39-242 is intentionally greater than initially required. We disclose a system program and microcontroller with programmable CPU FIG. 39-242 capacity which will allow for functional operation, which may be made available to the owners of the Sentinel Advanced Control Modules FIG. 25-200 for the purpose of increasing efficiency or enjoyment of the Sentinel Advanced Control Module FIG. 25-200, in the same way that the software is updated for PC (personal computer) system operation.

The potential for illumination efficiency is also greatly increased by the capacity of the Sentinel Advanced Control Module FIG. 25-200 microcontroller with programmable CPUs FIG. 39-242 to be programmed to function in concert with other Sentinel Advanced Control Module's FIG. 25-200 microcontroller with programmable CPUs FIG. 39-242, which are preset to energize yet more lamps also preset for the desired output when the wide angle motion detector FIG. 30-222 by means of the original Sentinel Advanced Control Module FIG. 25-200 microcontroller with programmable CPU FIG. 39-242 which elicits a corresponding energization of lamps by one or more additional Sentinel Advanced Control Module FIG. 25-200 microcontroller with programmable CPUs FIG. 39-242.

The result is that a single wide angle motion detector FIG. 30-222 may be utilized to energize several lamps along a path or in an area, and that the combination of illumination which results may be very precisely matched to what is desired, and with the additional parameter of variable delay time ON chosen effectively then the following; a lamp or multitude of lamps serve primary and secondary purposes, and the primary purpose function may or may not allow for the requirements of the secondary purpose function, but as has been described, the secondary purpose function can be made available as desired.

What must be added is that any of the Sentinel Advanced Control Modules FIG. 25-200 in the group may be relied upon to serve the described primary purpose, and by means of the wide angle motion detector FIG. 30-222 in the additional Sentinel Advanced Control Modules FIG. 25-200 also produce the secondary purpose function, or, any of the additional actuation devices in the additional Sentinel Advanced Control Modules FIG. 25-200 may serve a tertiary purpose function in a multitude of potential actuations.

For example, the Sentinel Advanced Control Module's FIG. 25-200 microcontrollers with programmable CPUs FIG. 39-242 are programmed not only to cause a preset lamp or lamps to function when motion is detected but also to count the number of motion detection events at each, and within the preselected variable sensitivity range of each Sentinel Advanced Control Module's FIG. 25-200 wide angle motion detector FIG. 30-222 as well. Thus patterns of movement and the order of movement is data which indicates the direction of the pattern of movement, and this data may be utilized to estimate and then activate a preselected tertiary illumination outcome for a preselected period of time. The tertiary function may be to actualize a completely altered totality of path or area illumination from one or all the lamps connected with the group or groups of interconnected Sentinel Advanced Control Modules FIG. 25-200.

An example at a residence is the detection by means of two or more wide angle motion detectors FIG. 30-222 of rapid motion in one or more directions toward and/or away from an entrance. Because this occurrence during darkness might be considered unusual and/or because rapid movement in darkness might cause injury, the Sentinel Advanced Control Modules FIG. 25-200 can be preset to energize all available lamps for maximum movement and function visibility for a protracted period of time. This description of variable potential function has included the motion detector(s) FIG. 30-222 as the causative actuation variable. For example, one of many possible events which precipitates the described function could be a medical emergency.

When audio input actuation (or as it is termed, voice recognition) is added (described later in this document), a nearly exponential increase in potential activation enters the control potential, which becomes difficult to describe. We wish to state that what has been described is only a fragment of potential function, and each time a variable is introduced it can only be accurately described with the inclusion of the fact the Sentinel Advanced Control Module FIG. 25-200 can be one of any number of possible additional Sentinel Advanced Control Modules FIG. 25-200 in a group, and that the address of the group can include the available designation in the microcontroller with programmable CPU FIG. 39-242 of each Sentinel Advanced Control Module FIG. 25-200 such that the groups are designated by choice with regard to quantity, and choice by area also. Here, as well as elsewhere, the inclusion of voice recognition makes a small, moderate or large system extremely user friendly and allows for multiple additional safety functions as described later in this document. For example, a pre-selected emergency command can be pre-programmed to cause full system rapid flashing. The audio can be pre-set to alert the indoor occupants and beyond this, by means of a dialler, call police, ambulance or fire personnel, as needed.

The Sentinel Advanced Control Module FIG. 25-200 is designed to include a microcontroller with programmable CPU FIG. 39-242 with the capacity to accept a multitude of detailed and precise programming far beyond what has been described and disclosed in this document.

### Sentinel Advanced Control Module Interconnection and Programming for Remote Address Module Output Control

What is available for other illumination and other energy outputs is also suited to path and area lighting. With two, three or multiple interconnected Sentinel Advanced Control Modules FIG. 25-200, the detection of motion by one Sentinel Advanced Control Module FIG. 25-200 can be programmed to send an output command preceded by an external address, and can provide for the following: Any of the multiple output terminals can be programmed to be energized with the original to produce the required or desired illumination, and the program can be set for an appropriate delay ON. Thus in some cases it is possible that dozens of luminaires are programmed to function with the Sentinel Advanced Control Module FIG. 25-200, which is set for this operation. For a difficult pathway in the dark, when properly illuminated for safety and ease, but with the automatic OFF time, the total energy consumed may be a very small fraction of illumination provided by other means.

A great advantage of the Sentinel Advanced Control Module FIG. 25-200 and Bondy et al system is the available addition of wide angle motion detectors FIG. 30-222. A closely nearby tree chosen for aesthetic lighting may free up an additional wide angle motion detector FIG. 30-222 and cause energization of lamps connected to other Sentinel Advanced Control Modules FIG. 25-200 without energizing a single pathway luminaire FIG. 41-309. Necessarily, each staging area of a pathway as described would require, if the path is long enough, a Sentinel Advanced Control Module FIG. 25-200 at or near each end. Thus, Sentinel Advanced Control Module FIG. 25-200 A may actuate Sentinel Advanced Control Module FIG. 25-200 B, C, E, H and if from the opposite direction, Sentinel Advanced Control Module FIG. 25-200 actuating a similar command Sentinel Advanced Control Module FIG. 25-200 will actuate H, E, C, B and A, while other Modules in the same stream of data, D, F, G, and I, are not affected.

Photocell with Variable Range Capacity and Ambient Light Intelligence

We disclose an embodiment wherein the photocell has a variable output capacity for contrast of ambient light, hereinafter referred to as a ‘photocell with V.O.C.’ FIG. 30-223. The photocell with V.O.C. (variable output capacity) FIG. 30-223 measures ambient daylight which is diminishing to a minimum in the dusk-to-darkest cycle.

The embodiments including the photocell with V.O.C. (variable output capacity) FIG. 30-223 are a method of energy savings which requires no loss in performance. The photocell with V.O.C. (variable output capacity) FIG. 30-223 sends a variable signal to the Sentinel Advanced Control Module's FIG. 25-200 microcontroller with programmable CPU FIG. 39-242. The minimum and maximum of luminous intensity of the primary lamp/luminaire, and any other desired lamp, is preset and for aesthetic purposes will range in direct proportion to the average ambient luminance as measured by the photocell with V.O.C. (variable output capacity) FIG. 30-223. The result will then be greater lamp output when average ambient light increases and lesser lamp output as ambient light decreases. The latter is only applied to lighting which is purely aesthetic. For safety, the function may be reversed to insure a set minimum ambient light. Both methods allow for a considerable reduction in energy use without any losses of function. We claim this outdoor low voltage function as original Intellectual Property.

The output of the photocell with V.O.C. (variable output capacity) FIG. 30-223 is variable regards the range from relatively low levels of ambient light and saturation. As sunlight fades, after sunset there is a period between what is termed twilight or dusk until it becomes fully dark. Thus the brightness of a lamp over this period will be proportional if, for example, a 700 lumen flood lamp is close to and illuminates a small hedge, then for descriptive purposes it can be stated that during the full light of day the hedge will appear only slightly illuminated whereas at the darkest time of night the hedge will be very much illuminated. In fact, for comparison, 700 lumens is an approximation of the light cast by an automobile headlamp. Therefore the impression received by the human eye of the hedge is a ratio between the ambient light within the range of sight of the observer's eyes and the intensity of the light cast upon the illuminated hedge and all ambient light. This fact can be used to advantage. At dusk it is decided that the lamp will be set to cast 500 lumens. As time passes and the sunlight fades, the hedge will by contrast appear more brightly illuminated. Logic dictates that the intensity of illumination may be gradually reduced while maintaining the same impression, again by reason of contrast and relativity. Without this capacity an outdoor lighting system must either be too dim as the shift towards darkness proceeds or too bright when the darkest hour arrives. If the illumination is intended for safety then the error must be towards over much illumination at the lightest period, otherwise during full darkness the illumination provided by the lamp may under some conditions be insufficient.

Again, the described capacity is disclosed as Intellectual Property because the capacity can be used to advantage in group lighting settings where a group of luminaires may all be energized, or in other conditions, only a fraction of the total light intelligence feature may be used to advantage by setting a program to increase or decrease the luminous intensity of one or any number of a plurality of the group to prove the desired effect under both conditions, and if the choice is reduction of output, energy may be conserved.

The Sentinel Advanced Control Module FIG. 25-200 includes light event intelligence. The described function of ambient light is set to ignore instantaneous ambient light, this to prevent a total system ramping up or down by artificial light. The function is pre-set to discriminate between the day and night cycle of sunlight and all other sources of light, and also to cycle daily during after dusk periods if they are part of the ambient lighting dynamic. The Sentinel Advanced Control Module FIG. 25-200 is therefore ambient light ‘intelligent’, but in order to avoid chaotic function resulting from the sensitivity and response to ambient light when the ambient light is resulting from every possible artificial light source (such as is not the result of the sun), then the Sentinel Advanced Control Module FIG. 25-200 is programmed to differentiate between daily light cycles which are of relatively long duration when compared to, for example, the momentary ambient light cast by automobile headlights as the automobile passes by the module location.

A photocell with V.O.C. (variable output capacity) FIG. 30-223 changes its resistance, or allows more current to flow through it as the light level increases. It is made part of a voltage divider with a resistor at the bottom, and this produces a voltage which varies with the light level. The microcontroller with programmable CPU FIG. 39-242 has an A-D converter (analogue to digital converter) which converts the measured voltage into 1s and 0s that the microcontroller works with. Common A-D voltage steps are 256, 512 or 1024, possibly even high. All digital code is to the power of 2, which explains these values (i.e., 2 power 8=256; power 10=1024). The more steps in the A-D converter, the finer the resolution of measurement, and in most cases, 512 or 1024 steps are adequate. For example, a room temperature thermometer would be more than fine with 256 steps.

By accepting variable input from the photocell with V.O.C. (variable output capacity) FIG. 30-223 or video camera FIG. 30-224 lens (when this becomes cost effective) the to the Sentinel Advanced Control Module's FIG. 25-200 microcontroller with programmable CPU FIG. 39-242, the desired or required illumination may be chosen relative to the ambient light from dusk until dawn. If the light is intended for safety, then it will be a simple process of setting the period of maximum illumination and the period of minimum required illumination. Once parameters are set for normal operation, then either more precise setting is programmed, as for example a setting for each time period, or the output is automatically adjusted up or down relative to maximum and minimum pre-set parameters and at several points between. An integer of 1 to 10 may be chosen, or from 1 to 100.

### Fibre Optics

One method of Sentinel Advanced Control Module FIG. 25-200 communication linkage is by means of a fibre optic transmit receive module FIG. 21-236, and fibre optic cable which has been provided with dual fibre optic connectors FIG. 22-252A, 252B on each Sentinel Advanced Control Module FIG. 25-200 housing. This provides for an installation advantage over the electrical conductor communication means in multiple ways as follow:
i. The cable may be completely isolated from the power supply conductors.
ii. Distance is not a limitation.
iii. There can be no danger of electrical hazard associated with a cable which does not include an electrical conductor.
iv. National Electrical Code directives with regard to communication conductors will be complied with, however, the fibre optic cable for the system contains no path for electrical current.
v. There is no potential for radio/television communications infraction since, regardless of frequency, total radio signals introduced into from the system into the atmosphere would be minimal.
vi. Systems of incompatible voltage may be safely interconnected for communication.
vii. Audio, video and data may be simultaneously communicated in a single optic strand.
viii. Nearly all audio, video and computer components are compatible with, or can be integrated by, fibre optic inputs. Other embodiments may require multiple fibre optic strands which would be provided for during manufacturing in the future.

### Means of Setting and Adjusting Programming

For the Sentinel Advanced Control Module FIG. 25-200, there are several means of setting and adjusting programming and temporary over-ride functions:
i. The liquid crystal (or other) display module FIGS. 30-220 and 3 weatherproof momentary contact push-button switches FIG. 30-221.
ii. Voice recognition.
iii. Hand held remote control (portable).
iv. Central indoor system monitor (stationary). This may be an existing system for which instructions would be provided for the needed interface.
v. A home PC (personal computer), where as above an interface may be purchased and a program package will be provided from existing system or via O.E.M. (original equipment manufacturer).
vi. A portable phone or a cell phone, which can at the time of writing this application, send and receive voice and data.

Other means will become available in the course of time. Intrusion could, for example, be detected and a dialler make possible the transmission of audio and video data (two way communication) to the homeowner, security monitoring company, or other intended recipient. As it is already possible to send text messages to home PCs (personal computers), and also receive text messages on wireless mobile devices, it follows that electronic media are becoming homogenized and the above will, or may be, possible at the time of writing this description.

### Voice Recognition

Voice recognition is a rapidly expanding means of activating device settings, actuation of memory programming and de-activation of part or all functions. With the voice recognition function, any Sentinel Advanced Control Module FIG. 25-200 within audio range may be directed to energize one or all of the 4 lamp outputs. The advantages are too numerous to list but include the following, most specifically because the addition of an audio input device or microphone FIG. 30-225 and an audio output device, audio speaker or annunciator FIG. 30-226, are very low cost for the function they provide, and have been vastly improved such that a very small audio speaker FIG. 30-226 can be produced to provide clear intonation and produce considerable output as measured in decibels. The required hardware and memory will be included, when optioned, for voice recognition in the capacity of the microcontroller with programmable CPU FIG. 39-242 depending on the potential addition cost of the available components. However, more accurate systems are being developed and these could potentially require greater CPU capacity, which could be included in the microcontroller with programmable CPU FIG. 39-242.

The Sentinel Advanced Control Module FIG. 25-200 is already equipped to interface analog to digital for input to the microcontroller with programmable CPU FIG. 39-242. This interface need not be altered for the digital input which a voice actuating device will produce. The microcontroller with programmable CPU FIG. 39-242 program language for input and output audio confirmation and staged directions can be chosen, which can be very cost effectively programmed for interactive voice operation in order to confirm commands and also to allow for the purpose of leading through potential actuation and programming streams.

Voice recognition can also be utilized to secure function by voice identification. This technology could be described in great detail, however, we will instead provide a significant additional processing speed and capacity and provide for additional memory function for future improvements to the voice recognition unit as this technology improves, or as has been disclosed, unlimited processing and memory function can be simply connected into the data and communication stream with the available nominal 12 volt DC auxiliary supply terminals, or to a greater effect with a PC (personal computer). We are disclosing a novel use for voice actuated function and programming, which can be programmed to function by means of manufactured or O.E.M. (original equipment manufacturer) components. This can be produced with specified detail for more cost effect manufacturing. In one embodiment, the system is integrated with a home PC (personal computer) which can be utilized to make all systems language and interface common, and thus the fibre optic stream will be accessible at multiple locations indoors and outdoors, and the wireless would be utilized as a security back-up or where cable installation is not considered a viable option for some or all interconnection of the Sentinel Advanced Control Module FIG. 25-200.

### Remote Control

We further disclose a remote control function, which includes a multi-channel fibre optic interface to a home PC (personal computer). Remote control can be via a fibre optic remote control transmit receive module FIG. 21-236, or wireless remote control transceiver FIG. 23-227, or conductor connected remote control with programming capacity of one or more Sentinel Advanced Control Modules FIG. 25-200, which are set to accept commands from the remote control, for the purpose of turning ON or OFF any of the luminaires, increasing or decreasing the luminous intensity of the multi-colored LED lamp(s), and/or a halogen or other lamp(s), and for the purpose of controlling the color output of the above LED lamp(s), and to control all functions of the Sentinel Advanced Control Module FIG. 25-200(s) by address, by program input or by default (where the default is the order as a measure of unloaded supply voltage in a string of Sentinel Advanced Control Modules) to each Sentinel Advanced Control Model microcontroller with programmable CPU FIG. 39-242.

A hand-held wireless programmer can be utilized for a multitude of Sentinel Advanced Control Modules FIG. 25-200. This reduces duplication in the case of more than one Sentinel Advanced Control Module FIG. 25-200 and also makes possible a larger display (not shown) and greater programming simplicity by means of more data input controls so that many functions need not be accessed by only 2 or 3 input weatherproof momentary contact push-button switches FIG. 30-221 as are available on the Sentinel Advanced Control Module FIG. 25-200.

The program would be optimized by PC (personal computer) software and fibre optics, with the described hand held wireless remote control serving for convenience, or with voice recognition options. There are several home system software programs available, and the fibre optic cable has already gained a large market share for interconnection and interface means. The PC (personal computer) can then be monitored from any remote internet location while persons are away from the installation. With cooperative program development or integration with exiting operating systems, cost for voice recognition, alarm dialling and other options is greatly reduced. Programs can be comfortably entered for variety of choice depending on occasion. Software from currently available programs could be utilized, or a more system specific and simple to adjust program can be made available by a manufacturer of proprietary products.

In all embodiments a function, and activation and de-activation, is accessible on the Sentinel Advanced Control Module(s) FIG. 25-200. Further, for convenience, the LED and/or incandescent dimmer control module FIG. 22-248 adjustment on all Sentinel Advanced Control Modules FIG. 25-200 can be made with the weatherproof momentary contact push-button switches FIG. 30-221 and the liquid crystal (or other) display module FIG. 30-220, such that a remote need not be located for a simple output or ON/OFF adjustment. The hand held remote control has a means of changing the light output color and shade of said color more quickly. Thus, while observing the system from indoors or outdoors, the luminaires can be made to produce a vast array of possible combinations, and the effect can be observed while setting.

### Dramatic Aesthetic Effects and Light Burst

The Sentinel Advanced Control Module FIG. 25-200 can be pre-set with the output of both color and luminous intensity in memory, and has a default capacity for a chosen program selection. If during the setting and adjusting of the luminaire, a much desired output setting is discovered, the setting can be saved and stored for later use/selection. When at the Sentinel Advanced Control Module FIG. 25-200, the liquid crystal (or other) display module FIG. 30-220 can be made to indicate what output level setting will cause this desired effect for the particular luminaire and lamp. Then the setting can be entered into the daily cycle program. Additionally, the setting can be fully ON for a set period and then slowly dimmed to the set OFF time. The system can also be very simply set with a portable PC (personal computer) with the necessary software and a fibre optic jumper cable and suitable connector. Tee fittings may be installed to allow for a quick connection of a PC (personal computer) to the system interconnection setup. In this way, a wide array of scene lighting can be set up while seated in the lighted outdoor area.

Time clocks are synchronized in each Sentinel Advanced Control Module FIG. 25-200. The ramp speed also can be a fraction of an hour or hours, or a fraction of a minute. In all cases, all lamp outputs can be set to function in unison, creating a dramatic evening light show, and the show can be changed every season, every night, or instantly with the remote control with a multitude of program cycles once they are saved in the memory.

Since the time clocks in each Sentinel Advanced Control Module FIG. 25-200 will auto synchronize to match all other Sentinel Advanced Control Modules FIG. 25-200, then a vast array of very dramatic effects can be programmed. For example, if at 9:15 p.m. 20 luminaires were set to adjust, then with a relative short ramp cycle, a very intricate and entertaining pattern can be programmed. For example: Lamp 1 ramps from 80% to 30% luminous intensity; Lamp 2 changes colour and ramps up from 20% to 90% luminous intensity; Lamp 3 ramps down from 75% to 50% luminous intensity; etc. The above function can be described as being nearly exactly like stage lighting for a theatre performance for dramatic effect. The same effect as described above can be achieved but with each luminaire output at some fraction of the power setting chosen initially. Thus, the system is capable of a range of output levels either above or below the first setting. The pattern is followed but can be set with relatively lesser or greater luminous intensity through the cycle so that energy used is decreased or increased for special occasions as the evening progresses.

With the tremendous advances in electronic controls, much of the control of these functions is directed by a microcontroller with programmable CPU FIG. 39-242. Thus, where it is possible to change the scene every 20 minutes, every 2 minutes, or every few seconds is equally possible. Larger output embodiments are foreseen. An embodiment which makes use of an MP3 type memory storage unit is disclosed and this will, among other advantages, allow for future embodiments wherein audio signals from music will be converted to digital, and then converted to multi-color/single color lamp dimmer driver signals.

The aesthetic potential of the Bondy et al system, when grouped and interconnected with real time synchronized multi-speed variable rate, variable duration, variable color change rate, variable luminous intensity, and variable luminous intensity change rate, is comparable to scene lighting experienced in live theatre or concert performance, with each lamp delivering the rainbow color group and countless shades and tones of color variation. We consider this to be astounding residential performance.

With, for example, 10 Sentinel Advanced Control Modules FIG. 25-200, the system has the capacity to provide performance lighting comparable to what might be required for an open air stage. Each Sentinel Advanced Control Module FIG. 25-200 will approximate full luminous intensity and is calculated as follows: Lamp A at 16.6 watt/hour LED×48 lumens per watt=800 lumens (undimmed), and Lamp B (maximum 50 watts) at 48 lumens per watt×50 watts=2,400 lumens (undimmed), for a total of 3,840 lumens (undimmed). Thus, for example, with 10 Sentinel Advanced Control Modules FIG. 25-200, the system allows for a light burst to 38,400 lumens.

The microcontroller with programmable CPU FIG. 39-242 in each Sentinel Advanced Control Module FIG. 25-200, when set, will energize a lamp to full intensity. However, both the primary and secondary dimmable lamp outputs, and to a lesser degree the remaining lamp supplies, will in fact soft start each lamp and are programmed by default to do so. Further, the voltage drop limitation current control will function to limit inrush current. The inrush current may be limited and yet imperceptible to an observer. Lamp life will be prolonged in this way, and the power supply overload protection need not be tripped when, for example, one of a group of supply transformers is ramped from zero to 600 watts instantaneously.

With the increased heat load resulting from rapid and repetitive output adjustment, a means of increased cooling for the dual dimmer units are foreseen to be provided for with by an aluminum heat sink and micro fan (not shown). A thermistor FIG. 38-233 is placed to detect overheating and the microcontroller with programmable CPU FIG. 39-242 is pre-programmed to limit temperature rise by interrupting full power output to 50% and will also limit programmed ramping up and down of both or any lamp loads on the dual dimmer LED and/or incandescent dimmer control module FIG. 22-248 until the temperature returns to a normal operating range. The difference between an observed instant and an electrical circuit instant regarding current flow leaves a considerable margin. When driven at relatively high current to produce rapid output changes, the latter time delay will by means of input from said thermistor FIG. 38-233 begin to retard the instant ON speed yet further as heat rises, finally slowing, and if necessary, stopping all switching at a set temperature limit.

### Security

We disclose a single or multiple Sentinel Advanced Control Modules FIG. 25-200, with or without the proprietary spherical luminaires, and with the inclusion of any or all of the following, but not limited to the following, for each Sentinel Advanced Control Module FIG. 25-200: 2 primary lamp/luminaires, a pathway luminaire FIG. 41-309, the programmable Sentinel Advanced Control Module FIG. 25-200 microcontroller with programmable CPU FIG. 39-242, a wide angle motion detector FIG. 30-222; a photocell with V.O.C. (variable output capacity) FIG. 30-223; a wireless data, audio and video transmit and receive (transceiver) assembly; a audio speaker or annunciator FIG. 30-226; a battery array pack FIG. 34-253 with battery charge controller module FIG. 21-266 and battery current over limit protection FIG. 21-238; dual LED and/or incandescent dimmers FIGS. 22-248; and a 12 to 30 volt AC or DC power supply. The battery array pack FIG. 34-253 is a backup power supply consisting of deep cycle batteries with applicable power capacity.

The system is preferably interconnected by fibre optic cable and a wireless data, audio and video transmit and receive (transceiver) assembly. Communication and audio/video data is connected to the fibre optic cable on the outer case of the Sentinel Advanced Control Module FIG. 25-200. If either of the two methods of security interconnections are interfered with, then this will create a warning signal to the indoor control monitor. The fibre optic cable, if cut or dislocated, will also result in flashing of all luminaires at maximum output.

The wide angle motion detector FIG. 30-222 can be set to override some or all the programmable functions for the purpose of safety, energy saving or security. If the system is set for “alarm” or “security” function, then during the first stage, the wide angle motion detector FIG. 30-222 is activated by, for example, an intruder attempting to approach any secured area, and the Sentinel Advanced Control Module FIG. 25-200 which is programmed for this function will cause both the primary lamp/luminaire and all pathway luminaires FIG. 41-309 to ramp up in luminous intensity to a pre-selected output. During the second stage, with further intrusion, the actuation of a second Sentinel Advanced Control Module FIG. 25-200 will begin a ramping up of all lamps/luminaires in the system, and in doing so, dissuade said intruder from further approach. If motion ceases, then the system will ramp down to a low level of output until dawn. If motion detection continues, then during the third stage, all the lamps/luminaires in the system begin to flash ON and then OFF repeatedly. The further would-be intruders trespass, the greater is the number of activated flashing lamps/luminaires, and if connected to the optional timed irrigation water valves FIG. 23-278, will actuate all 3 water valves to further dissuade the intruder from remaining in the secured area. During the last stage, with the continued activation by an uninvited guest of two or more wide angle motion detectors FIG. 30-222, and if the re-set code is not entered either by remote control or at a Sentinel Advanced Control Module FIG. 25-200, then after a set time of full power light intensity flashing, the audio speakers or alarm annunciators FIG. 30-226 may be set to sound an alarm. The Sentinel Advanced Control Module 200 will de-energize the audible alarm, the irrigation system and all lamp outputs after a pre-set time delay.

The alarm sounding device can also be used to make the theft of the Sentinel Advanced Control Module FIG. 25-200 and/or luminaire a near impossibility. The same unpleasant high pitched tone and flashing lamp would cause most persons to simply drop the Sentinel Advanced Control Module FIG. 25-200 and/or luminaire and leave the area.

One embodiment of the Sentinel Advanced Control Module FIG. 25-200 also includes a means of producing a repeating audible recorded voiced announcement as follows: “Audio video monitor ON” or “Your presence here will activate an audio alarm, please leave the property” or other warning. This function can be conveniently deactivated at each Sentinel Advanced Control Module FIG. 25-200 and if tampered with the Sentinel Advanced Control Module FIG. 25-200 will not function for this purpose. For security, this function is energized by motion so that the repeating notification will not be disturbing. Reactivation of this function from a remote location will result in the statement being instantly repeated so that schemes to get around this requirement will be not rewarded. Equipment for this purpose without this device is available but our preferred design includes it. The audio warning may also be programmed to give an audible warning before or at any time during the intrusion event, for example, after a pre-set period of time before the lights begin flashing.

A complete system with sufficient Sentinel Advanced Control Modules FIG. 25-200 would quietly dissuade would-be intruders and once the system function became known among those who regularly resort to theft, etc., then these persons would know that the increasing light is only the beginning of the alarm process, and that not only would home alarms be in place, but the optional video camera FIG. 30-224 would provide identification of the intruder for police.

With respect to the noise pollution of false alarms, with the Bondy et al system the first lines of security are silent. If a false alarm has occurred, then the system will discontinue flashing lights and will continue illumination for a set time and then the flashing lights are de-energized, but without waking the neighbours. In the final stage, the audio speakers or alarm annunciators FIG. 30-226 are set for a default 3 minutes delay ON. One of the main reasons that perimeter alarm systems are not chosen is to for disturbing homeowners and neighbours, with false alarms being numerous in a typical residential neighbourhood.

The irrigation function could also be actuated as part of the security system, with sprinklers turning ON. When the security system is not set for “alarm” or “security” or “irrigation” setting, as for example when a group of people is gathered for a social occasion held in the evening, then, for the protection of homeowner(s), occupant(s) and/or guest(s), the irrigation function for alarm or other purposes will not be activated.

The security system functions during daylight, but since during daylight the artificial light is less noticeable, the system may be programmed to move quickly to the audio warning statements, and may be used both to alert residents or neighbours, or to dial for cell phone monitoring, or to increase the sensitivity of home indoor security.

With stair step lighting, when a person exits the house or someone approaches the steps, then the wide angle motion detector FIG. 30-222 energizes the stair step lighting and causes perhaps a second Sentinel Advanced Control Module FIG. 25-200 to illuminate the pathway to a sidewalk or to a parked car where yet more illumination is energized. Persons arriving are completely put at ease for illumination, however an uninvited guest can be identified by video camera FIG. 30-224 and intercom (not shown).

For areas where public safety is a concern, the built-in video cameras FIG. 30-224 would allow for monitoring of children, etc. With an upgraded transmitter, even remote areas such as bus stop shelters could be lit by a solar panel charge source and be triggered by an audible means.

We are aware of many possibilities regarding camera selection. Multifunction cameras are falling in price, and when pricing models make these cameras practical, one embodiment would include a video camera with lens guard and motion sensing and ambient light output data which would make possible the elimination of the photocell 219 and photocell with V.O.C. (variable output capacity) FIG. 30-223. However, we see a continued demand for these functions without the video camera FIG. 30-224 and microphone FIG. 30-225.

### Emergency Light

We further disclose the operation of the primary lamp/luminaire, or where required for safety, primary lamp/luminaires, and an exit sign, as emergency lighting during power failure, as follows: The primary lamp/luminaire(s) will be energized when the power supply is interrupted. The following are additional benefits: The emergency operation can be set to activate with the photocell over-ride or without. The lamp output at each location can be set according to luminous intensity requirements. One of the lamps may be of the multi-color adjustable type. If the lamp is programmed for the purpose, then the color lamp for emergency operation can be programmed into the Sentinel Advanced Control Module's FIG. 25-200 microcontroller with programmable CPU's FIG. 39-242 memory. The above allows for maximum visibility under smoke or other environmental conditions and when power is restored the primary lamp/luminaire and pathway luminaire FIG. 41-309 can be set to return to the auto-programmed function.

Another advantage is that the emergency exit luminaire with Lamp A FIG. 23-272 color can also be altered such that under difficult vision conditions the emergency exit luminaire with Lamp A FIG. 23-272 can be made to flash and guide persons toward the exit while Lamp B FIG. 23-277 is functioning to illuminate the pathway or stairway, etc. A great advantage of this means of emergency lighting is that the energy savings and aesthetic features may be utilized until testing or power failure. The luminaire is more economical by reason of dual function capacity.

As was earlier described, the Sentinel Advanced Control Module FIG. 25-200 for the LED Lamp A FIG. 23-272 color embodiment is rated at 30 watts (3×10 watts), and Lamp B FIG. 23-277 is rated at 50 watts. Therefore two 10 watt LED lamps can be supplied from the Sentinel Advanced Control Module FIG. 25-200 and can be dimmed by 50%. The Sentinel Advanced Control Module FIG. 25-200 may be internal to one of the luminaires with nominal 12 volt supply leads to a second LED lamp.

The system has been designed for outdoor/open air locations, however, we seen an energy saving advantage to be gained in this embodiment if used indoors. This embodiment can be U.L. (Underwriter's Laboratory) listed for building code compliant operation as emergency exit lighting in outdoor/open air areas. The remaining LED watt capacity of the above Sentinel Advanced Control Module FIG. 25-200 can be utilized for the illumination of an emergency exit sign.

We think that the value of the Bondy et al system is greatly increased by the potential to provide warm white light or other aesthetic effects, and in an emergency to change function and with or without a power failure become instead a means of providing illumination and guidance luminaires simultaneously for the purpose of safety.

In the main, emergency lights with battery back-up do not produce a desirable source of lighting. We see this as a duplication of illumination provision. It is the programmable output capacity which makes the Bondy et al system economical because, beyond reducing unnecessary duplication, the Sentinel Advanced Control Modules FIG. 25-200, lamps and luminaires can be set to provide desired or required luminous intensity and not more.

Emergency lighting has not been utilized as dual function lighting for many reasons. One of the main reasons is that lamp failure may cause a dangerous condition. However, as is well known in the industry, multi-LED emitter lamps can be constructed so that partial failure can be detected long before emergency operation would malfunction. A fail safe program may be entered which will detected failed emitters in the multi-emitter lamps. The program can be set to cause intermittent flashing such that lamp replacement is the only choice for normal operation. We claim this as original Intellectual Property.

### Portable Alarm and Site Illumination Embodiments

We disclose a system of lighting comprised of, but not limited to, multiple proprietary spherical luminaires FIG. 26-208 with a Sentinel Advanced Control Module FIG. 25-200 internal to each luminaire, a lamp, a wide angle motion detector FIG. 30-222, and including the options of a video camera FIG. 30-224, a wireless transmitter, and a battery array pack FIG. 34-253 with the necessary capacity, and a battery charge controller module FIG. 21-266. This embodiment provides system portability and monitoring from a remote location.

The luminaires are pre-charged and then placed temporarily at any location for overnight security monitoring from a remote location. Once placed, the light intensity can be adjusted to the required setting, and the wide angle motion detector FIG. 30-222 sensitivity set such that when the wide angle motion detector FIG. 30-222 is activated, the lamp may be pre-set to be energized, and the video camera FIG. 30-224 will be energized, and the transmitter will be energized, and thus with any quantity of the described luminaires, a building or any area within range of the remote monitor can be utilized for the prevention of vandalism and/or theft.

Since the monitoring station can be, for example, in a non-descript van, the need for persons to be exposed to the risk of injury is nearly eliminated, when compared to the risk to security personnel walking through a potentially dangerous area. If monitoring occurs during the night, then in the early morning, or any other suitable time, the Sentinel spheres (i.e., the Sentinel Advanced Control Module FIG. 25-200 within the proprietary spherical luminaire encasement FIG. 26-208) may be gathered quickly, and then recharged and brought back for the next shift of security monitoring.

With the proprietary spherical luminaire encasement FIG. 26-208 placed in stairwells, and/or inside or around a building, for the purpose of providing temporary illumination for safety on construction sites and/or areas with tools or materials, etc., such that the wide angle motion detector FIG. 30-222 will cause the lamp to be energized when a person or persons enters the area which is being secured from vandalism, but with the advantage that the illumination will make finding need materials, etc., less difficult. In the main, construction temporary lighting is set up eventually, however, during the interim the luminaires will be of advantage.

One embodiment that would serve both purposes would be with the proprietary spherical luminaire encasements FIG. 26-208 inverted as for down lighting, with a means of hanging the spheres fastened to the bottom of the proprietary spherical luminaire encasement FIG. 26-208 (i.e., the top when the spheres are inverted).

### Artificial Intelligence

We disclose an additional optional upgrade component which is manufactured elsewhere or for O.E.M. (original equipment manufacturer). The component expands the capacity of one microcontroller with programmable CPU FIG. 39-242, or multiple microcontrollers with programmable CPUs FIG. 39-242, as required, and is a means of integrating and introducing artificial intelligence and other improvements in the future operation of the Sentinel Advanced Control Module FIG. 25-200 in the same way that PCs/personal computers are upgraded. The additional capacity can be introduced into the fibre optic data stream and the auxiliary outputs may be utilized to energize the upgrade component.

The Sentinel Advanced Control Module FIG. 25-200 need never become obsolete, and it should be disclosed here that additional actuation means beyond voice recognition can be employed when cost effective, necessary or simply desired. For example, a small portable transmitter could be supplied to authorized personnel. Thus if a motion detector was actuated without the transmitter in range, a signal could be transmitted to staff or security.

### Smart Home

All features of the Sentinel Advanced Control Module FIG. 25-200 which are described in this document represent only the minimum of possibilities, and represent a simple, inexpensive and proven means of ‘smart home’ and/or ‘smart building integration’. The Bondy et al system is designed to integrate with ‘smart home’ and/or ‘smart building’ PC (personal computer) programming.

### Sentinel Advanced Control Module Housing and Component Layout

The Sentinel Advanced Control Module FIG. 25-200 is designed so that the optional components may be including during a production run, or not included. This will allow for the supply of demand, and to reduce waste when it is pre-established that the options not chosen would only cause waste. It cannot be later claimed that a similar device without any of these optioned devices could be manufactured less expensively without them and thereby serve a public good because the inclusion or absence of any of these devices can be batch produced and will reduce the cost of production by a very small margin and only the component itself would be the cause of a notable difference in cost. Therefore a competing manufacturer or more specifically a distributer need only ask for the product at a reduced cost and this could be very simply arranged. With or without the chosen options the appearance of the front outside face would not differ. The video camera could be assembled and also a similar or matched colored lens. It would be difficult for intruders to ascertain if the video camera was or was not included.

Thus the devices which may be optioned in the front case include:
i. liquid crystal (or other) display module FIG. 30-220;
ii. weatherproof momentary contact push-button switches FIG. 30-221;
iii. motion detectors of at least two types, which may include a wide angle motion detector FIG. 30-222 and a narrow angle variable long range motion detector FIG. 43-229, FIG. 22-229;
iv. photocell 219 or photocell with V.O.C. (variable output capacity) FIG. 30-223;
v. audio speaker or annunciator FIG. 30-226;
vi. audio input/microphone FIG. 30-225;
vii. video camera FIG. 30-224.

The above have a means of electrical interconnection with the back of the Sentinel Advanced Control Module FIG. 25-200 encasement via cords and cord connectors.

The back shell FIG. 39-216 of the encasement includes a means of encasement mounting by a minimum of the following methods of attachment or secure placement:
i. Wall mount: Two ⅜ inch circular voids FIG. 39-259 are open into the upper area of the back encasement wall space horizontally in proximity to the outer side edges of the back shell FIG. 39-216. The voids FIG. 39-259 elongated upwardly to form ¼ inch diameter voids FIG. 39-259 and thus with the ⅜ inch voids FIG. 39-259 the case may be fitted over a fastener with a head which is smaller than the ⅜ inch and with a shaft which is smaller than ¼ inch, thus if the fastener heads are not fully seated and a space is left for the back encasement wall to shift downwardly, then the housing can be made to hang from the described fasteners in a suitable manner. Note that the fibre optic cable connectors FIG. 34-252A, 252B are shown to jut out beyond the back wall. In this embodiment, a spacer could be used to leave room for the cable to fold out of the way. A more precise method would be either the fibre optic connectors directed 90° down or to 90° fittings and placement to allow space for correct surface mounting.
ii. A concave circular valley centered vertically and formed into the surface of the back shell of the encasement FIG. 39-216. Two hole-straps FIG. 39-257 for mounting can be made to friction/compression fit a tubular pole FIG. 39-260 or, with suitable means, fit larger or smaller diameter vertical stakes or tubing, etc. Circular voids are created during the molding process either side for the above straps. Threaded inserts are pressed into the back shell FIG. 39-216 which allow for corresponding machine screws for pole mounting FIG. 39-258 to be directed through the strap holes and then threaded into and tightened.
iii. Best shown in FIG. 28 is the void in the bottom shell FIG. 28-206, intended to accept the placement of the Sentinel Advanced Control Module FIG. 28-200 (or the 0.5 Sentinel Control Module FIG. 16-211). Two voids are formed in each shell, top shell FIG. 28-205 and bottom shell FIG. 28-206. The side wall (one of 4) FIG. 28-290 appears as an acute triangle, (for this description the shortest of the 3 sides), however, the side outermost to the shell is not straight but is formed by a small segment of the substantially spherical 360 degree outer surface. The plane formed (termed the “base”) by the above described surface is intended to be 100 percent wider at the narrow base. The latter will allow for a 3/16^{th} inch slot or groove to be formed vertically, which will extend 1.5 inches down towards the base of the described void, but leaving sufficient material such that the structure of the bottom shell FIG. 28-206 will not be compromised and thereby weakened. The mirror image of the surface described will also be modified in the same way, and also the top shell FIG. 28-205. Further, the front shell FIG. 28-215 of the Sentinel Advanced Control Module FIG. 28-200 will be formed with a protruding ridge on each side FIG. 28-291, one of 4 shown, and sized to correspondingly friction fit when slid down into place in the voids in the both the bottom shell FIG. 28-206 and top shell FIG. 28-205. (The front shell FIG. 17-217 of the 0.5 Sentinel Control Module FIG. 16-211 will also be formed with a protruding ridge on each side FIG. 17-291.) The ridge length will be nearly twice the length of the individual grooves, as described. The tolerance of the fit will be such that small variations during manufacturing will not cause jamming. Further, the base of the void and the ridges FIG. 28-291 may be sized to allow for a gasket between the formed surfaces. The top shell FIG. 28-205 will be formed as described for the bottom shell FIG. 28-206.

If optioned, the assemblies for two battery array packs FIG. 34-253 are interconnected and intended to form a single battery array FIG. 34-253. Also mounted is a 3-pin male connector FIG. 34-254 for the supply of the battery array FIG. 34-253. All are mounted between the back side of the printed circuit PC board FIG. 34-210 and the back shell encasement cover FIG. 36-216 such that the optional inclusion during or after manufacturing will be a simple and easily accessible component bundle with a battery array FIG. 34-253 which can be easily accessed for replacement.

Also on the back of the printed circuit PC board FIG. 34-210 is a second 3-pin male connector FIG. 34-239 intended for an optional auxiliary large capacity battery array 237 (not shown). In one embodiment as described, a third 3-pin male cable connector FIG. 34-230 would be included for optional transmit and receive (transceiver) module FIG. 23-227. Again, the placement of the transmit and receive (transceiver) module FIG. 23-227 would allow for the simple inclusion and placement of this option during or after manufacture.

A separate optioned detachable plug-in battery control and charger module 268 (not shown) comprised of a battery charge controller FIG. 21-266, fuel gauge FIG. 21-267, and battery over current protection FIG. 21-238, could be accessed behind one side of the battery array FIG. 34-253 of the Sentinel Advanced Control Module FIG. 25-200. Importantly, said battery control and charger module design 268 creates an unlimited potential for charge module embodiments for auxiliary large capacity battery arrays 237 (not shown), either direct from alternate energy sources or through the input terminals FIG. 35-250.

This embodiment is intended for a weatherproof or waterproof conductor termination junction box and that the communication conductors be terminated together and if a further extension of the conductors are required that the extension conductor be made to enter through a weatherproof PVC (or other) cable/box connector FIG. 35-261 separately and that all power supply conductors entering the enclosure through the weatherproof PVC (or other) cable/box connector FIG. 35-261 and thereafter be double insulated from the communication conductors. FIG. 35 illustrates the means of insulating and isolating the supply input. It illustrates the input terminals FIG. 35-250 and the input terminal cover FIG. 35-255 for double insulation of the supply input terminals FIG. 35-250 and weatherproof PVC (or other) cable/box connector FIG. 35-261. FIG. 36 illustrates that the back shell encasement cover FIG. 36-216 has voids for the output terminal strip FIG. 36-251 and the fibre optic connectors FIG. 34-252A, 252B.

The input terminal cover FIG. 35-255 can be modified as an isolated switch mode power supply SMPS module encasement FIG. 35-296 with the required depth to house the required components of the isolated switch mode power supply SMPS module FIG. 21-295.

On the output terminal strip FIG. 34-251, there are outputs for:
i. Lamp A FIG. 23-272: A nominal 12 volt output for a multi-color LED lamp maximum 30 watts which is of variable current outputs for, in one lamp control embodiment, RGB LED's with common, and in another embodiment, white, red, amber/yellow LEDs with common, and with a group modulator with a variable means total lamp luminous output while maintaining the selected lamp color output controlled by outputs from the microcontroller with programmable CPU FIG. 39-242. Thus each of 3 power leads has a 10 watt supply capacity.
ii. Lamp B FIG. 23-277: A nominal 12 volt DC terminal pair with a maximum 50 watt output with variable modulation by means of a means of variable voltage with a maximum nominal 12 volts and a selectable minimum voltage output memory.
iii. Lamp C FIG. 23-279: A nominal 12 volt terminal pair which is wide angle motion detector FIG. 30-222 actuated with a means of variable time delay ON. This output is one of all outputs which can be controlled by the microcontroller with programmable CPU FIG. 39-242.
iv. Lamp D FIG. 23-280: A nominal 12 volt terminal pair with a means of photocell actuated output for dusk to dawn lamp function with override from the microcontroller with programmable CPU FIG. 39-242.
v. A nominal 12 volt terminal pair for timed irrigation water valves FIG. 23-278, for one or more zone valve coils (or other), with time actuated control or other actuation from microcontroller with programmable CPU FIG. 39-242.
vi. A nominal 12 volt terminal pair with 24 hours/7 days output and a means of overload shut down and reset. This nominal 12 volt output FIG. 23-276 is controlled indirectly from the microcontroller with programmable CPU FIG. 39-242 by means of the overload and protection shutdown module FIG. 23-240.
vii. Two fibre optic communication/audio/video/actuation data and other cable connectors with feed through capacity FIG. 34-252A, 252B which form part of the optional fibre optic transmit receive module FIG. 21-236. The fibre optic strand or strands are the preferred means of moving data and communication from one Sentinel Advanced Control Module FIG. 25-200 to another, but also a means of safely entering an indoor space and connecting with or interconnecting to a central “smart house/building” monitor and control center equipped with all necessary means to optimize the security function and lighting, etc., with a means of distance monitoring, adjustment and control of all interconnected and individual Sentinel Advanced Control Modules FIG. 25-200.
viii. For the input power supply FIG. 34-250 there are two outer terminals for input power supply L1 FIGS. 34-273 and L2 FIG. 34-274 and a single center terminal for the optional communication input FIG. 34-275 with a means of weatherproof PVC (or other) cable/box connector FIG. 35-261 and input terminal cover FIG. 35-255 for double insulation of conductor and input terminals for protection and isolation to a maximum nominal 15 volts. Not shown is an insulating gel which hardens when exposed to air for insulating and isolating terminals on the input terminal strip FIG. 34-250. The input voltage is variable from nominal 12-15 volts AC or DC, and the third (center) terminal COMM FIG. 34-275 is provided for a secondary optional means of intercommunication between Sentinel Advanced Control Modules FIG. 25-200.
ix. An optional means of transmission isolation and reduction of voltage input with an isolated switch mode power supply SMPS module FIG. 35-295.

In short, under no circumstances is it intended that the communication conductor be utilized with voltage exceeding nominal 15 volts maximum. Other means will be made available for the communication conductor to exit the back of the Sentinel Advanced Control Module FIG. 25-200, including a two conductor terminal (not shown).

### Uplight to Downlight Conversion

The Sentinel Advanced Control Module FIG. 25-200 is made to fit a void of the Bondy et al proprietary spherical luminaire encasement FIG. 26-208. The proprietary spherical luminaire encasement FIG. 26-208 is comprised of two halves which are made to fit together.

The lamp conductors for the pathway luminaire FIG. 41-309 and the lamp FIG. 26-39 in the luminaire are first connected by conductors to the terminal strip at the lower back side of the Sentinel Advanced Control Module FIG. 25-200, then a grease may be applied, and then a hinged cover is snapped down to cover the terminals (not shown). The Sentinel Advanced Control Module FIG. 25-200 is then friction fitted to the top half shell FIG. 26-205 of the proprietary spherical luminaire encasement FIG. 26-208, which is the half which houses the primary lamp/luminaire (not shown).

Then, with the conductors leaving the proprietary spherical luminaire encasement FIG. 26-208 fitted through the weatherproof supply conductor FIG. 35-261 (i.e, PVC (or other) strain relief compression cable box connectors), the bottom half shell FIG. 26-206 is also friction fitted in a manner identical to the top to firmly hold the Sentinel Advanced Control Module FIG. 25-200 in place in the proprietary spherical luminaire encasement FIG. 26-208.

The bottom half shell FIG. 26-206 of the proprietary spherical luminaire encasement has countersunk screw passages and the screws FIG. 28-204 enter female pressed alloy threaded fastening fittings. Plugs can then be pressed part way into each screw case for the prevention of corrosion.

The proprietary spherical luminaire encasement FIG. 26-208 is intended to be placed such that it is partly covered with ground cover or soil, or placed on a flat surface, or mounted upside down for the purpose of down lighting. For down light function, the Sentinel Advanced Control Module FIG. 25-200 is placed inside the proprietary spherical luminaire encasement FIG. 26-208 so that it will be upside down when the luminaire and lamp are facing up, but when the luminaire and lamp are mounted upside down, the Sentinel Advanced Control Module FIG. 25-200 will be oriented for setting and the liquid crystal (or other) display module FIG. 30-220 will be right side up, and the rain guard FIG. 30-213 will also be at the top. This greatly simplifies conversion requirements.

### Multiple Sentinel Module Proprietary Spherical Luminaire 180°/240°

The proprietary spherical luminaire encasement FIG. 26-208 is composed of two half shells of a sphere: an upper half shell FIG. 26-205 and lower half shell FIG. 26-206. A void is made during manufacturing, as seen in FIG. 28, which allows for the placement of a single Sentinel Advanced Control Module FIG. 25-200. In a down light arrangement, the Sentinel Advanced Control Module FIG. 25-200 can be placed 180 degrees inverted such that the Sentinel Advanced

Control Module FIG. 25-200 can be made upright for mounting. We disclose an embodiment in which one or more Sentinel Advanced Control Modules FIG. 25-200 are fitted in the same way and the center line positions of these are described in radial degrees.

The proprietary spherical luminaire encasement FIG. 26-208 may be described a sphere with a midpoint such that a division along a midpoint plane results in two equal half shells. Thus, regardless of the alterations made to the half shells for utility, the circumference around each half shell may be divided into 360 degrees. The Sentinel Advanced Control Module can be described as having a placement at a vertical midpoint of 0 degrees.

We disclose an embodiment comprised of two Sentinel Advanced Control Modules FIG. 25-200 which are located at 180 degrees for dual coverage along a straight path or lane, etc. The proprietary spherical luminaire encasement (most likely to be implemented to function as a down light but might also function as an up light or in any configuration), or other luminaire, can be pre-set to energize illumination when persons approach the luminaire, and passing beyond the luminaire will cause the same as persons walk past. With a long pathway, the proprietary spherical luminaires (or other luminaires) can be mounted at required intervals to ensure path illumination. Thus not only path luminaires can be energized in this way, but aesthetic lighting is optional as well. The outer appearance will not be altered, except potentially when used with luminaires by others and a plexiglass or other type protective cover. The concept has a focus on safety, but allows for aesthetic illumination without wasting energy when no one is present to enjoy the dramatic effects. A narrow angle variable long range motion detector FIG. 40-229, FIG. 22-229 has been described as an option with, or in place of, the existing wide angle motion detector FIG. 30-222, which will make possible scene lighting.

When placed, for example, in public parks or university campus grounds, and utilizing LED or other lamps, such areas and paths can be very well illuminated with one very important advantage. The illumination can be available all night but energy will be conserved. The amount of energy conserved in this way will vary but, as can be opined, at 3 a.m. for example, in the main very few people would be likely to require the illumination, however, for those who do, it is likely a necessity. On campus grounds, for example, the optional and two-way video could be harm reducing and life saving, and a person or persons walking through the area would feel security in knowing that a call for help would bring assistance.

Where paths converge, we disclose a proprietary spherical luminaire as above but with three Sentinel Advanced Control Modules FIG. 25-200 located 120 degrees between centers, each with a wide angle motion detector FIG. 30-222, resulting in 360 degree wide angle motion detection, and video camera and audio function capacity. Thus persons entering from any direction along a pathway or road, etc., will be detected and path lighting may then be energized. Further, when persons(s) change paths at the intersecting pathways, then one of the other wide angle motion detectors FIG. 30-222 can be set to provide path lighting on that pathway also.

Other embodiments are also practical, such as 180 degrees circular centers of the Sentinel Advanced Control Modules FIG. 25-200 and also 120 degrees. Thus all available functions, or only those selected, could be utilized as described above, however, the 180 degree center Sentinel Advanced Control Modules FIG. 25-200 would allow for detection along suit a straight path or roadway, and the 120 degree Sentinel Advanced Control Modules FIG. 25-200 would provide more than ample bi-directional coverage when placed at a corner of a pathway, etc.

### Isolated Switch Mode Power Supply SMPS Module And Encasement

As will be illustrated in FIG. 24, we disclose a proprietary innovation to maintain the function of the overvoltage when transmission conductors to greatly reduce line losses or voltage drop, most specifically dimming, thus creating a system which is intended to provide energy savings, and with the LED lamps added slowly or all at once, an old system can be revamped and all components retained, but energy losses will be discovered, displayed and corrected via the microcontroller via the CPU and display.

This disclosure is a means of continuous isolation from wet contact to a maximum of 30 volts AC or DC comprised of the proprietary isolated switch mode power supply SMPS module 295 within the isolated SMPS encasement 296, and the weatherproof PVC (or other) cable/box connector 261, which can be optioned for use with the 0.5 Sentinel Control Module FIG. 16-211 and the Sentinel Advanced Control Module FIG. 25-200, and for continuity, the voltage and current modulated dimmers FIG. 8A, 8B.

National Electrical Code has ruled that “low voltage outdoor lighting systems” subject to wet contact be limited to nominal 15 volts AC or DC. Bondy et al believe we have met the National Electrical Code concern for harm resulting from possible electrical hazard due to wet contact. Once terminated and sealed, the proprietary means of transmission voltage isolation prevents contact with any metal or other conducting material until the voltage has been reduced to a maximum nominal 15 volts AC or DC. In our view, our disclosed wet contact isolation method is very much safer than commonly accepted methods of indoor power supply, which can expose 120 volts at the receptacle.

The input terminal cover best shown in FIG. 35-255 is extended by design to create a deeper bodied version for isolated SMPS encasement 296. The mold produces an encasement 296 with the same opening dimensions and the same form conforming mounting surface to the back of the printed circuit PC board FIG. 35-210 as the input terminal cover FIG. 35-255 (with gasket not shown), however the depth is increased to protrude as far back as possible without interfering with the surface mount back shell cover FIG. 36-216, FIG. 20-218, thus allowing more space for the isolated switch mode power supply SMPS module 295, and the 2 supply conductors 288 which attach to the input terminals FIG. 20-256 for the 0.5 Sentinel Control Module FIG. 16-211, or the 3 supply conductors 287, when including a communication conductor, which attach to 3 input terminals FIG. 35-250 for the Sentinel Advanced Control Module FIG. 25-200.

Where required, a qualified or licensed person would be employed to complete all terminations above nominal 15 volts. The 3 leads which exit the isolated switch mode power supply SMPS module 295 include 2 supply voltage options, to each of the 4 described embodiments for lamp and output control, of nominal 12 and 15 volts, and require pre-selection of voltage before mounting. These voltage options serve as descriptive to the function of the innovation. Other voltages might be chosen for use as per unforeseen circumstances or changes in National Electrical Code or for function in countries other than the U.S.A which might require an isolated SMPS with optioned or as built input voltages other than what has thus far been described. The

Sentinel Advanced Control Module FIG. 25-200 accepts nominal 12 or 15 volts AC or DC maximum. Nominal 15 volts AC or DC is required for the optional battery array FIG. 34-253. The 0.5 Sentinel Control Module FIG. 16-211 accepts maximum nominal 12 volts AC or DC.

A weatherproof PVC (or other) cable/box connector 261 is tightened into the K/O of the isolated SMPS encasement 296. The over voltage transmission conductors are slipped through and attached to the isolated switch mode power supply SMPS module 295 with a gasket in place. The isolated switch mode power supply SMPS module 295 in the isolated SMPS encasement 296 is pressure push-snap-locked into position. A compression nut (not shown) is turned and a round grommet (not shown) is compressed to become tightly sealed around the supply conductors FIG. 24-287, 288. The longer screw 297 is used to attach the isolated SMPS encasement 296 to the printed circuit PC board FIG. 35-210 for the Sentinel Advanced Control Module, and FIG. 20-249 for the 0.5 Sentinel Control Module. A reinforced area of the PC board includes a press fitted female insert of corresponding thread and trade size to allow for the mounting of the input terminal cover FIG. 35-255 or the isolates SMPS encasement 296.

Once completed the termination will provide either nominal 12 or 15 volts depending on the switch setting accessible before positioning. Three conductors exit the isolated switch mode power supply SMPS module 295 and the third clearly marked COMM for communication conductor is only utilized when chosen for the Sentinel Advanced Control Module FIG. 25-200; otherwise it is taped.

We recommend NMWU or NMDU cable (14/2, 12/2, 10/2 for 2 conductors and 14/3, 12/3, 10/3 for 3 conductors) with the bare copper snipped back to the sheath and wrapped to cover with electrical tape. The red and black conductors are trade designated for low voltage DC. The identified conductor (white/grey) will then be taped suitably to cover all exposed portions of this conductor with yellow or brown or other colored tape, and is used optionally for the Sentinel Advanced Control Module FIG. 25-200 as seen in FIG. 35.

A continuous seal for further termination in a PVC (or other) weatherproof box is required prior to the power supply source if the communication cable is optioned. All taping of conductors is repeated and all required conductors from the low voltage power supply 24 volts or 30 volts Class 2 low voltage outdoor, are fed into said box. In this way the communication conductors will be electrically and mechanically connected without entering the power supply transformer housing. Once the PVC (or other) box is sealed and the isolated switch mode power supply SMPS module FIG. 24-295 is pressure push snap locked for isolation, then the remainder of the terminals and conductors will be a maximum nominal 12 to 15 volts AC or DC.

Connections at the applicable Class 2 transformer will be UL designated for outdoor low voltage nominal 30 volts maximum. A warning of hazard will be marked clearly as per Underwriters Laboratory UL and National Electrical Code requirements. Potential electrical hazard above nominal 15 volts occurs only by ignoring hazard warning labels and breaking open the isolated SMPS encasement 296 or other potentially hazardous components, i.e. junction boxes and supply transformers, all of which are to be marked as hazardous when placed for potential wet contact.

In addition, the described isolated switch mode power supply SMPS module 295 and isolated SMPS encasement 296 can be of the original size to fit the incandescent dimmer for halogen, etc., as shown in FIG. 8A, or the 3 color LED input dimmer as shown in FIG. 8B. The cover in this instance will include a gasket (not shown) and be fastened with a screw and, as required, sealant. The output from the isolated switch mode power supply SMPS module 295 will range from nominal 12 volts maximum to both the incandescent and LED dimmer modules of FIGS. 8A and 8B. Said encasements FIG. 8A-80, FIG. 8B-80 are formed by a bottom and top shell.

We disclose an embodiment which will include an input terminal location and the required seating surface such that each of the form conforming dimmer modules as seen in FIGS. 8A and 8B would include both the mount location and the female threaded press fitted insert as above. Thus, in each embodiment outer encasements are formed to accept either the input terminal cover FIG. 25-255 or the isolated SMPS encasement 296 as required.

In all cases the isolated switch mode power supply SMPS module 295 and isolated SMPS encasement 296 has been designed with safety as the first priority, however, the benefits can include considerable reductions in power or line losses for nominal 12 volt supply conductors, which cannot be made to carry voltage for dimming (i.e., nominal 6-12 volts) without very high losses or control from the point of supply, unless the supply conductors are large enough to limit these losses.

Bondy et al are working to reduce energy waste, but since the alterations to National Electrical Code, we have altered and isolated the transmission conductors with voltage above nominal 15 volts AC or DC. We consider the described means of over voltage transmission supply conductors in our previous applications and the above improvement for National Electrical Code compliance with respect to wet contact, to be of novel and unexpected benefit. This will be further indicated with the displayable percent voltage drop due to of conductor losses, and the load in watts which can also be set for read on the display, thus providing a means of determining voltage drop percentage, either on local display or remote.

### Connection to a Nominal 120 Volts and Above

Another embodiment is made compatible with National Electric Code for connection to a nominal 120 volts and above by means of a (non-conductive) weatherproof encased 120/12 volt or other input voltage electronic switching power supply or transformer or other, by means of which the supply may be switched from a remote location, and may be utilized to supply one or more low voltage Sentinel Advanced Control Modules FIG. 25-200 and luminaires

Optimally this arrangement would include an indoor wall mount GFI feed through circuit which supplies the power should be protected by a pass through GFI device. The weatherproof U.L. approved power supply voltage reduction module would have an accessible means of power supply interruption, and without a receptacle, then the means of disconnect would necessarily be clearly marked as to the primary voltage, and that this portion of the embodiment is dangerous and not to be connected to or confused with any other luminaires of low voltage at that location.

This is simply a conversion of a remote 120 volt luminaire to create a remote low voltage outdoor power supply which might otherwise be located at the building. A U.L. approved power supply voltage reduction module with a U.L. listed means of connection to electrical power supplies of higher voltage. As for example a lamp of a nominal 120 volts AC, and for further example, in the form of a driveway luminaire mounted on a suitable structure and switched from a remote location.

The low voltage luminaire or Sentinel Advanced Control Module FIG. 25-200 with a suitable weatherproof means of connection would make possible a substantial upgrade in function such that with some or all of the listed components the replacement luminaire can be provided to increase safety and reduce energy consumption with the added potential to produce aesthetically pleasing landscape and architectural lighting effects. The indoor switch in this case need not disconnect the supply, and if indoor remote control is desired we have described several means.

### Battery Over Current Protection and Battery Charge Controller

The battery over current protection module FIG. 21-238 is comprised of an adjustable means of charge current control for the purpose of limiting current either flowing to or from the battery array FIG. 21-253. Once overloaded, the circuit will open and a program in the microcontroller with programmable CPU FIG. 22-242 will display the current reached and potentially the battery temperature via a thermistor (not shown) which may be required depending on battery type.

Any Sentinel Advanced Control Module FIG. 25-200 which includes the battery array pack FIG. 34-253 can be programmed to minimize line losses in supply conductors as follows: A system of battery array pack FIG. 34-253 charging wherein the input voltage is established at a point beyond the over current protection and control module FIG. 21-238 via a voltage divider FIG. 23-269 comprised of resistors R1 and R2, and a voltage drop is limited such that the drop will not exceed a pre-set value above a set maximum percentage, and the control is comprised of a current limited device which will allow current flow only when the applied voltage ranges above the pre-set value for the purpose of reducing energy losses resulting from voltage drop caused by excessive loading of supply conductors relative to the length and AWG wire designation and voltage of the conductors, and to allow for a greatly increased luminous intensity along a pathway or any illuminated area where it is pre-established that the charging time of the battery array pack FIG. 34-253, in the main, is greater than the load operation time of the device which is intended to be utilized, and in this instance a lamp, but also applicable to a pump or other electrical load.

The battery charge controller module FIG. 21-266 includes a variable means of controlling the flow of electrical current and/or voltage to a battery or battery array pack FIG. 34-253 for the purpose of storing electrical energy for use when needed, and this means of adjustment is based on a range of variable voltage parameters such that: (a) The rate of charge and voltage is predetermined to maximize the potential number of charge and discharge cycles for the purpose of extending cell function. The input voltage of the battery charge controller module FIG. 21-266 is limited by the voltage divider FIG. 21-269 via the microcontroller with programmable CPU FIG. 39-242. (b) The ammeter FIG. 21-294 and current limiter and protection module FIG. 21-263 may detect a fault regardless of the component, since nearly all components are in conductor contact with the microcontroller CPU FIG. 39-242 and all outputs can be switched individually. Then, if a diagnostic test was pre-programmed to run via ‘auto’ or by command, which energizes one component at a time (not including the 5 volt power supply or the CPU), would result in a component fault which will be detected and displayed by means of a manufacturer installed default program.

In addition to the optional battery array pack FIG. 21-253 is an optional secondary output for an auxiliary large capacity battery array 237 (not shown). The optional primary output for battery array FIG. 21-253 has the capacity to charge the described 1.4 Amp/hour nominal 12 volt battery array and, when optioned, a secondary auxiliary large capacity battery array 237 (not shown) ranging to and beyond a nominal 0.5 kW/hours at nominal 12 volts such that a solar panel could be directly connected to the input terminals.

A separate optioned detachable plug-in battery control and charger module 268 (not shown) comprised of a battery charge controller FIG. 21-266, fuel gauge FIG. 21-267, and battery over current protection FIG. 21-238, could be accessed behind one side of the battery array FIG. 34-253 of the Sentinel Advanced Control Module FIG. 25-200.

In this way, changes or capacity adjustments, as with the described auxiliary large capacity battery array 237 (not shown), could be optioned and not simply redundant. The cost of the Sentinel Advanced Control Module FIG. 25-200 would be reduced and made more affordable for purchasers who do not require this capacity. However, attachment to the female 4-pin module connector can be made at any time after purchase. The system is created as a building block optioned control.

A second optioned detachable plug-in battery control and charger module 299 (not shown) might occupy surface area made available without the on board battery array FIG. 34-253 on the printed circuit PC board FIG. 34-210 of the Sentinel Advanced Control Module FIG. 25-200, for example, for use with auxiliary large capacity battery array 237 (not shown). Thus, the charger modules would be optional, reducing redundancy and cost where not required, but would also makes possible a battery control and charger module specific to a desired battery array which may not yet be available or may be cost prohibitive at this time. We disclose a system of battery charger modules which is not limited in variation, and with an additional means of input to the printed circuit PC board of the Sentinel Advanced Control Module FIG. 25-200. The optional renewable energy source is solar panel. A charge rate of 200 watts/hour would result in a nominal 2 kW/hour storage which, owing to the efficacy of the Sentinel Advanced Control Module FIG. 25-200, would provide nominal 1.5 kW/hours into the home.

We disclose a programmable or default means of staged Sentinel Advanced Control Module FIG. 25-200 battery array charging FIG. 21-253 order. Beyond this, the microcontroller with programmable CPU FIG. 22-242 can be programmed to meet the needs of current flow through one battery charge controller FIG. 21-266, and switch on the next Sentinel Advanced Control Module's battery charge controller FIG. 21-266. Each Sentinel Advanced Control Module FIG. 25-200 is in a series of Sentinel Advanced Control Modules FIG. 25-200 on one supply conductor.

The Sentinel Advanced Control Modules FIG. 25-200 are programmed to assign an address to each Sentinel Advanced Control Module FIG. 25-200. The address by default is determined by the unloaded supply voltage. It may be possible that the battery arrays FIG. 21-253 of the Sentinel Advanced Control Modules FIG. 25-200 charge at different rates without hindering the most efficient and array preserving charge stages.

The Sentinel Advanced Control Module FIG. 25-200 closest to the supply will read the highest zero load voltage drop and will begin to increase until a maximum at the last Sentinel Advanced Control Module FIG. 25-200. When the battery array FIG. 21-253 of the first Sentinel Advanced Control Module FIG. 25-200 is completely charged, the second in the series reserves the greatest amount of the available charge current, and at a point the last in the series would be triggered by the programmed microcontroller with CPU FIG. 39-242 to also begin charging. The first one day becomes the last the next day. This is so that all of the battery arrays FIG. 21-253 of the Sentinel Advanced Control Modules FIG. 25-200 are given equal opportunity to move through a staged charge with full power stage one current flow. In all cases the first Sentinel Advanced Control Module FIG. 25-200 for each will take precedence, and any remaining current will flow to the next Sentinel Advanced Control Module FIG. 25-200, and potentially a third or fourth. In short, each Sentinel Advanced Control Module FIG. 25-200 will take the first position in rotation.

The voltage divider formed by the resistors FIG. 21-269 can be utilized to reduce current flow via the CPU and either via the battery charge controller FIG. 21-266 for charging or the current limiter/over current protection/ammeter module FIG. 21-265 for all loads combined.

An ammeter FIG. 21-294 also located in the current limiter/over current protection/ammeter module FIG. 21-265 with the voltage divider via the microcontroller with programmable CPU FIG. 39-242 allows for total power in watts to be indicated when desired on the liquid crystal (or other) display module FIG. 21-220 or at a remote location via the common means among the several other potential functions. In the current limiter/over current protection/ammeter module FIG. 21-265, the current protection makes possible:
i. That from the zero load voltage as measured by the above voltage divider, and the voltage reduction caused by line losses resulting from a range of potential loads can be reduced via programming limits for voltage drop.
ii. That said current limiter FIG. 21-292 via the microcontroller with programmable CPU FIG. 39-242 can be utilized to reduce current flow regardless of the load so that the total percent voltage drop is not surpassed. The percent voltage drop can via the microcontroller with programmable CPU FIG. 39-242 also be indicated on said liquid crystal (or other) display module FIG. 21-220.

We disclose the first line loss indication and reduction means for ‘low voltage outdoor lighting systems’ and for charging onboard or external battery array. Regardless of the type of load which the Sentinel Advanced Control Module FIG. 25-200 is supplying, the supply conductor percent line losses can now be indicated without external meters. We believe that said losses in ‘low voltage outdoor lighting systems’ may include conductors sized for this purpose but end users not aware of this unseen energy drain might be dismayed to learn of this ongoing waste.

Disclosing another of many components, the said components can also be utilized to determine the loads in watts on each lamp output individually, and thus the microcontroller with programmable CPU FIG. 39-242 via said components can be programmed to isolate as quickly as possible the Sentinel Advanced Control Module FIG. 25-200 from the input supply and/or isolate any load which is creating an over current condition. This can be done as fast as the microcontroller with programmable CPU FIG. 39-242 can switch OFF and back ON all outputs. Depending on the energy of the fault, this process could conceivably occur fast enough to protect the Sentinel Advanced Control Module FIG. 25-200 without a complete shutdown. Otherwise, during or following the fault, the current limiter can be utilized, via the microcontroller with programmable CPU FIG. 39-242, to follow the above process at reduced current flow. The overload can be determined and the caused corrected.

We have disclosed the first ‘low voltage outdoor lighting system’ fault current limiter, protection and/or isolation and indication means via remote or onboard display. Said fault can be located as the speed which the microcontroller with programmable CPU FIG. 39-242 can energize each output. The overload which will trigger a complete and instantaneous current interruption will be factory pre-set.

### Voltage Drop Control

We disclose a system of long distance functional lighting which keeps line losses within the range of National Electrical Code, and this is accomplished by means of rechargeable battery arrays which charge during day and night.

The following is an example of the novel distance path lighting means of the Sentinel Advanced Control Module FIG. 25-200. The calculation will indicate that the provision of 430 watts of LED illumination (comparable to 1290 watts halogen) along a 200 meter path will result in line losses of 3% or less utilizing No. 10/2 AWG. All figures are approximated but in every case will be rounded up to ensure ample supply power for the described lighting requirements.

From National Electrical Code tables it is determined that the provision of 430 watts along a 200 meter path at nominal 12 volts will require cable of 2 conductor AL4Ø for the first 60 meters for a 5% voltage drop. We will not proceed with this potential means because it is already proven absolutely unreasonable. Either a very large cable will be required, or multiple runs of the described cable. The cost to purchase the above cable and provide for distribution via weatherproof junction boxes at each module or to provide for fewer junction boxes but then requiring yet more branch supply conductors would be exorbitantly costly. It has been concluded that excavation for this 200 meter pathway will be very destructive using an excavator and a formidable task by manual labour. Rigid metal conduit is considered and also the covering of the cable with concrete. All methods are simply untenable either by cost, or destruction of the neutral terrain, or both. Thus a 120 volt system, which must also include a switching means and additional trenching for installation of luminaires, is possible but extremely undesirable.

It has been determined that an average of 2.3 watts of LED lamp illumination will be required per meter (nominal average), totalling 430 watts for the total pathway length. To meet this requirement with low voltage luminaires limited to nominal 12 volts will require a conductor capacity of 28 amps and from National Electrical Code tables, it is determined that 30 cable will not allow for more than 62 meters at nominal 12 volts. Other possibilities include trenching the 200 meter length to the required depth for 120 volts nominal, but with rock and roots this is not chosen. Rigid conduit is considered but this too would be exorbitant.

We will prove the merit of the Bondy system by overcoming the above problems, and will indicate how much more efficient and simple the solution is. Each of 12 Sentinel Advanced Control Modules FIG. 25-200 is fitted with the optional battery array pack FIG. 34-253 of 1.4 Amp hours at nominal 12 volts.

The first large step in solving the problem is by nature of the fact that the Sentinel Advanced Control Modules FIG. 25-200 spaced along the path are fitted with wide angle motion detectors FIG. 30-222, thus the lighting is available when required but need not function otherwise. The Sentinel Advanced Control Modules FIG. 25-200 also include battery array packs FIG. 34-253 which allow for 45 minutes a day of the required illumination, which is estimated to greatly exceed requirements.

The Sentinel Advanced Control Module FIG. 25-200 with wide angle motion detector FIG. 30-222 and battery array pack FIG. 34-253 is considered and it is calculated that with a 30 volt supply, and a maximum estimated time ON time per day is 45 minutes with a 3 minute delay for each Sentinel Advanced Control Module FIG. 25-200. A maximum of 15 trips either way after dark is considered a very good provision for the possible requirements with a built in 25% reserve. Plus the Sentinel Advanced Control Module FIG. 25-200 can be programmed to reduce output from maximum if more than 15 passes are required. Thus 12 Sentinel Advanced Control Modules FIG. 25-200 will be required. The isolated switch mode power supply SMPS module FIG. 21-295 will be required at each Sentinel Advanced Control Module FIG. 25-200 with nominal 15 volt output.

Because ultimately safety is the primary concern, the system can be programmed to allow for greatly increased line losses. There is no inherent danger is this arrangement as the load is 14 Amps, however there would be no need for hasty and drastic measures. With the described 25% margin of reserve, it would be a simple matter of allowing for increased line losses until, if necessary, the load is carried by the power supply.

The path may be used for 45 minutes per day, which when divided into 6 segments each of 33 meters, may be set for a 3 minute OFF delay and this will allow for 3 minutes to walk each 33 meters. The result is that 15 trips per day can be made without exceeding the calculated 15 watts of daily supply conductor loss, and all of this is made possible by means of the Sentinel Advanced Control Module FIG. 25-200 with wide angle motion detector FIG. 30-222 and optional battery array pack FIG. 34-253. With a 24 hour charge period at 1.3 Amps/hour from a 300 watt 30 volt power supply, and a nominal FIG. 25-200 meters of No. 10/2 AWG cable with an absolute minimum disruption to the local environment.

From National Electrical Code tables it is indicated that with the use of No. 10/2 NMWU cable, the 1.3 amp load at 30 volts will cause a 6% voltage drop over 200 meters. However, the actual figure is 3% and this results because the nearest Sentinel Advanced Control Module FIG. 25-200 voltage drop is 0.5% and as distance is increased incrementally the resulting average is 3% as stated. The 3% loss, however, is a portion of only 1.4 Amps=0.042 Amps/hour. Thus 0.5 Amp/hours per day at 30 volts=15 watts per day. The magnitude of this improvement in line losses is, in our view, astounding. Thus 200 meters of pathway is very well illuminated with 430 watts of LED lamps in luminaires (the equivalent of 1290 watts of halogen).

There are 12 Sentinel Advanced Control Modules FIG. 25-200 along the path. They must have a combined capacity of 430 watt/hrs per day, thus 430 watt/hr÷12 Sentinel Advanced Control Modules FIG. 25-200=36 watt/hr each. Each of the 12 Sentinel Advanced Control Modules FIG. 25-200 will require 36 watt/hrs (430 watts/hr÷12=36 watts/hr) of storage capacity to produce 1 hour of standby. At this point a contingency will be added of 4 watt/hr. Thus, for calculation purposes, each 60 minutes of Sentinel Control Module operation will require 40 watt/hrs. However, it has been determined that the maximum estimated 45 minutes of path illumination per day will allow for 15 after darkness trips along the path and a reserve of 25% will remain.

We will include a contingency to allow for potential losses depending upon battery type and ambient temperature. With a 4 watt contingency, the requirement is now 40 watt/hr per Sentinel Advanced Control Module FIG. 25-200. The 15 minute reserve results in therefore with 30 volts supplied and a demand of 40 watt/hrs with a current flow of 0.6 Amp/hr each hour of the day (24 hours).

While being set up, the Sentinel Advanced Control Modules FIG. 25-200 are set to limit voltage drop. The microcontroller with programmable CPU FIG. 39-242 inputs data from the supply voltage by means of a voltage divider with an input to the CPU which controls current flow through the over-current limit control circuitry. It will then seek out all connected Sentinel Advanced Control Module FIG. 25-200s and addresses will be numbered in order of voltage, highest to lowest.

Each Sentinel Advanced Control Module FIG. 25-200 will then be ready for a voltage drop percent selection measured from the highest voltage in the group. Once set, for example to 3%, the Sentinel Advanced Control Modules FIG. 25-200 are programmed to charge to limit the voltage drop from the lowest detected reading to 3% reduction maximum. The charging order will be counted and staged in series, thus the first on day one becomes the last in order the next day, and this will prolong battery life since the first battery charged will, near the end of the cycle or at any time. However, it is decided that given the Sentinel Advanced Control Module FIG. 25-200 capacity to reduce charge rate to correspond with the 24 hour prior cycle requirement that with 8 trips the maximum voltage drop will be reduced to 1.5%.

With several Sentinel Advanced Control Modules FIG. 25-200 in a series, connected across a long supply conductor pair, the charge controller includes a means of detecting voltage which will measure the unloaded voltage at each luminaire in this series. The highest voltage reading will be closest to the power supply, and the lowest at the far end. The charge control program in the microcontroller with programmable CPU FIG. 39-242 will indicate Sentinel Advanced Control Module FIG. 25-200 addresses counting from the first. Voltage drop maximum, which is pre-selected, will be measured from the first Sentinel Advanced Control Module FIG. 25-200. Each day the charge will shift forward to the next Sentinel Advanced Control Module FIG. 25-200 such that the first Sentinel Advanced Control Module FIG. 25-200 charged the first day will be charged last the next. This simple programming arrangement will optimize the battery array pack FIG. 34-253 charge efficiency and cycle life.

The Sentinel Advanced Control Modules FIG. 25-200 are set up along a pathway which is illuminated for after dark passage. Staging areas may be included consisting of minimal illumination. Once this point is reached at either end of the path, wide angle motion detectors FIG. 30-222 actuate path lighting consisting of a variety of luminaires as required.

Beyond this are a potential of:
i. 45 minutes of path illumination in the event of a power supply interruption.
ii. Optional means of calling for assistance at 12 locations along the path.
iii. Optional audio and video monitoring for notification or security.
iv. Emergency operation at a nominal 50% illumination if the battery array pack FIG. 34-253 is completely discharged.
v. Optional voice recognition.
vi. Optional capacity to speak to persons on the path.
vii. The Sentinel Advanced Control Modules FIG. 25-200 pay for themselves via energy conservation, and in this particular case, the Bondy et al system was the only sensible choice.
viii. The system can be connected to alternate energy supply directly and by adjusting allowable voltage drop to 4%, a 24 volt supply will produce the same results as 30 volts.
ix. A 2.0 Amp 24 volt water turbine may also be directly connected and create a closed loop system of the most astounding efficiency.
x. With optional auxiliary large capacity battery array packs 237 (not shown), the system would have double or triple storage capacity with battery housing provided by proprietary spherical luminaires, optionally used as down lights at landings, etc.

### Provision of Alternate Energy to the Home

In an embodiment of a complete system, all of the energy required for year round operation is produced as close as practicable to each Sentinel Advanced Control Module FIG. 25-200. The power supply conductors are a practical and perfectly sized means of bringing alternate energy ‘into the home’ and not out of it. It will then be seen that the first step in the process of system assembly, ie; the provision of energy from the home, will later serve to eliminate one of the last steps of alternate energy system assembly, i.e., the means of the provision of alternate energy ‘to the home’.

The battery we have chosen for description purposes is Lithium Ion. In our view, in time, lower material cost or new design and manufacturing developments will make possible battery arrays with capacity similar to lithium ion more cost-effective. Then much more storage capacity will become practical: in short, less cost, less volume, less mass. Alternate energy has a weakness: power requirements are often beyond available daily electric generating capacity. However, when storage capacity is large, then homeowner(s) and/or occupant(s) time away can result in a potentially huge reserve capacity when demand is resumed. This is what we intend to offer. When the prices are reduced, then Lithium Ion or similar battery arrays would allow for our proprietary luminaire housing to store many times more energy than typical lead acid or nickel-cadmium batteries. The provision of 0.5 kilowatt/hours of storage for nearby solar panel array is cost effective when consideration is given to the potentially pre-existing lighting power supply conductors or in light of the fact that isolation of 30 volt terminals allows for the described conductors to feed energy to a central location while safely segregating and isolating the energy sources. This will allow for the full utilization of energy not required for outdoor lighting, with a reduction in the capacity requirement of an indoor battery containment area.

The additional function can be harvested by means of a dual fused buss-bar and, if desired, an AC inverter. However, with improvements in lamps and also the low operating voltage of LED lamps we see no need to invert the described DC supply, and even in the case of halogen, greater efficiencies are available at 24 volts DC than could be produced at greater expense through an inverter at 120 volts AC with the attendant transitional losses.

Importantly, the intent is for the Bondy et al system to merge with the indoor control system and in all arrangements be upgraded without loss or redundancy, nor is this integrated system likely to be quickly outdated. Evidently the outdoor lighting system can be arranged to supply some or all of the indoor lighting requirements while maintaining complete control of an expanding and diverse system from a central indoor location and preferably a home/office personal computer.

It may be surprising to note that where outdoor lighting is a requirement, then providing for such lighting by means of photovoltaic collection and storage can be done by other means, but in our view at considerably greater expense, and to provide the means of delivery more efficiently is, again from our view an unlikely potential, but to also provide the several additional potential functions at such low first cost and high operational efficiencies is, from our understanding, without our claimed Intellectual Property an impossibility at this time.

### Optional Reflectors

In a large professional landscape/architectural lighting system there are many luminaires chosen and thus for the following reasons (for our purpose) we will limit the individual lamp output to 800 lumens or 50 watts halogen. Larger lamp outputs would be common in large commercial projects, but for typical residential design 800 lumens is considerable as this represents the output of an automobile headlamp. Beyond this, two luminaires could be implemented to provide 1,600 lumens, which might be sufficient to cause neighbours to complain. In the lighting choice there is the output which is variable under different conditions. Thus instead of choosing between 50 watt, 35 watt and 20 watt halogen luminaires, the same outputs could be matched by means of the proprietary LED lamp FIG. 9B, first by utilizing proprietary spherical luminaire encasements (or any other luminaires of other manufacture) and then making use of the dimmer. The range of luminous intensity from 800 lumens to 200 would be very simply provided for.

Beyond intensity is the beam spread such as wide flood, flood, and narrow flood, and then wide spot, spot and narrow spot lamps, and luminaires for wall wash lighting. It is well known in the industry that the focus of its multi LED lamps is achieved very often with reflectors on individual emitters internal to the lamp. This is however one of the reasons that the actual efficacy of lamps constructed in this way is much reduced. Our concept is to follow the lead of the PAR (parabolic lens) and mount the emitter to this reflective backing. The light will then be somewhat homogenized by the refractory lens. Without a reflector this method would result in a very wide flood lamp effect, and very likely too wide for most applications.

We therefore make use of lamp collar reflectors of varying angles. The above will allow for the reflecting of light within the desired beam spread for narrow spot lamp effect. It would be necessary to create a reflector with a nearly 90 degree collar surfaced with reflective material and the depth of the collar would be increased as needed to limit beam spread. The collars can also be utilized for down lights, and also to reduce the visibility of the lamp lens itself.

The same principle can be applied to the embodiment of the proprietary spherical luminaire encasement that utilizes the light tube and canopy to convert it into a path light. The light tubes can be varied in transparency and the canopy varied in reflector angle, resulting in a wide range of potential light footprints. For the pathway luminaire FIG. 41-309, a reflector is designed to reflect the functional light in the desired or required direction.

Although not shown, we disclose a range of reflectors for our proprietary luminaire to produce required beam spread, including inverted collars which are of chrome plated tubing. A cut in the reflector tube at 45° would allow for a down light or up light wall wash.

### Water/Brine Cooled Heat Sink for High Output LED Lamps (Down Light)

The long favoured halogen has resulted in much increased LED operating temperatures. Historically LEDs have been a great benefit to many industries for more than 20 years as indicator lamps. The function of indicators did not include the current challenge of high temperature failure. It is evident when doing product research that replacement LED lamps which are rated for lumen output comparable to a 50 watt PAR 36 halogen at a nominal 800 lumens are almost invariably placed in metal alloys or aluminum, etc., which conduct heat away from the relatively fragile and temperature sensitive LEDs. Most commonly convection is relied upon to dissipate heat from the housings and thus the LEDs. A small fan can be utilized for this purpose as have been much improved for decades for the purpose of cooling computer chips. We have devised a novel means for cooling LEDs in our LED lamp embodiment.

While researching new source of component for product development, we have become aware of a much referred to temperature, such as is a typical operating nominal temperature for LED lamps of many different manufacturers, namely 100° C. We were struck by the fact that this is the evaporative temperature of H2O. Basics of HVAC engineering brought to mind the latent heat of evaporization of water 970 BTU/lb/hour. With simple calculation, 970 BTU is converted to 310 watts/hour. Heat output from one multiple emitter LED lamp could range to 5 watts if the LED lamp output was being rapidly and repeatedly modulated.

Since the heat losses of a nominal 800 luminous intensity LED lamp which consumes maximum 30 watts is unlikely to exceed 10 watts, it follows that the evaporation of 0.5 ounces of water will dissipate 10 watts per hour. Further, if the water is enclosed and in constant contact with the heat sink of the LED, then the temperature of the LED heat sink will not substantially rise above 105° C. if constructed of a suitably high conducting material and is correctly sized. The enclosure could therefore be a covering for any odd shape for this purpose. For example, a finned tube can be shaped into a spiral into which water is sealed. The spiral rises on coils above the heat sink, then terminates on a plane just below the heat sink in such a way that water condensing in the tube will re-enter the heat sink chamber as fast as the liquid is vaporized.

The convection cooling of the cooling tube material is greatly increased by reason of the fact that the steam created by the LED array or single LED moves rapidly upward and away from the heat source creating a much greater temperature difference along the length of the heat sink than would occur by convection alone. The greater the temperature difference in convection cooling, the greater is the cooling efficiency.

Thus a very simple spiral tube within the proprietary spherical luminaire with a measure of light non-corrosive brine will replace very complicated and expensive heat sinks of other design, as for example heat sinks composed of much more heat sink material which is in the example required due to the fact that the temperature difference between the heat sink material which is closest to the LED emitter(s) and the material furthest away from the LED emitter. The spiral might be formed into other shapes for visible use indoors.

This design is suited to the down light embodiment of the proprietary spherical luminaire, but would require adaption for the inclusion of the Sentinel Advanced Control Module FIG. 25-200.

### Heat Sink Adaptation for Up Light

In the process of creating a multi-LED lamp with an approximation of the color rendering index attributed to halogen and a luminous intensity equal to 50 watt PAR 36 halogen, heat has returned as an issue. Lamps of this capacity are invariably designed with a substantial means of heat dissipation. The method which has been described thus far will function only as a down light. With the lamp inverted, the spiral will not flow through brine to replace the vaporized coolant. For simplicity, our system is intended to function by gravity. This can be achieved with an alteration of the lamp depth. With the lamp facing upwards, the reservoir will be seated low enough in the proprietary spherical luminaire encasement that the coils can then spiral upward. Since, as was said, the proprietary spherical luminaire encasement housings are spacious, the latter spiral will be hidden from view and protected from damage. Thus thin and quite fragile heat dissipating fins can be employed to move heat from the primary heat sink rapidly to the end of the spiral tubing. A 3 mm ID tubing with strategic emitter sink reservoirs would allow for a continuous vaporization of the brine which, upon condensing, returns to the reservoirs. This method favors ‘hot spot’ cooling since the brine will remove heat most quickly from the hottest areas in the heat sink array. This simple system is well matched to multiple emitter lamps. It may be further described as a means of both extending lamp life and extending lamp color rendition.

### BRIEF DESCRIPTION OF THE DRAWINGS

There are 49 Figures numbered 1A, 1B, 2, 3, 4, 5, 6, 7, 8A, 8B, 9A, 9B, 10, 11 (which pertain to the disclosures of the Bondy et al prior U.S. patent application Ser. No. 11/723,445, also included in this Continuation-in-Part) and 12, 13, 14, 15, 16, 17, 18, 19, 20, 21, 22, 23, 24, 25, 26, 27, 28, 29, 30, 31, 32, 33, 34, 35, 36, 37, 38, 39, 39, 40A, 40B, 41, 42, 43, 44 and 45 (which pertain to the new disclosures of this Continuation-in-Part).

FIG. 1A illustrates the configuration of one embodiment of the Bondy et al system, and FIG. 1B illustrates the configuration of the embodiment of FIG. 1A with additional detail, and also illustrates the configuration of two other embodiments of the Bondy et al system.

FIG. 2 illustrates the layout of the Control Module circuitry.

FIG. 3 illustrates the components of the luminaire and lamp.

FIGS. 4 and 5 illustrate the components of the luminaire and lamp in greater detail.

FIG. 6 illustrates the luminaire and lamp with a mushroom shaped cap (shade and reflector) fitted onto the luminaire housing.

FIG. 7 illustrates different illumination effects achieved by dimming individual lamps with the dimmer control component of the Control Module.

FIGS. 8A and 8B illustrate the weatherproof embodiment of the Control Module.

FIGS. 9A and 9B illustrate the configuration of a multi-coloured emitter LED lamp.

FIG. 10 illustrates the layout of the Control Module circuitry for usage with a LED lamp.

FIG. 11 illustrates a solar power embodiment of the Bondy et al system.

FIG. 12 illustrates a spherical luminaire including the 0.5 Sentinel Control Module.

FIG. 13 illustrates a spherical luminaire including the 0.5 Sentinel Control Module inverted in a down light embodiment.

FIG. 14 illustrates the bottom shell with the placement of the 0.5 Sentinel Control Module.

FIG. 15 illustrates how the 0.5 Sentinel Control Module fits into the top and the bottom shell, and how it can be rotated 180 degrees.

FIG. 16 illustrates the 0.5 Sentinel Control Module.

FIG. 17 illustrates the 0.5 Sentinel Control Module front shell cover face with components.

FIG. 18 illustrates the back view of the 0.5 Sentinel Control Module front shell cover face with components.

FIG. 19 illustrates the back view of the printed circuit PC board for the 0.5 Sentinel Control Module.

FIG. 20 illustrates the back view of the assembled 0.5 Sentinel Control Module, and also illustrates a means of insulating and isolating the supply input terminals for the 0.5 Sentinel Control Module, and also illustrates an isolated switch mode power supply SMPS module with encasement.

FIGS. 21, 22, and 23 illustrate the layout of the circuitry for the Sentinel Advanced Control Module.

FIG. 24 illustrates the isolated switched mode power supply SMPS module within the isolated SMPS encasement.

FIG. 25 illustrates the Sentinel Advanced Control Module.

FIG. 26 illustrates a spherical luminaire including the Sentinel Advanced Control Module.

FIG. 27 illustrates a spherical luminaire including the Sentinel Advanced Control Module inverted in a down light embodiment.

FIG. 28 illustrates how the Sentinel Advanced Control Module fits into the top and the bottom shell, and how it can be rotated 180 degrees.

FIG. 29 illustrates an exploded view for the Sentinel Advanced Control Module of the front shell of the encasement (front face plate), front face plate options, back shell of the encasement, and the printed circuit PC board with some assorted components.

FIG. 30 illustrates the Sentinel Advanced Control Module front shell encasement with rain guard and with all current options open to receive each component.

FIG. 31 illustrates a conceptual means of cord connection.

FIG. 32 illustrates an embodiment of the Sentinel Advanced Control Module without the security options of the video camera, microphone, audio speaker or annunciator.

FIG. 33 illustrates the back view of a generic face plate of the same size with blanks to fill voids.

FIG. 34 illustrates the back view of the printed circuit PC board for the Sentinel Advanced Control Module.

FIG. 35 illustrates the means of insulating and isolating the supply input terminals for the Sentinel Advanced Control Module, and an isolated switch mode power supply SMPS module with encasement.

FIG. 36 illustrates an exploded view of the front face of the Sentinel Advanced Control Module.

FIG. 37 illustrates an exploded view of the back of the Sentinel Advanced Control Module.

FIG. 38 illustrates the front view of the printed circuit PC board of the Sentinel Advanced Control Module, without any of the required circuits.

FIG. 39 illustrates the back view of the Sentinel Advanced Control Module for mounting on a tubular garden stake (unassembled) with details.

FIG. 40A illustrates the Sentinel Advanced Control Module with means of sealing the front shell with the back shell, and FIG. 40B illustrates the 0.5 Sentinel Control Module with means of sealing the front shell with the back shell.

FIG. 41 illustrates a pathway luminaire and a beacon.

FIGS. 42, 43, 44 and 45 illustrate a house on a developed lot with a variety of outdoor lighting luminaires illuminated in staged lighting zones.

### DETAILED DESCRIPTION OF THE DRAWINGS

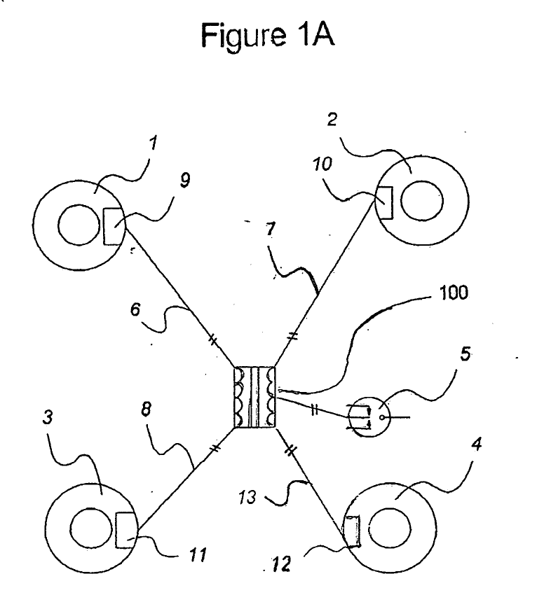

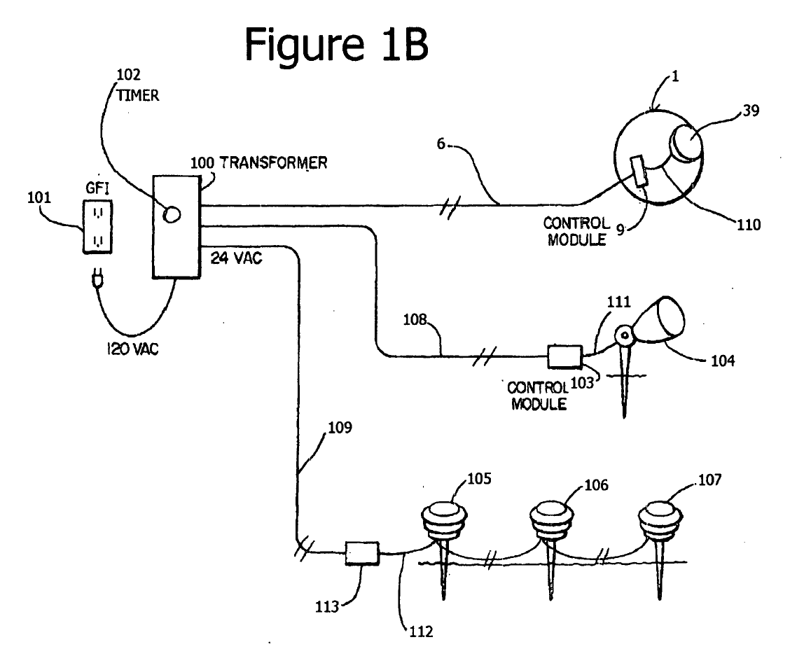

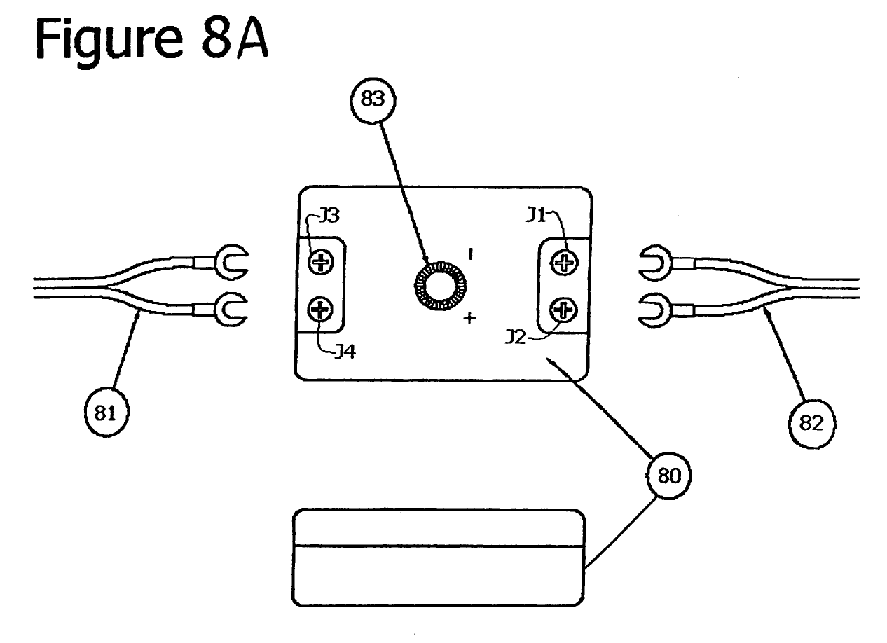

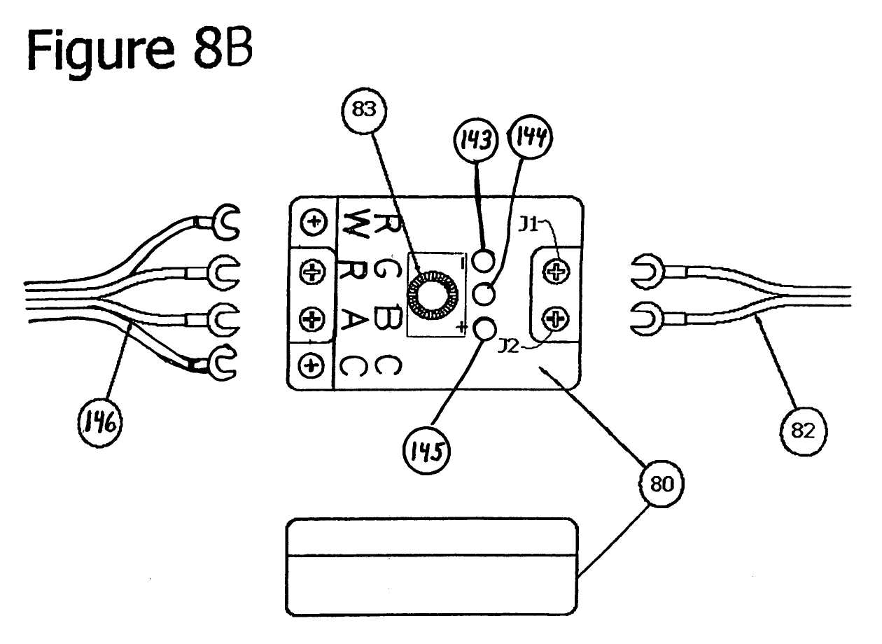

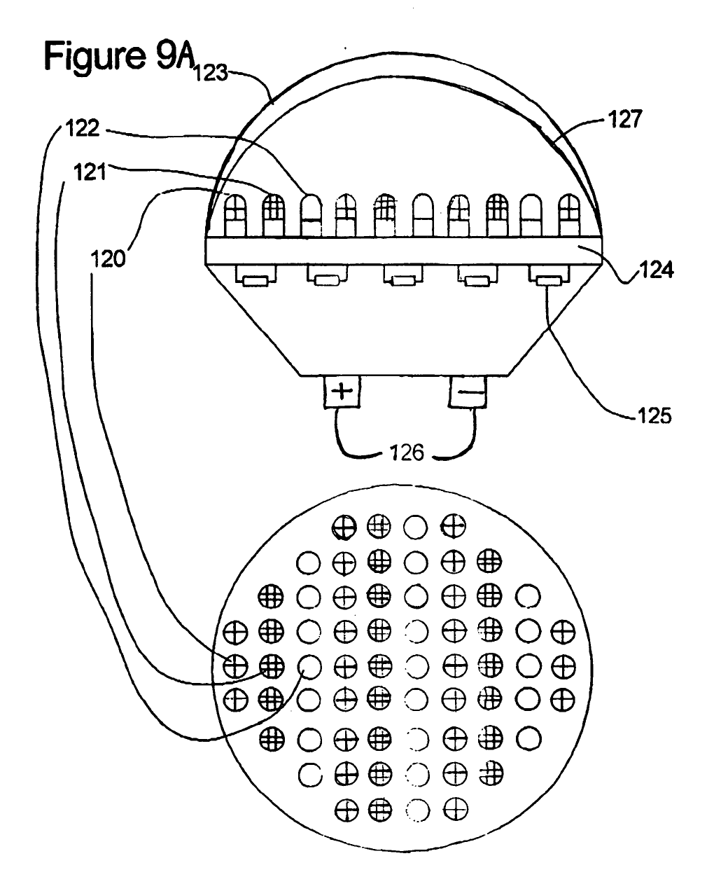

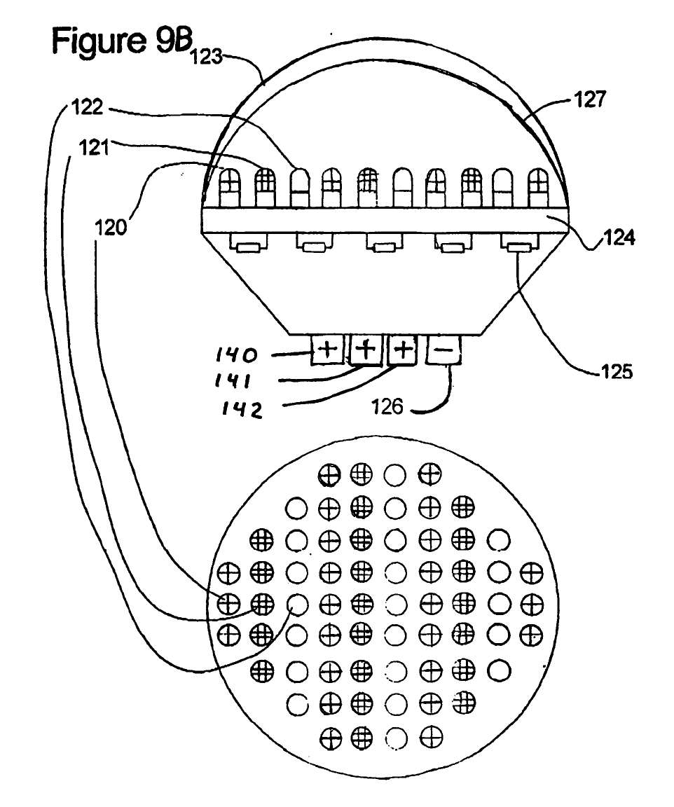

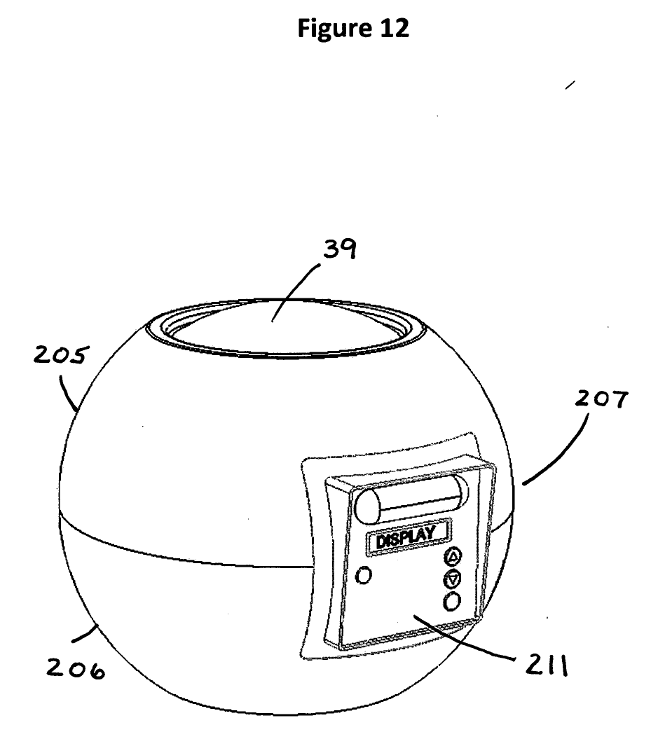

Note to examiner: In this section, Detailed Description of the Drawings, we have maintained the disclosures of the Bondy et al prior application Ser. No. 11/723,445 in FIGS. 1A, 1B, 2, 3, 4, 5, 6, 7, 8 (renumbered 8A), 9 (renumbered 9A), 10, 11, with minor changes as indicated by strikethroughs and underlining, and with the addition of FIG. 8B and FIG. 9B. These disclosures are followed by the new disclosures of this Continuation-in-Part beginning with FIG. 12.

Referring to FIG. 1A, the configuration consists of a first individual luminaire 1, a second individual luminaire 2, a third individual luminaire 3, a fourth individual luminaire 4, each with its own Control Module (internal to the luminaires 1, 2, 3, 4) 9, 10, 11, 12 respectively, which are connected to a power supply transformer (120 volts AC) 100 by secondary transmission conductors 6, 7, 8, 13 respectively. The power supply transformer (120 volts AC) 100 is connected to a central primary line ON/OFF control switch 5.

Referring to FIG. 1B, three embodiments of the Bondy et al system are illustrated. In all 3 configurations, the power supply transformer (120 volts AC) 100 is plugged into a GFI receptacle 101 and is switched ON and OFF by a rotary timer 102, which is built into the power supply transformer (120 volts AC) 100.

In FIG. 1B, the configuration of the first embodiment consists of the power supply transformer (120 volts AC) 100 connected by secondary transmission conductors 6 to the Control Module 9 (internal to the luminaire 1). The Control Module 9 is connected to the lamp 39 within luminaire 1 via power conductors 110.

In a multi-luminaire configuration of this embodiment, as illustrated in FIG. 1A described above, additional luminaires 2, 3, 4 with their own individual Control Modules (internal to the luminaire 2, 3, 4) 10, 11, 12 are added and connected to the power supply transformer (120 volts AC) 100 with secondary transmission conductors 7, 8, 13.

In FIG. 1. B, the configuration of the second embodiment consists of the power supply transformer (120 volts AC) 100 connected by secondary transmission conductors 108 to the Control Module 103 (external to the luminaire) in close proximity to an extra-low voltage luminaire 104 of other manufacture, in which the lamp does not exceed 50 watts. From the external Control Module 103, power is fed to the lamp within the luminaire 104 via power conductors 111.

In FIG. 1B, the configuration of the third embodiment consists of the power supply transformer (120 volts AC) 100 connected by secondary transmission conductors 109 to the Control Module (external to the luminaire) 113 in close proximity to a daisy chain of extra-low voltage luminaires 105, 106, 107 of other manufacture, the lamps within said luminaires not exceeding 50 watts total. From the external Control Module 113, power is fed to the lamps within the daisy chain of luminaires via power conductors 112.

Any combination of the three embodiments in FIG. 1B, and not restricted to only these embodiments, could be utilized in a single landscape design.

In FIG. 1B, the power supply transformer (120 volt AC) is switched ON and OFF by a rotary timer 102. Said transformer 100 can be controlled by other components but for illustration purposes we have used a rotary timer.

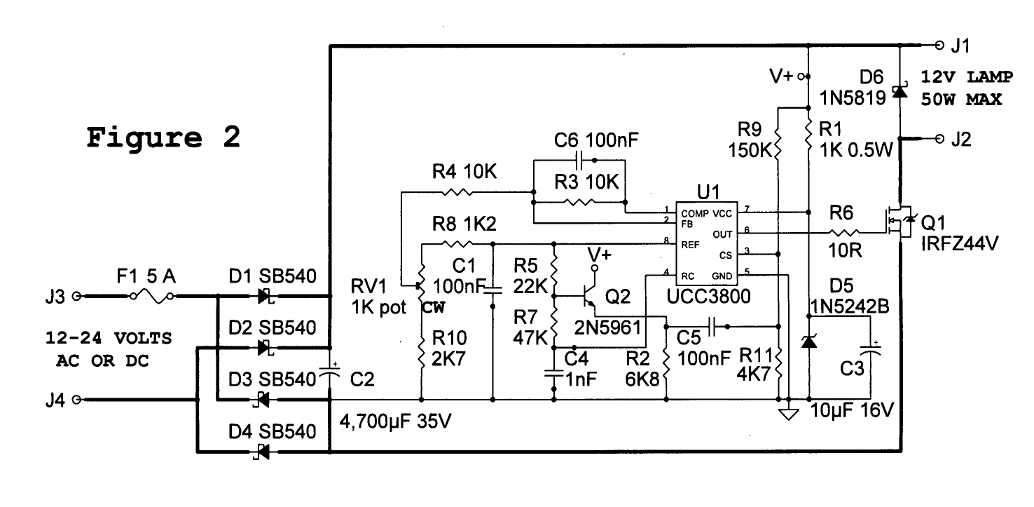

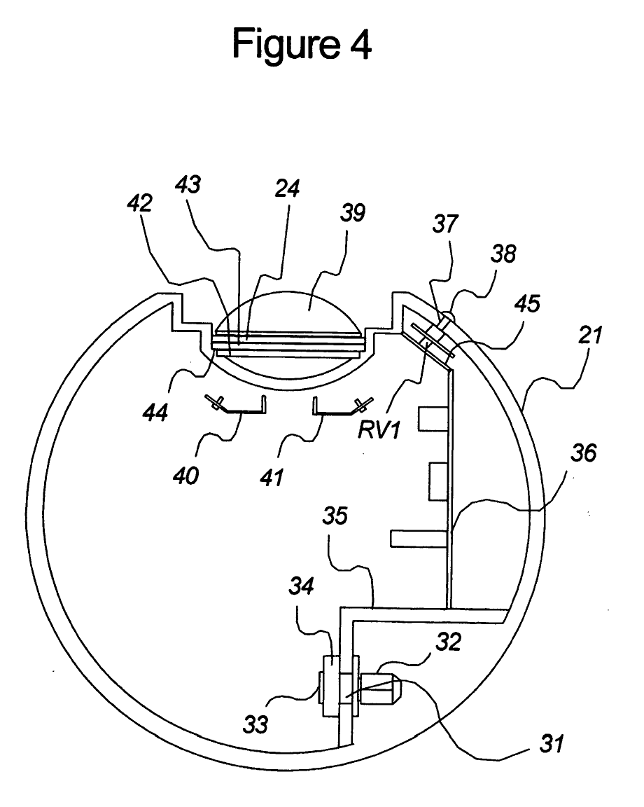

Referring to FIG. 2, this is a drawing of the circuitry of the Control Module board FIG. 4-36, which in this embodiment is rated for 50-watt loads or lamps. The lamp brightness is controlled by a switching circuit in integrated circuit (IC) U1 which controls the lamp start and varies the duty cycle of the power through Q1. The dimming level is set with screw adjuster pot RV1 which is rated 1K 20% 250 mW. This affects the lamp ON time and hence the light output. To minimize lamp brightness changes with minor voltage flow variations, the supply voltage is sensed through the divider comprising R9 and R11.

Further electrical components complete the required circuits as shown in FIG. 2. C1, C5 and C6 are 100 nF monocap 50 V 20%; C2 is 4,700 uF Electrolytic 35V 20%; C3 is 10 uF electrolytic 16V. Diodes D1-D4 are 5 amps, 40 V; D5 is 12V 5% 500 mW; D6 is 1 Amp, 40 V. R1 is 1K 5% 500 mW. R2-R11 are all 5% 250 mW; with values R2—6K8, R3 and R4—10K, R5—22K, R6—10R, R7—47K, R8—1K2, R9—150K, R10—2K7, R11—4K7. Fuse F1 is a fast 5 amp fuse, mounted in fuse clip HW1 on the dimmer control board 20, which comprises a printed circuit board HW2. HW3 is a heat sink to dissipate excess heat during operation to allow the components to function without degradation due to overheating. Q1 is an FET rated at 60V 55A and Q2 is a general purpose transistor 60 V 100 mA A current mode controller at U1 has a 100% duty cycle and is rated to operate in the range of 0- to 70 degrees C.

J3 and J4 are input terminals for inputs of 12 to 30 volts AC or DC. J1 and J2 are output terminals for outputs to the luminaire FIGS. 1A-1, 1B-1 containing the 12 volt lamp FIGS. 1B-39, 4-39, 5-39.

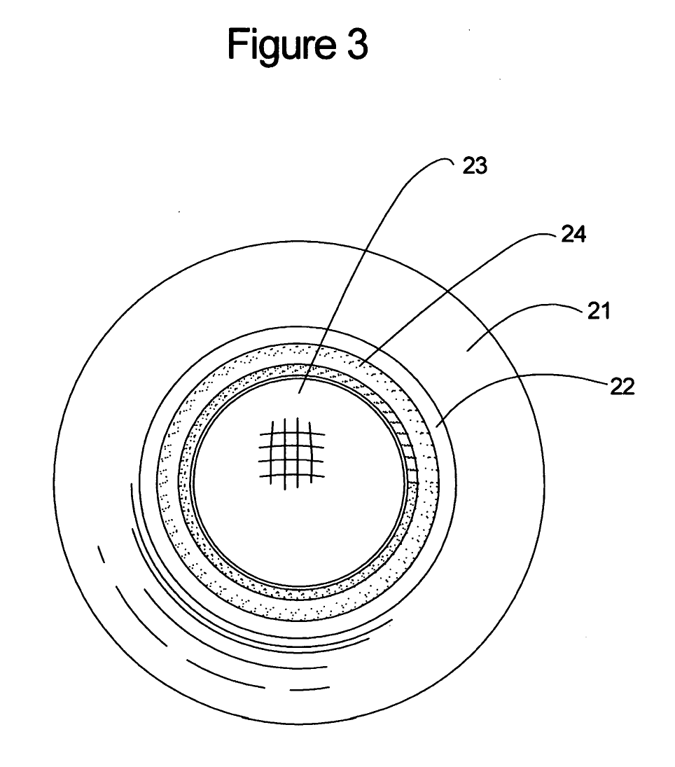

Referring to FIG. 3, the lamp has a substantially spherical luminaire housing 21, which is weatherproof, suitable for burying such that only a top portion 22 adjacent to the lens cover 23 is exposed to shine on the target objects to be illuminated. The lens rim seal 24 keeps rain and dust from entering the luminaire housing 21.

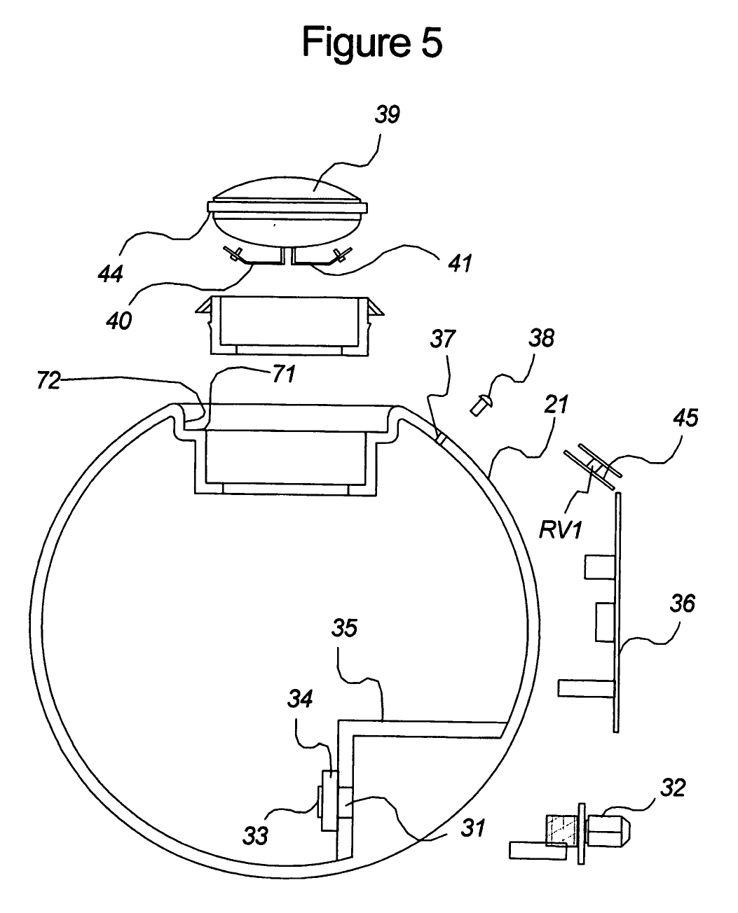

Referring to FIGS. 4 and 5, the luminaire housing 21 has a wire inlet 31, a wire inlet grommet 32, adapted to seal around an electrical supply wire and match the weatherproof functionality of the luminaire housing 21, a wire inlet bolt 33, and a complementary nut 34. The wire inlet bolt 33 also serves to hold the bottom flange 35 of the Control Module board 36. The dimmer's screw adjuster pot RV1 is set on an upper side flange 45 of the Control Module board 36 to enable to be positioned behind adjuster aperture 37. A dimmer screw adjuster plug 38 fits into the aperture 37 to seal against rain and dirt, etc. A sealed beam lamp 39, with electrical contacts 40 and 41 fits within the sealed beam cradle 42. The cradle is held in position in the luminaire housing 21 by means of compression flange 43. The lens rim seal 24 can be made of resilient material of a close-fitting tolerance pressed into position on the lens seal rim ledge 44. The luminaire housing 21 has an optional shade support ledge 71 and shade holding rim 72, suited to hold a shade wall

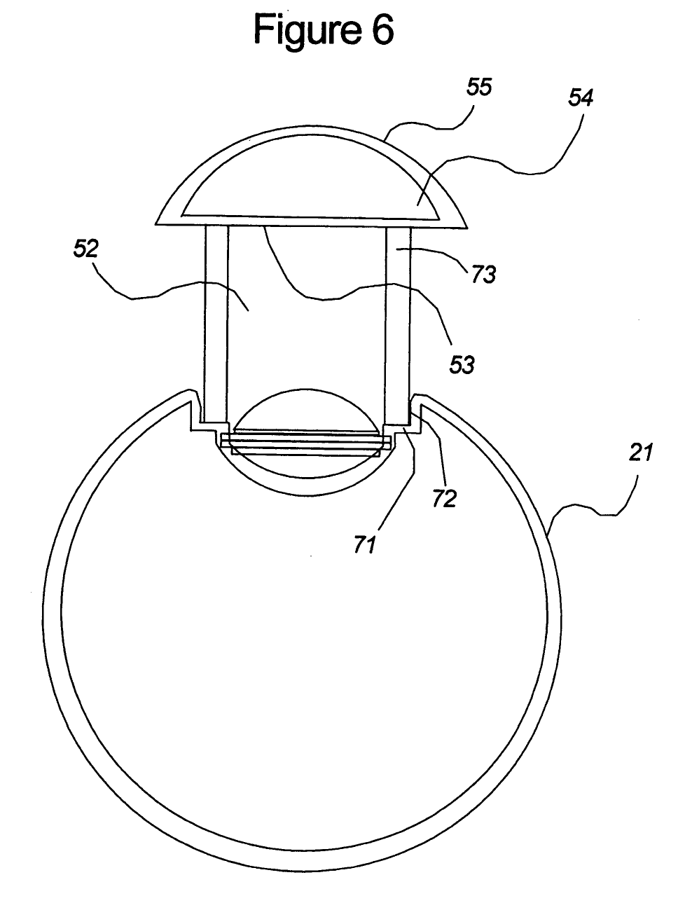

FIG. 6-73. Thus, in place of a flush lens seal, a mushroom shaped shade and reflector can be fitted onto the luminaire housing 21 as shown in FIG. 6. The mushroom shade and reflector 51 (not numbered in FIG. 6, but consisting of items 52, 53, 54, 55 and 73) has a hollow column 52 up which the light from the lamp travels. Slots in the column near its top allow the light to then be reflected down from the underside 53 of the mushroom-shaped cap 54. The top of the mushroom-shaped cap 55 acts as a roof or umbrella to deflect rain, wind, dust, and snow from falling on the lamp.

Referring to FIGS. 4 and 5, in this embodiment the Control Module board 36 is not enclosed in a weatherproof case FIG. 8-80 (to be described in FIG. 8), because the Control Module board 36 is enclosed in the weatherproof luminaire housing 21. In an embodiment, the Control Module board 36 will be enclosed in a weatherproof case FIG. 8-80, which will make the Control Module FIG. 1A-9 universal as shown in FIG. 8.

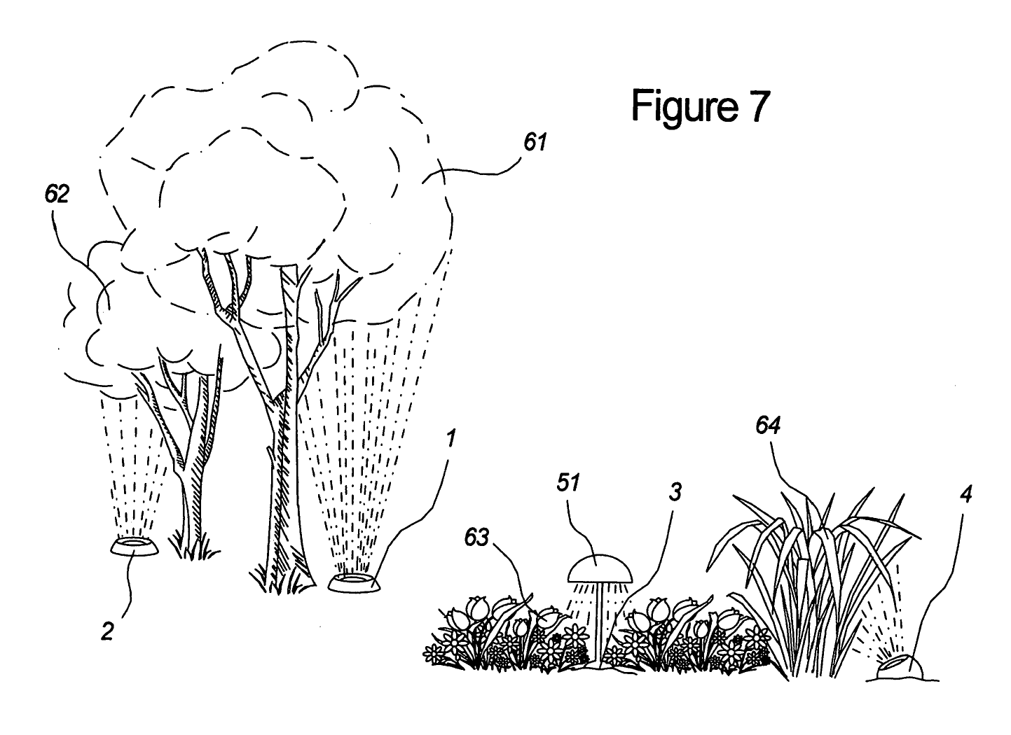

Referring to FIG. 7, the individual lamps 1, 2, 3 and 4 are pre-set at different levels of brightness. Lamp 1 is set at maximal brightness to illuminate a tall tree 61. Lamp 2 is set at a medium level to illuminate a shorter tree 62. Lamp 3 is set at a moderate level to illuminate a flower bed 63 via a mushroom-shaped shade and reflector 51. Lamp 4 is shown buried at an angle to illuminate an adjacent upright plant 64.

Referring to FIG. 8A (numbered as FIG. 8 in Bondy et al prior application Ser. No. 11/723,445), the weatherproof outer case 80 encloses the Control Module board FIG. 4-36. Power is conducted from the power supply transformer (120 volt AC) FIGS. 1A & 1B-100 along secondary transmission conductors 81 to input terminals J3, J4 (also shown in FIG. 2) of the Control Module board FIG. 4-36, at +/−24 volts AC. The rotary dimmer control 83 mechanically connects to the Control Module board FIG. 4-36, which is enclosed in the weatherproof outdoor case 80. An O-ring (not shown) prevents the egress of moisture past the rotary dimmer control 83. The rotary dimmer control 83 makes mechanical rotational contact with pot in FIG. 2-RV1. The power conductors 82 are connected to the output terminals J1, J2 (also shown in FIG. 2), and are then connected to the lamp FIG. 3-23 within the luminaire housing FIG. 3-21, allowing for dimming to take place.

FIG. 8B illustrates a weatherproof outer case 80 which encloses the Control Module board FIG. 4-36 and a substantially weatherproof dimmer module for a 3 color LED lamp. Input terminals will allow for 11 to 30 volts AC or DC. Input terminals marked J1 and J2 will accept supply voltages. The rotary dimmer control 83 mechanically connects to the Control Module board FIG. 4-36, which is enclosed in the weatherproof outdoor case 80. The rotary dimmer control 83 is common to both housings. The 4 conductors 146 are W+ (white), R+ (red), A+ (amber/yellow), C−, or R+ (red), B+ (blue), G+ (green), C− (common). The terminals on the encasement are marked W, R, A, C and three weatherproof rotary adjustment means 143, 144, 145 are for the purpose of choosing the shade and color of the lamp to which they supply current at 12 volts with the white emitter chain at a nominal 75 percent and the amber/yellow at a nominal 25 percent and the red at a nominal 25 percent. The cool white will be substantially warmed in color output. In the proprietary embodiment of the lamp illustrated in FIG. 9B, and the control module FIG. 1B (9, 103, 113), it is intended that the color be precisely adjusted to what is desired. Afterward the dimmer control 83 could be utilized as a means of increasing or decreasing the lamp luminous intensity.

FIG. 9A (numbered as FIG. 9 in Bondy et al prior application Ser. No. 11/723,445), illustrates the layout of the par 36 LED lamp 127 with a proprietary mix of white, red and amber/yellow emitters (120, 121, 122). The emitters are cooled by a heat sink 124. Resistors 125 are in series protecting diodes 120, 121, 122. Spade input terminals 126 are shown with polarity. Also shown is the glass refractory lens 123. The configuration of three colour emitters through the glass refractory lens results in a softer lamp output.

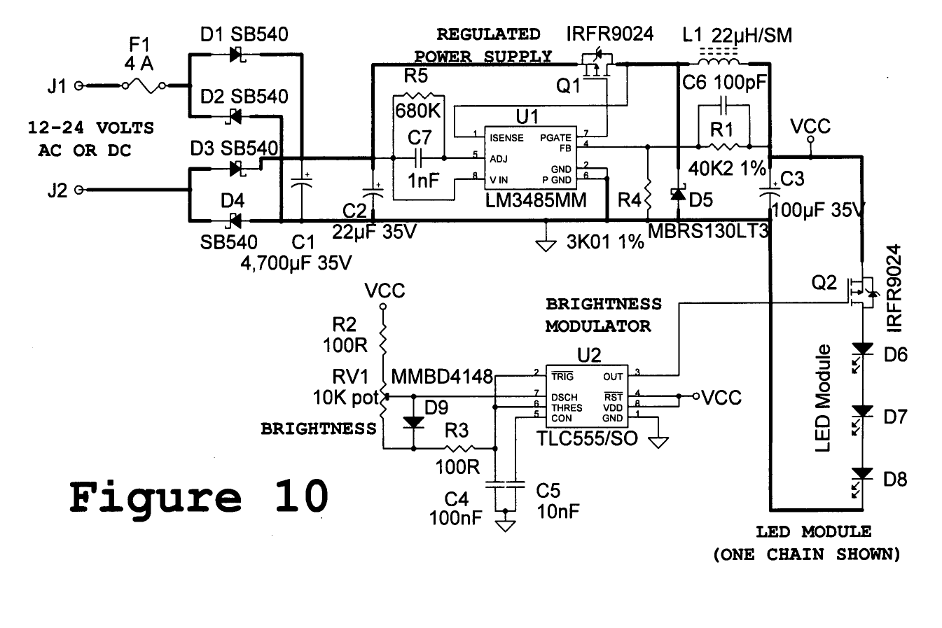

FIG. 9B illustrates the layout of the par 36 LED lamp 127 with a proprietary mix of white, red and amber/yellow emitters (120, 121, 122) all of which have a positive male spade wire connector 140, 141, 142 and a single common negative spade male wire connector 126. Thus from the circuit indicated as FIG. 10 and the lamp control FIG. 8B, the proprietary par 36 LED lamp illustrated in FIG. 9B could be made to closely resemble halogen.

FIG. 10 illustrates the Control Module circuitry for usage with an LED lamp (hereafter referred to as the LED Control Module), comprised of two blocks:

U1 and associated circuitry comprise a step-down power regulating supply to produce an output of 10.5 volts at up to 4 amps, which makes possible the dimming of LED lamps up to 42 watts total power.

U2 and associated circuitry is the brightness modulator circuit, which produces an output signal at approximately 1,400 Hz, which is then used to control the LED brightness. In the Control Module embodiment for usage with an LED lamp, it is the average current that affects lamp brightness.

Referring to FIG. 10, a diode bridge consisting of D1-D4 is used on the power input to allow operation from AC and polarity protection on DC. The power supply circuit will provide a steady output voltage over a range of 12 to 32 volts input. The output is currently set at 10.5 volts but this may require changing dependent upon the final choice of LED Control Module. For reliability, it is important not to exceed the current rating of the LEDs, and by providing a regulated voltage to match the running voltage of the LED Control Module, this can be achieved.

Control of the LED brightness is achieved by varying the ON-OFF time of the LED Control Module and hence the average current. Power to the LED module passes through FET Q2 whose gate is controlled by the brightness modulator circuit around U2. Q2 is turned ON and OFF around 1,400 times a second, which is more than fast enough to ensure that there is no perceived flicker. Unlike a halogen lamp, LEDs turn ON and OFF instantly. The ON-OFF period (duty cycle) of the brightness modulator can be changed through 1 to 99%, which will vary the brightness from almost zero to almost maximum. Fine tuning of the brightness limits can be achieved by increasing the value of components R2 and R1

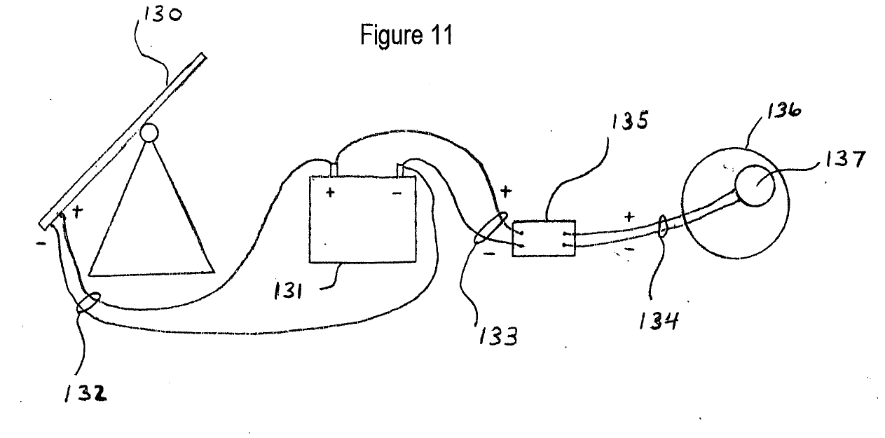

FIG. 11 illustrates a solar power embodiment of the system wherein the solar panel 130 during daylight hours collects energy from the sun and distributes this energy through power conductors 132 to the battery 131 during operating hours. As shown, the energy stored in the battery runs through feeder conductors 133 to the Control Module 135. The Control Module 135 sends power to the lamp 137 inside the luminaire 136 through luminaire conductors 134, from 12 volts DC and below. In this embodiment all voltage is DC. The Control Module 135 could also be located within the luminaire 136. The Control Module protects the lamp from over-voltage that can exist in the battery rated for 12 volts. During charging, the voltage between the battery anode and cathode can range above 13 volts. After a full charge the voltage across the battery is often 13 volts or more. Again the Control Module protects the lamp resulting in less material waste.

In a common embodiment of alternate energy, the batteries are arranged as for a 24 volt configuration. As above the battery voltage ranges above 25 volts DC, the Control Module regulates voltage to the lamp for safe operation of 12 volt luminaires.

FIG. 12 illustrates a substantially spherical luminaire 207, which is a two part embodiment of the original luminaire FIG. 4-21, but including the 0.5 Sentinel Control Module 211. The 0.5 Sentinel Control Module 211 is comprised of the following encased in a substantially weatherproof housing, all of which is called the control assembly 241: (i) clock and timer module; (ii) 3 weatherproof momentary contact push-button switches; (iii) a liquid crystal (or other) display module; (iv) a multiple inputs and a multiple output microcontroller with programmable CPU with memory, a cord and a 12-pin female connector. In the up light embodiment illustrated in FIG. 12, the top shell 205 conforms at the lamp 39 placement location to what is indicated in FIGS. 3, 4, 5, and 6. The bottom shell 206 from the above has been altered to produce a flat surface at the lowest point of the luminaire. The supply conductor inlet is raised for correct clearance from the said flat bottom horizontal mounting surface. Clearly visible is the 0.5 Sentinel Control Module 211.

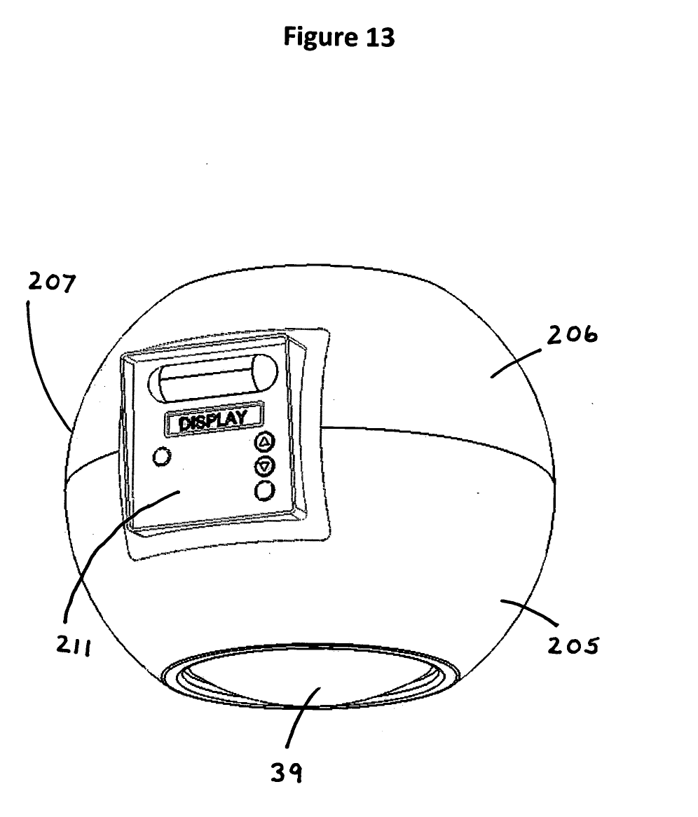

FIG. 13 illustrates the two part spherical luminaire 207 including the 0.5 Sentinel Control Module 211 in a down light embodiment. The top shell 205, bottom shell 206 and lamp 39 have been inverted. The 0.5 Sentinel Control Module 211 has been inverted by a rotation of 180 degrees.

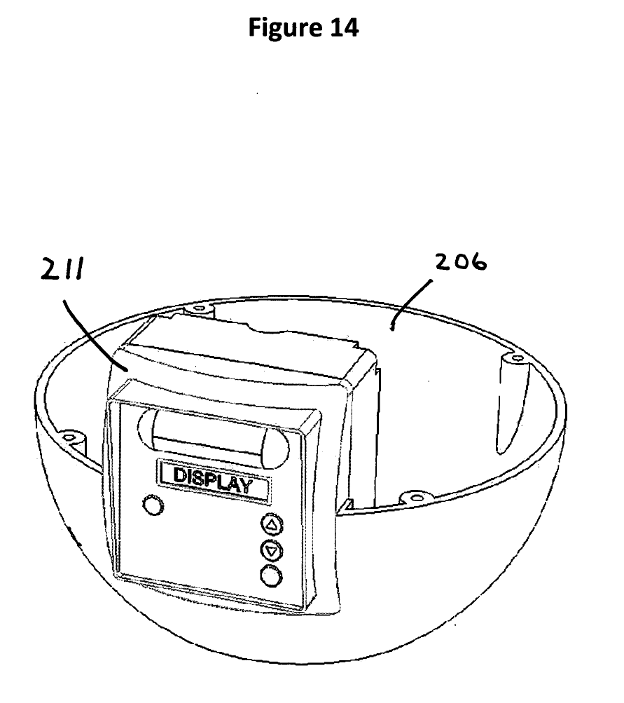

FIG. 14 illustrates the bottom shell 206 with the placement of the 0.5 Sentinel Control Module 211.

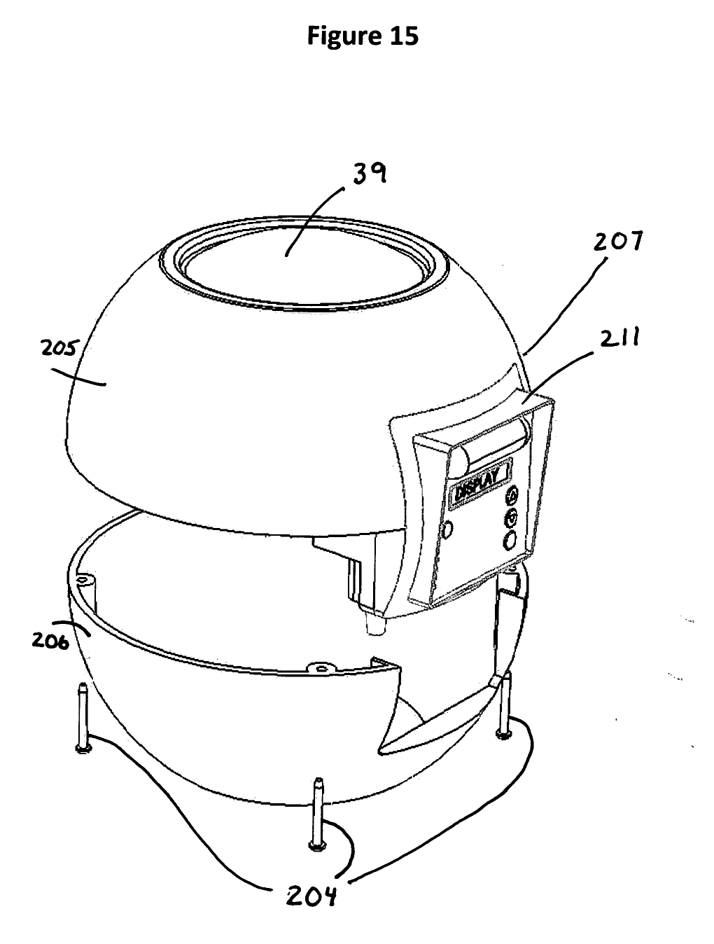

FIG. 15 illustrates how the 0.5 Sentinel Control Module 211 fits into the top shell 205 and bottom shell 206 such that the 0.5 Sentinel Control Module 211 may be inverted by a rotation of 180 degrees, since the fit is identical either up or down, and this can be done simply and quickly after purchase. Stainless screws (each) 204 pass through holes which are hidden from view once tightened. A gasket 203 (not shown) is designed to weatherproof the join form between the shells.

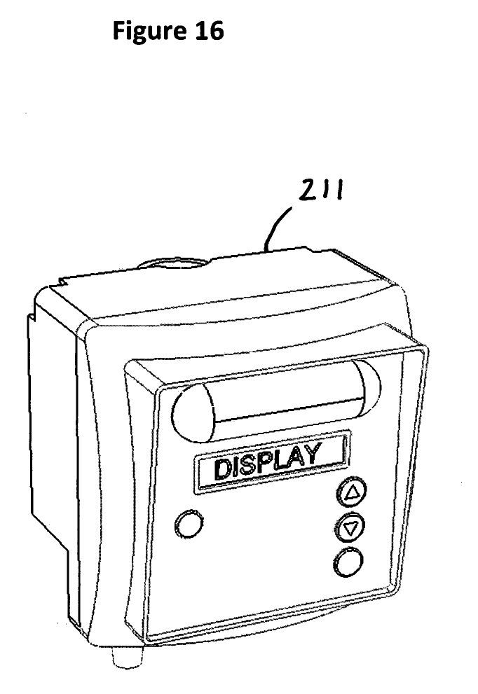

FIG. 16 illustrates the 0.5 Sentinel Control Module 211 which may be used inside the two part spherical luminaire FIG. 12-207. The 0.5 Sentinel Control Module 211 is comprised of the following encased in a substantially weatherproof housing, which is called the control assembly 241: (i) clock and timer module; (ii) 3 weatherproof momentary contact push-button switches; (iii) a liquid crystal (or other) display module; (iv) a multiple input and a multiple output microcontroller with programmable CPU with memory, a cord and a 12-pin female connector.

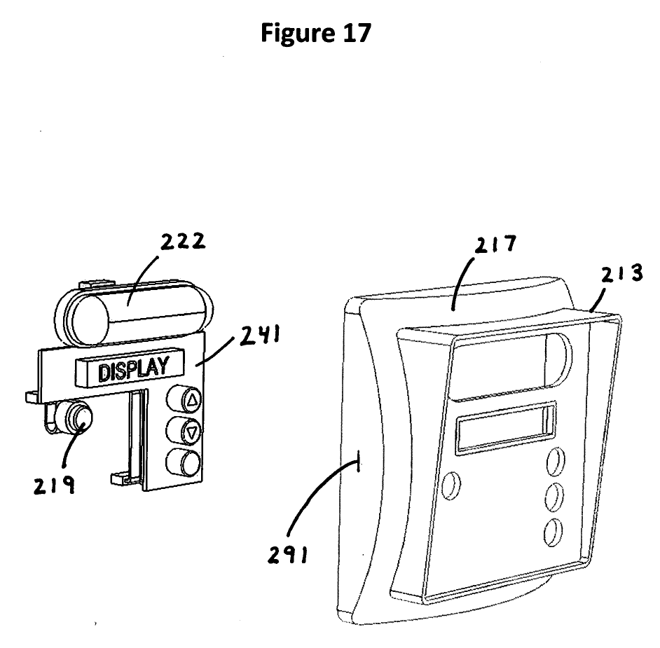

FIG. 17 illustrates the 0.5 Sentinel Control Module FIG. 16-211 front shell cover face 217 with a protruding ridge 291 on each side, rain guard 213, wide angle motion detector 222, 3-wire switched supply photocell 219, and the 0.5 Sentinel control assembly 241.

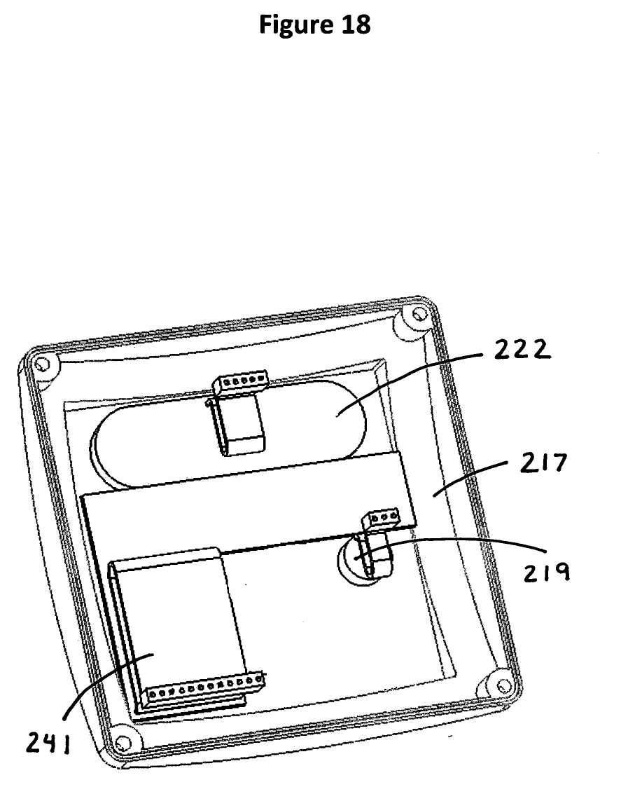

FIG. 18 illustrates the back view of the front face 217 of the 0.5 Sentinel Control Module FIG. 16-211 and the components: wide angle motion detector 222, 3-wire switched supply photocell 219, and the 0.5 Sentinel control assembly 241.

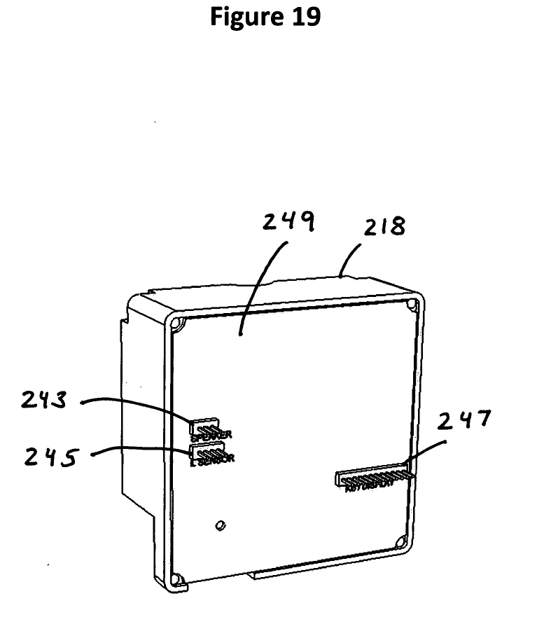

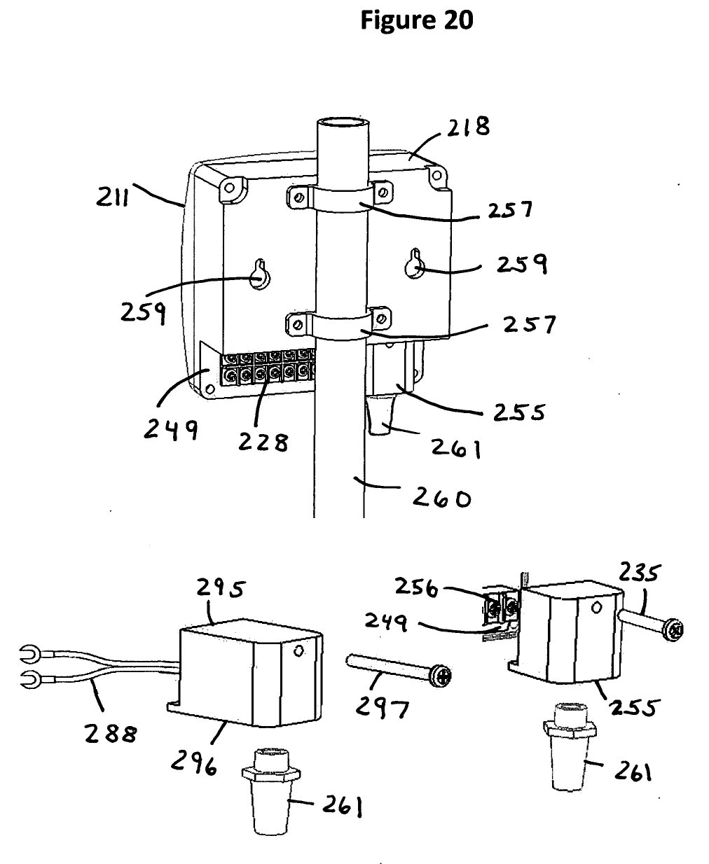

FIG. 19 illustrates the printed circuit PC board 249 for the 0.5 Sentinel Control Module, best illustrated in FIG. 16-211, which simplifies assembly and substantially reduces jumper wire conductors. The printed circuit PC board is shown in place with the back shell encasement cover 218, with 12-pin male connector 247 on printed circuit PC board 249 for the 0.5 Sentinel control assembly FIG. 17-241, 3-pin male connector 243 on printed circuit PC board 249 for the 3-wire switched supply photocell FIGS. 17-219, and 5-pin male connector 245 on printed circuit PC board 249 for the motion detector best illustrated in FIG. 17-222. With reference to FIGS. 17 and 18, it can be seen how the components of the photocell FIG. 17-219 and motion detector FIG. 17-222 (both of which are required), and 0.5 Sentinel control assembly FIG. 17-241 can be electrically and mechanically interconnected via three cables with female connector. Switched L1 power supply output from the motion detector FIG. 17-222 is one input to the 0.5 Sentinel control assembly FIG. 17-241 via the printed circuit PC board 249 from the input terminals FIG. 20-256. L1 output terminals FIG. 20-228 are L1-1, L1-2, L1-3, L1-4, L1-5, L1-6 and corresponding L2 output terminals L2-1, L2-2, L2-3, L2-4, L2-5, L2-6 are formed of a continuous conducting terminal block supplied from the PC board 249.

FIG. 20 illustrates the back view of the assembled 0.5 Sentinel Control Module 211. On the back shell 218, the input terminal cover 255 is shown in place covering the input terminals 256 (L1, L2) and which are mounted directly on the printed circuit PC board 249. Note that the 0.5 Sentinel Control Module FIG. 16-211 functions without the center COMM terminal in this embodiment. Also shown is the terminal cover screw 235 and weatherproof PVC (or other) cable/box connector 261. All 6 output terminal pairs are supplied with L2 via the printed circuit PC board 249 from the L2 of the input terminals 256. The output terminals 228 are directly mounted on the back of the printed circuit PC board 249 and are supplied for all 6 L2 outputs AC or DC depending on the source to the control assembly FIG. 17-241. Two mounting voids 259 allow for surface mounting of the 0.5 Sentinel Control Module 211, or by means of a suitable tubular pole or stake 260 with two hole pipe straps 257 and four screws for straps 258. The 0.5 Sentinel Control Module 211 may be located without the proprietary spherical luminaire encasement FIG. 12-207. Not shown in FIG. 20 is a hinged or snap-on cover plate for the output terminal strip 228. The cover plate will include terminal markings for correct connections to luminaires and other potential components (not shown).

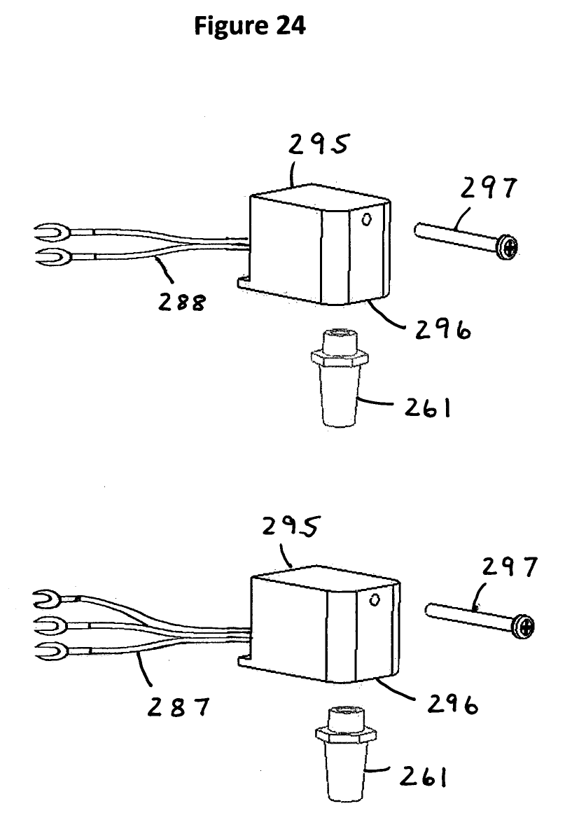

FIG. 20 also illustrates the proprietary isolated switch mode power supply SMPS module 295 within the isolated SMPS encasement 296, both of which can be optioned for use with the 0.5 Sentinel Control Module FIG. 16-211, and which are best illustrated and described in further detail in FIG. 24-295, 296. The isolated SMPS encasement 296 is modified to create a deeper bodied version of the input terminal cover 255 and requires a longer screw FIG. 24-297. It is molded to accept the weatherproof PVC (or other) cable/box connector 261. Once the isolated switch mode power supply SMPS module 295 is connected to the supply conductors 288, which are protected by a grommet (not shown), the isolated switch mode power supply SMPS module 295 will be tightly sealed with a gasket (not shown) via pressure push-snap-lock, completely enclosing the input termination means and isolated switch mode power supply SMPS module 295. The isolated switch mode power supply SMPS module 295 includes a means of voltage adjustment for maximum nominal 12 volts AC or DC for use with the 0.5 Sentinel Control Module FIG. 16-211.

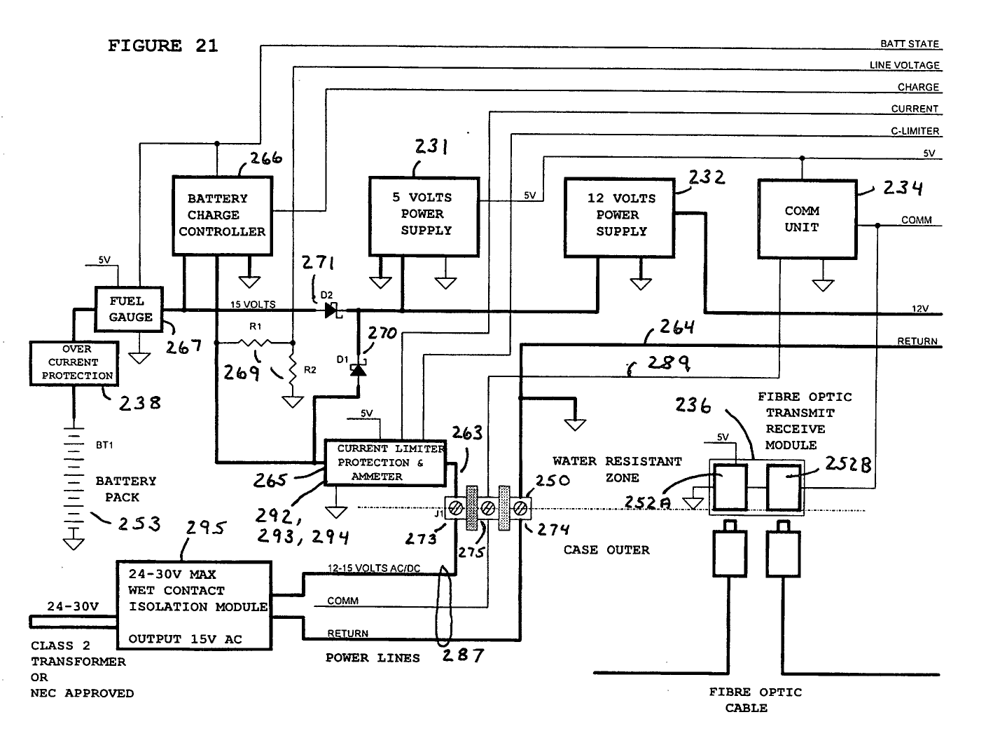

FIGS. 21, 22, and 23 illustrate the layout of the circuitry for the Sentinel Advanced Control Module.

Referring to FIG. 21, power for module operation is nominal 12 to 15 volts AC/DC, primarily provided by 24 to 30 volt AC power supply. An isolated switch mode power supply SMPS module 295 can be optioned. Should there be a mains power failure, the Sentinel Advanced Control Module is powered by a nominal 15 volts battery pack. Current normally flows through diode D1 270 into the Sentinel Advanced Control Module power supplies. When powered by the battery, current flows through diode D2 271.

Incoming power passes through a current limiter and protection circuit, which also measures the current being drawn from the power lines. Should a fault develop within the Sentinel Advanced Control Module which causes an excessive current draw, the current limiter circuit will prevent damage to the Sentinel Advanced Control Module and effectively isolate the Sentinel Advanced Control Module from the power lines. This will allow the other Sentinel Advanced Control Modules to carry on functioning as normal.

A voltage divider 269 comprised of resistors R1 and R2 induces a range of voltage and may be utilized to establish a current flow for the purpose of limiting line losses. A 3% drop on a 30 volt supply conductor or nominal 15 volts without the isolated switch mode power supply SMPS module FIG. 21-295. Again the 3% drop would represent a benchmark and therefore the CPU can be programmed to limit current so that the voltage drop is held below the requirements if the National Electrical Code applies voltage drop limits to low voltage lighting systems, and more importantly, the result being reduced line losses via heat in supply conductors.

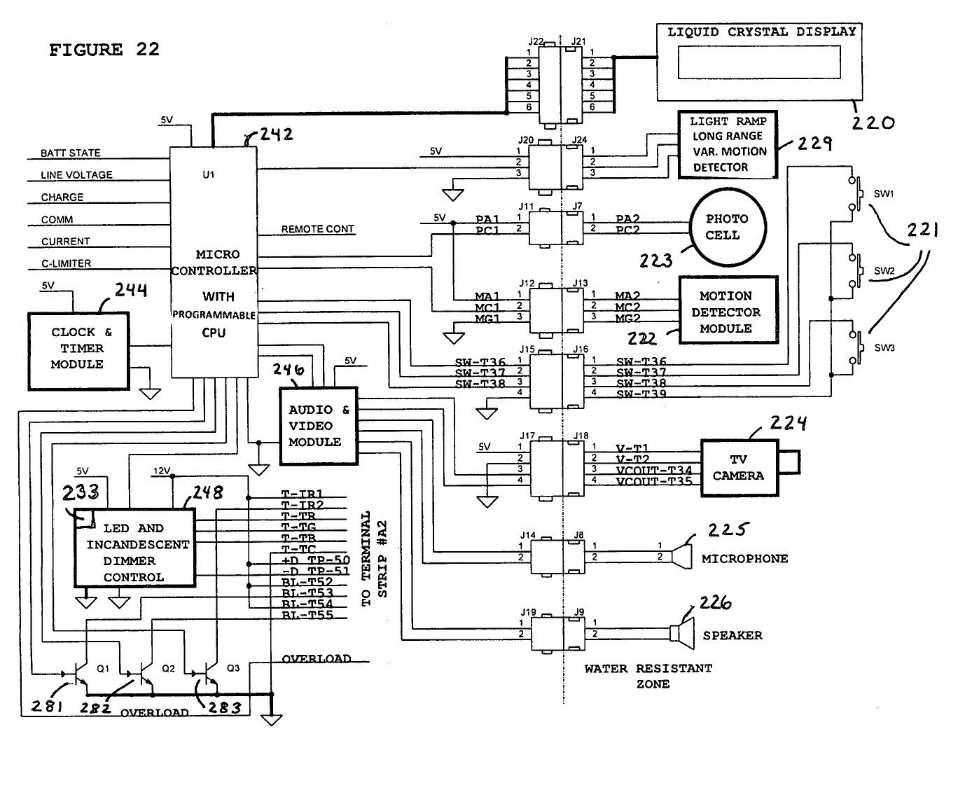

Similarly, there is also battery over current protection and control 238 on the battery pack 253 which is designed to protect both the battery pack and Sentinel Advanced Control Module from damage in the event of a Sentinel Advanced Control Module fault. In order to determine the correct amount of charge for the battery pack, current flows both in and out of the battery pack 253 through a fuel gauge 267. The fuel gauge reading is conveyed to the microcontroller with programmable CPU FIG. 22-242 by means of the BATTERY STATE line.

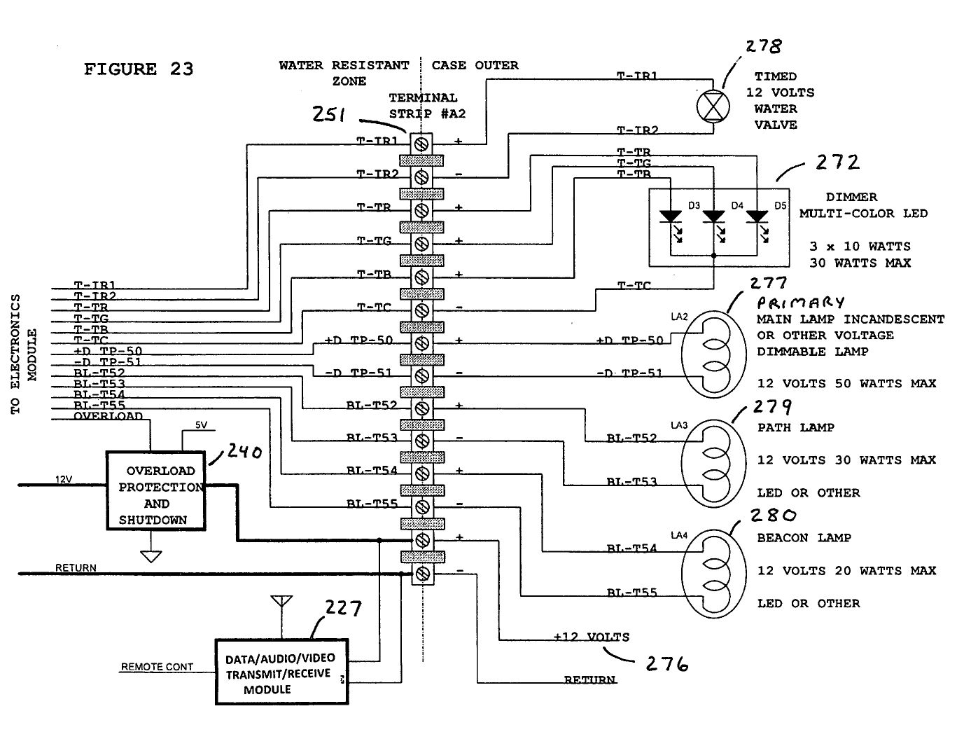

When the battery pack needs charging, the microcontroller with programmable CPU FIG. 22-242 activates the battery charge controller module 266 by activating the CHARGE line. This is to ensure that should the battery pack 253 need recharging, all Sentinel Advanced Control Modules supplied by a singular conductor pair on the system will not try to charge at the same time. Further, the microcontroller with programmable CPU FIG. 22-242, once programmed to direct system charge control, will limit charge current of any of the system Sentinel Advanced Control Modules such that the zero load and charge load current flow will not result in a voltage drop greater than has been programmed for. The microcontroller with programmable CPU FIG. 22-242 in each Sentinel Advanced Control Module receives continuous data from the voltage divider 269 comprised of resistors R1 and R2, the ammeter 294, (located in the current limiter/over current protection/ammeter module 265), the battery charge controller module 266 and the fuel gauge module 267. Thus an input voltage with zero output load as measured at the voltage divider 269 comprised of resistors R1 and R2 received by the microcontroller with programmable CPU FIG. 22-242 and once voltage drop is set, then regardless of the Sentinel Advanced Control Module power output setting, the minimum allowable voltage will be maintained either by means of the battery charge controller module 266, and/or the supply input current limiter 292 and over current protection 293 (located within the current limiter/over current protection/ammeter module 265), and can be made to apply to battery charging to the battery array 253, and/or output terminal strip FIG. 23-251, or to the optional external auxiliary large capacity battery array 237 (not shown).

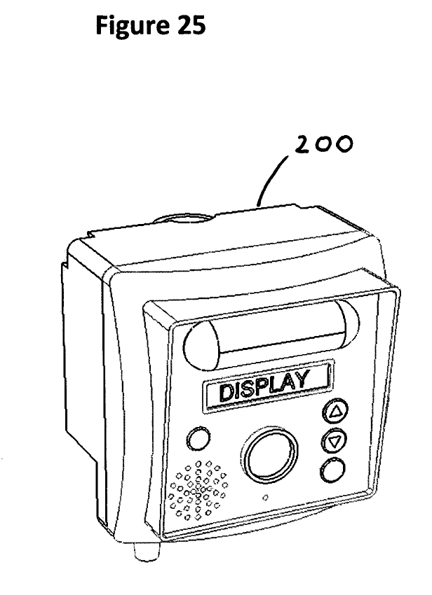

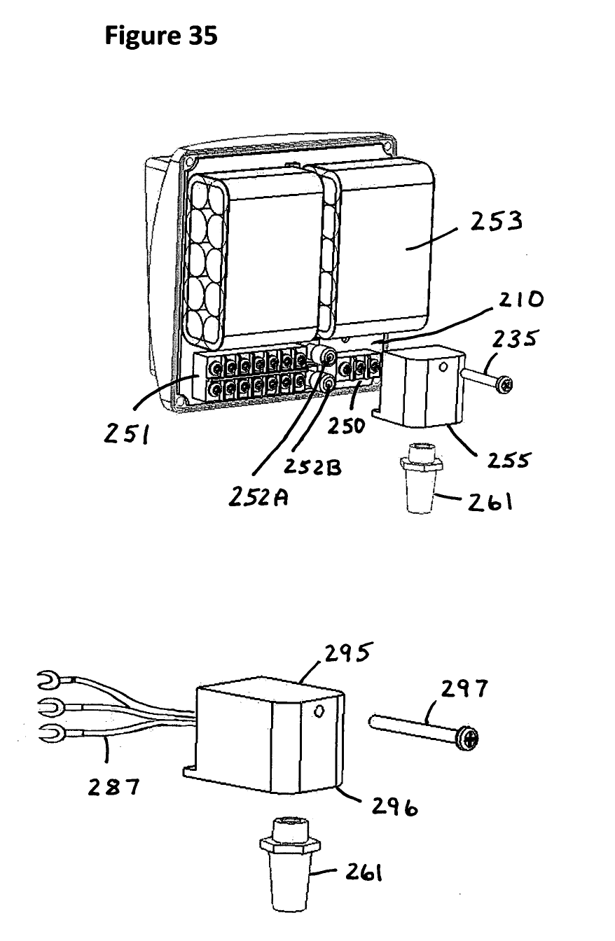

A separate optioned detachable plug-in battery control and charger module 268 (not shown) comprised of a battery charge controller 226, fuel gauge module 267, and battery over current protection 238, with a thermistor lead conductor entering the module 268, could be accessed behind one side of the battery array 253 of the Sentinel Advanced Control Module FIG. 25-200, and would require a rectangular void in the printed circuit PC board FIG. 35-210 which would allow for a recessed socket for said battery control and charger module 268 (not shown).

Also shown is the power supply and communication terminal input block 250 with input terminals L1 273, L2 274 and COMM 275, power supply conductor 263, communication conductor 289, and power supply conductor RETURN 264.

The power from either the battery pack 253 or the power lines passes through switch-mode power supplies 231, 232, which output either nominal 5 volts 231 or nominal 12 volts 232. 5 volts is used to power the Sentinel Advanced Control Module FIG. 25-200 internal circuitry and nominal 12 volts some of the external items controlled by the Sentinel Advanced Control Module FIG. 25-200. In both cases, the RETURN line is the negative for the power supplies. The printed circuit PC board has a 5 volt negative where required. The printed circuit PC board also has a nominal 12 volt negative. In this way 5 volt control components are isolated from potential spikes which the power circuits are subject to.

Sentinel Advanced Control Modules FIG. 25-200 can have bi-directional communication with other Sentinel Advanced Control Modules FIG. 25-200 on the system. Data passes to and from the microcontroller with programmable CPU FIG. 22-242 on the COMM line 289. Communications with the other Sentinel Advanced Control Modules FIG. 25-200 is either by means of a third wire which is part of the power lines cable, or using the fibre optic transmit receive module 236 and fibre optic cables 252A, 252B or a transmit and receive (transceiver) 227 or any combination of the latter, terminating in the communications module unit 234 and continuing on into FIG. 22 where they enter the microcontroller with programmable CPU FIG. 22-242.

Referring to FIG. 22, U1 is the microcontroller with programmable CPU 242 which looks after all the commands and housekeeping tasks of the modules. Communications from the other modules is on the COMM line. Connected to the microcontroller is a clock and timer module 244 which has an RTC (real time clock) for time controlling peripheral device functions. The microcontroller with programmable CPU 242 feeds a number of input and output devices. A liquid crystal (or other) display module 220 is used to display status information and for programming any features. SW1, SW2 and SW3 are three weatherproof temporary contact push-button switches 221 used to navigate the programming menu displayed on the liquid crystal (or other) display module 220.

Other interface devices include a photocell 223 to monitor ambient light level and wide angle motion detector 222 and long range motion detector 229 which are used to control the lamps/luminaires. Some lamps can be dimmed and this is actualized by the control commands issued from the microcontroller with programmable CPU 242 sending commands to the LED and/or incandescent dimmer control module 248. This module may be interchanged with a dimmer module of other design. The Sentinel Advanced Control Module FIG. 25-200 is intended to include lamp dimming capacity, and also, lamp color output control options will include the voltage modulated dimmer. Cooling for the LED and/or incandescent dimmer control module 248 may include a fan and large heat sink (not shown). A thermistor 233 is located as part of the outer case of the LED and/or incandescent dimmer control module 248, in thermal contact with the heat sink. Output conductors are routed to the output terminal strip #A2 FIG. 23-251 and then to the lamps which can be dimmed. A 4-wire conductor set can be made to allow current to flow to each of three series connected LED FIG. 23-272 chains or single emitters of sufficient capacity in an RGB lamp, our proprietary LED lamp with white, red and amber/yellow emitters, or 3 individual LED lamps or lamp ropes, etc., with a common RETURN terminal.

Once the ratio of the 3 output power supply is set (programmed), or reset and set again over a relatively short period of time, then a combination of these three LED chains will result in a blended color output. Thus, while maintaining each ratio for desired color output an increase in current flow available to each will by proportional current modulation allow for increased or decreased luminous intensity from an individual lamp or from individual LED lamps/luminaires (as in LED ‘light ropes’, etc.) In the latter case the terminal marked T-TC would receive three conductors from three 2-wire cables. The remaining conductors would be connected to terminals TR, TG, TB. However if an RGB is not chosen as a single 3-color lamp, then our proprietary lamp could be employed as described and consisting of 3 color changes or single emitters consisting of white, red and amber/yellow. The purpose of which is to economically approximate the color rendition of low voltage halogen lamps with increased efficacy over RGB assemblies.

The Sentinel Advanced Control Module FIG. 25-200 can also be equipped, if optioned, with audio and visual equipment. These optional modules include a TV camera 224, microphone 225 and speaker 226. The signals to and from the audio and video peripherals go to the audio and video module 246. Here the signals are converted to digital format and sent to the COMM line by the microcontroller with programmable CPU 242. Signals for the speaker come down the COMM line via the microcontroller with programmable CPU 242 and are converted from digital to analog and amplified in the optioned audio and video module 246 before being sent to the speaker.

Otherwise the PA (public announcement) and music function can be provided in pre amp state via analog or digital format for connection to speakers by others, if optioned. The nominal 12 volt DC output can be utilized where advantage could be made of it for the purpose of supplying power to speakers of manufacture by others which are assembled for analog or digital input. A secondary power boosting module and a high efficiency high output speaker (not shown) is a potential option for the Sentinel Advanced Control Module FIG. 25-200, which alone or in multiple configuration could be relied upon for a PA (public announcement) function and/or music, the advantage being that vast distances can be reached simply by means of the fibre optic interconnection means or any combination of a wireless transceiver, fibre optic cables or electrical conductor with each transceiver serving the function of a repeating station and without loss of sound quality or speaker supply leads.

Devices labelled FIGS. 22 Q1 281, Q2 282 and Q3 283 represent electronically controlled switching modules activated by the microcontroller with programmable CPU 242. They may be FETs or intelligent switch devices which protect themselves from damage. The corresponding output terminals are by default wide angle motion detector 222 and photocell 223.

Referring to FIG. 23, output terminal strip #A2 251 is the interface between the Sentinel Advanced Control Module FIG. 25-200 and the items controlled by the microcontroller with programmable CPU FIG. 22-242, such as multicolor LED lamp(s) 272 option shown, incandescent lamps 277, 279, 280 and a pair of 12 volt terminals for the timed water valves for irrigation 278. Nominal 12 volts power supply 276 is also available on output terminal strip #A2 251 for other uses. There is short circuit and overload protection 240 which can shut down the output to prevent damage to the unit. The wireless data, audio and video transmit and receive (transceiver) module 227 consists of a radio transmitter and receiver which allows functions to be remote controlled in each of the Sentinel Advanced Control Modules FIG. 25-200. The microcontroller with programmable CPU FIG. 22-242 communicates with the transceiver module 227 by means of the REMOTE CONT line.

Many of the components seen in the electronic circuitry diagrams FIGS. 21, 22 and 23 are optional at time of manufacture. The printed circuit PC board modules and components are purposely laid out for this purpose. Optimization is engineered to eliminate all extraneous components not required by the end users.

FIG. 24 is a proprietary innovation to maintain the function of the overvoltage when transmission conductors to greatly reduce line losses or voltage drop, most specifically dimming, thus creating a system which is intended to provide energy savings, and with the LED lamps added slowly or all at once, an old system can be revamped and all components retained, but energy losses will be discovered, displayed and corrected via the microcontroller via the CPU and display.

This disclosure is a means of continuous isolation from wet contact to a maximum of 30 volts AC or DC comprised of the proprietary isolated switch mode power supply (SMPS) module 295 within the isolated SMPS encasement 296, and the weatherproof PVC (or other) cable/box connector 261, which can be optioned for use with the 0.5 Sentinel Control Module FIG. 16-211 and the Sentinel Advanced Control Module FIG. 25-200, and for continuity, the voltage and current modulated dimmers FIG. 8A, 8B.

National Electrical Code has ruled that “low voltage outdoor lighting systems” subject to wet contact be limited to nominal 15 volts AC or DC. Bondy et al believe we have met the National Electrical Code concern for harm resulting from possible electrical hazard due to wet contact. Once terminated and sealed, the proprietary means of transmission voltage isolation prevents contact with any metal or other conducting material until the voltage has been reduced to a maximum nominal 15 volts AC or DC. In our view, our disclosed wet contact isolation method is very much safer than commonly accepted methods of indoor power supply, which can expose 120 volts at the receptacle.

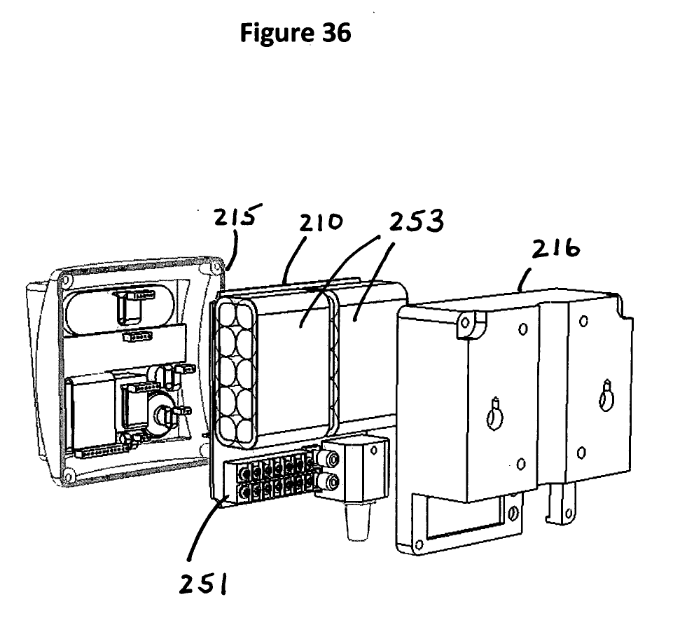

The input terminal cover best shown in FIG. 35-255 is extended by design to create a deeper bodied version for isolated SMPS encasement 296. The mold produces an encasement 296 with the same opening dimensions and the same form conforming mounting surface to the back of the printed circuit PC board FIG. 35-210 as the input terminal cover FIG. 35-255 (with gasket not shown), however the depth is increased to protrude as far back as possible without interfering with the surface mount back shell cover FIG. 36-216, FIG. 20-218, thus allowing more space for the isolated switch mode power supply SMPS module 295, and the 2 supply conductors 288 which attach to the input terminals FIG. 20-256 for the 0.5 Sentinel Control Module FIG. 16-211, or the 3 supply conductors 287, when including a communication conductor, which attach to 3 input terminals FIG. 35-250 for the Sentinel Advanced Control Module FIG. 25-200.

Where required, a qualified or licensed person would be employed to complete all terminations above nominal 15 volts. The 3 leads which exit the isolated switch mode power supply SMPS module 295 include 2 supply voltage options, to each of the 4 described embodiments for lamp and output control, of nominal 12 and 15 volts, and require pre-selection of voltage before mounting. These voltage options serve as descriptive to the function of the innovation. Other voltages might be chosen for use as per unforeseen circumstances or changes in National Electrical Code or for function in countries other than the U.S.A which might require an isolated SMPS with optioned or as built input voltages other than what has thus far been described.

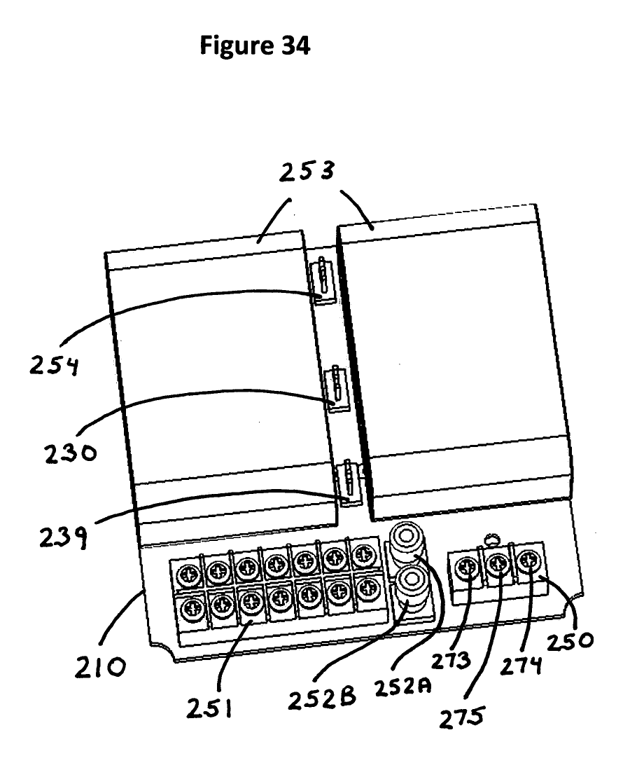

The Sentinel Advanced Control Module FIG. 25-200 accepts nominal 12 or 15 volts AC or DC maximum. Nominal 15 volts AC or DC is required for the optional battery array FIG. 34-253. The 0.5 Sentinel Control Module FIG. 16-211 accepts maximum nominal 12 volts AC or DC.

A weatherproof PVC (or other) cable/box connector 261 is tightened into the IC/0 of the isolated SMPS encasement 296. The over voltage transmission conductors are slipped through and attached to the isolated switch mode power supply SMPS module 295 with a gasket in place. The isolated switch mode power supply SMPS module 295 in the isolated SMPS encasement 296 is pressure push-snap-locked into position. A compression nut (not shown) is turned and a round grommet (not shown) is compressed to become tightly sealed around the supply conductors FIG. 24-287, 288. The longer screw 297 is used to attach the isolated SMPS encasement 296 to the printed circuit PC board FIG. 35-210 for the Sentinel Advanced Control Module, and FIG. 20-249 for the 0.5 Sentinel Control Module. A reinforced area of the PC board includes a press fitted female insert of corresponding thread and trade size to allow for the mounting of the input terminal cover FIG. 35-255 or the isolates SMPS encasement 296.

Once completed, the termination will provide either nominal nominal 12 or 15 volts depending on the switch setting accessible before positioning. Three conductors exit the isolated switch mode power supply SMPS module 295 and the third clearly marked COMM for communication conductor is only utilized when chosen for the Sentinel Advanced Control Module FIG. 25-200; otherwise it is taped.

We recommend NMWU or NMDU cable (14/2, 12/2, 10/2 for 2 conductors and 14/3, 12/3, 10/3 for 3 conductors) with the bare copper snipped back to the sheath and wrapped to cover with electrical tape. The red and black conductors are trade designated for low voltage DC. The identified conductor (white/grey) will then be taped suitably to cover all exposed portions of this conductor with yellow or brown or other colored tape, and is used optionally for the Sentinel Advanced Control Module FIG. 25-200 as seen in FIG. 35.

A continuous seal for further termination in a PVC (or other) weatherproof box is required prior to the power supply source if the communication cable is optioned. All taping of conductors is repeated and all required conductors from the low voltage power supply 24 volts or 30 volts Class 2 low voltage outdoor, are fed into said box. In this way the communication conductors will be electrically and mechanically connected without entering the power supply transformer housing. Once the PVC (or other) box is sealed and the isolated switch mode power supply SMPS module FIG. 24-295 is pressure push snap locked for isolation, then the remainder of the terminals and conductors will be a maximum nominal 12 to 15 volts AC or DC.

Connections at the applicable Class 2 transformer will be UL designated for outdoor low voltage nominal 30 volts maximum. A warning of hazard will be marked clearly as per Underwriters Laboratory UL and National Electrical Code requirements. Potential electrical hazard above nominal 15 volts occurs only by ignoring hazard warning labels and breaking open the isolated SMPS encasement 296 or other potentially hazardous components, i.e., junction boxes and supply transformers, all of which are to be marked as hazardous when placed for potential wet contact.

In addition, the described isolated switch mode power supply SMPS module 295 and isolated SMPS encasement 296 can be of the original size to fit the incandescent dimmer for halogen, etc., as shown in FIG. 8A, or the 3 color LED input dimmer as shown in FIG. 8B. The cover in this instance will include a gasket (not shown) and fastened with a screw and, as required, sealant. Thus the output from the isolated switch mode power supply SMPS module 295 will range from nominal 12 volts maximum to both the incandescent and LED dimmer modules of FIGS. 8A and 8B. Said encasements FIG. 8A-80, FIG. 8B-80 are formed by a bottom and top shell.

We disclose an upgraded embodiment which will include an input terminal location and the required seating surface such that each of the form conforming dimmer modules as seen in FIGS. 8A and 8B would include both the mount location and the female threaded press fitted insert as above. The result of these changes is that in each embodiment outer encasements are formed to accept either the input terminal cover FIG. 25-255 or the isolated SMPS encasement 296 as required.

In all cases the isolated switch mode power supply SMPS module 295 and isolated SMPS encasement 296 has been designed with safety as the first priority, however, the benefits can include considerable reductions in power or line losses for nominal 12 volt supply conductors, which cannot be made to carry voltage for dimming (i.e., nominal 6-12 volts) without very high losses or control from the point of supply, unless the supply conductors are large enough to limit these losses.

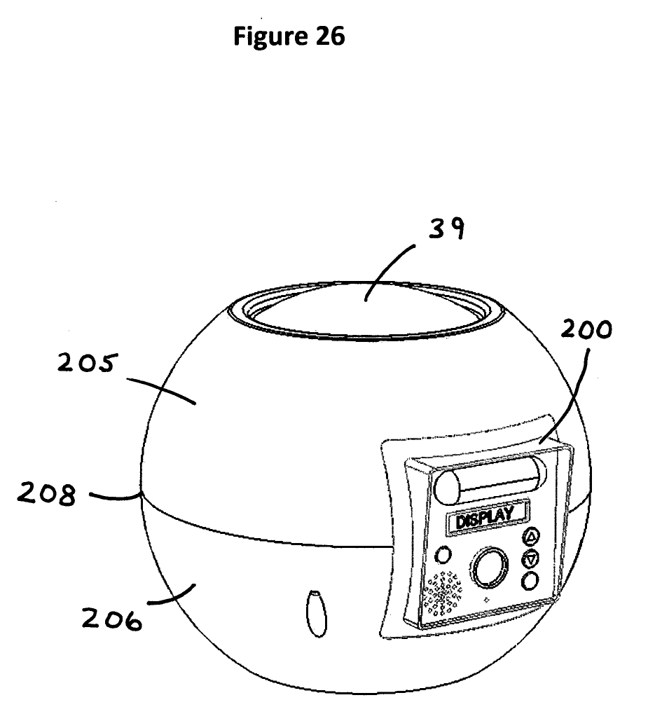

FIG. 25 illustrates the Sentinel Advanced Control Module 200 which may be used inside the two part spherical luminaire FIG. 26-208.

FIG. 26 illustrates a substantially spherical luminaire 208, which is a two part embodiment of the original spherical luminaire FIG. 4-21, but including the Sentinel Advanced Control Module 200. In the up light embodiment illustrated in FIG. 26, the top shell 205 conforms at the lamp 39 placement location to what is indicated in FIGS. 3, 4, 5, and 6. The bottom shell 206 has been altered to produce a flat surface at the lowest point of the luminaire. The supply conductor inlet is raised for correct clearance from the said flat bottom horizontal mounting surface. Clearly visible is the Sentinel Advanced Control Module 200.

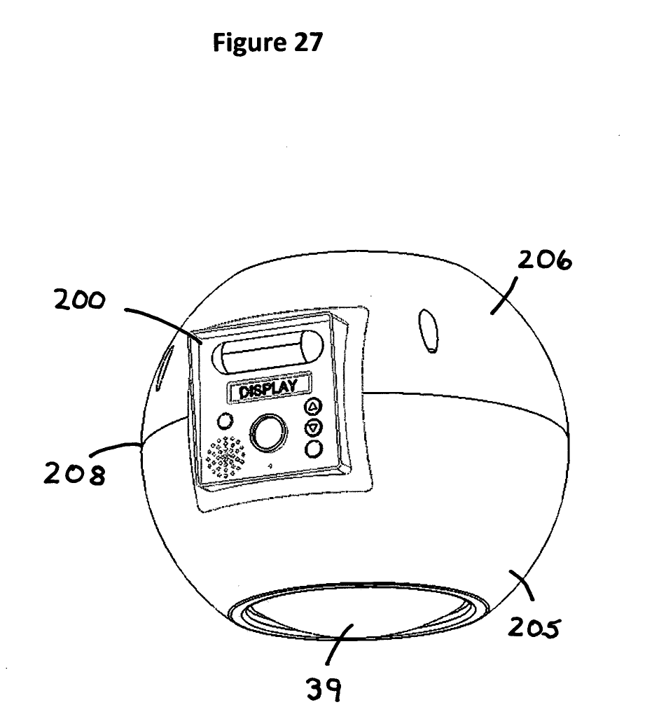

FIG. 27 illustrates the two part spherical luminaire 208 including the Sentinel Advanced Control Module 200 in a down light embodiment. The top shell 205, bottom shell 206 and lamp 39 have been inverted. The Sentinel Advanced Control Module FIG. 25-200 has been inverted by a rotation of 180 degrees (not shown).

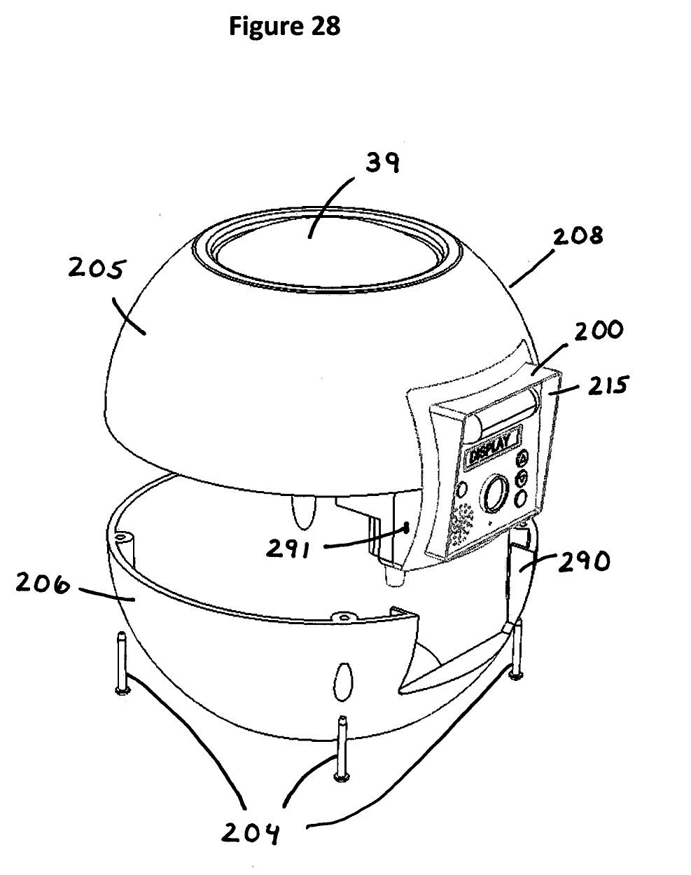

FIG. 28 illustrates where the Sentinel Advanced Control Module 200 fits into the top shell 205 and bottom shell 206 such that the Sentinel Advanced Control Module 200 may be inverted by a rotation of 180 degrees since the fit is identical either up or down, and this can be done simply and quickly after purchase. Stainless screws (each) 204 pass through holes which are hidden from view once tightened. A gasket 203 (not shown) is designed to weatherproof the joint formed between the shells. Also shown are one of four side walls 290, and one of two ridges 291 on the front shell 215 of the encasement of the Sentinel Advanced Control Module 200. Not shown is the precise means of Sentinel Advanced Control Module 200 attachment, however, it is intended to be done as described above without additional fasteners.

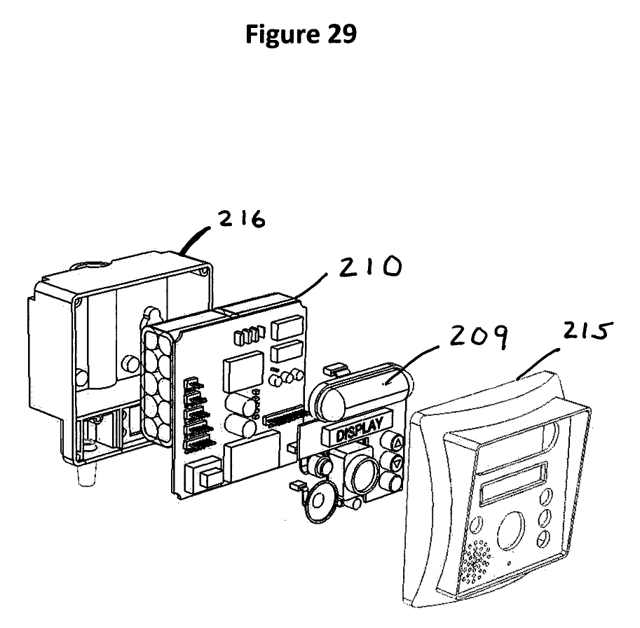

FIG. 29 illustrates an exploded view for the Sentinel Advanced Control Module FIG. 25-200 of the front shell 215 of the encasement (front face plate), front face plate options 209, back shell 216 of the encasement, the printed circuit PC board 210 with components indicated only as to location. The back shell cover 216 contains unfilled area. The optional transmit and receive (transceiver) 227 could be located there (not shown).

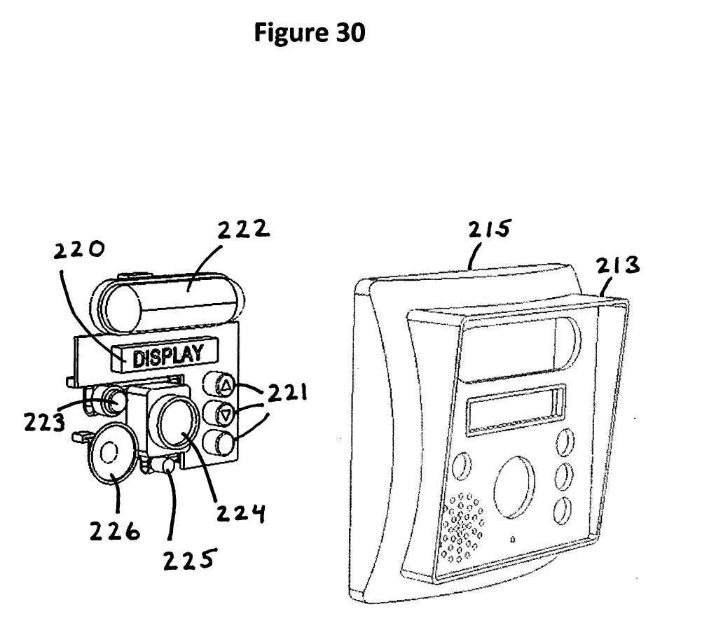

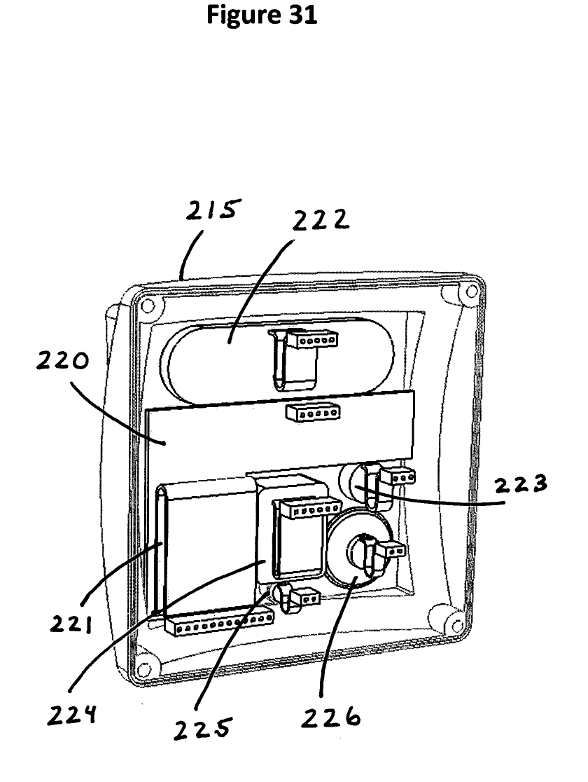

FIG. 30 illustrates the Sentinel Advanced Control Module FIG. 25-200 front shell encasement 215 (front face plate) with rain guard 213 and with all current options open to receive each component including: wide angle motion detector 222; photocell with variable output range 223; audio speaker or annunciator 226; microphone 225; video camera 224; liquid crystal (or other) display module 220; weatherproof momentary contact push-button switches 221.

FIG. 31 illustrates a conceptual means of cord connection. The back view of the Sentinel Advanced Control Module FIG. 25-200 front shell encasement 215 (front face plate) with all current options including: wide angle motion detector 222; photocell with variable output range 223; audio speaker or annunciator 226; microphone 225; video camera 224; liquid crystal (or other) display module 220; weatherproof momentary contact push-button switches 221; and also illustrates the cords and connectors to the printed circuit PC board FIG. 29-210 (not shown in FIG. 31) for all actuated outputs.

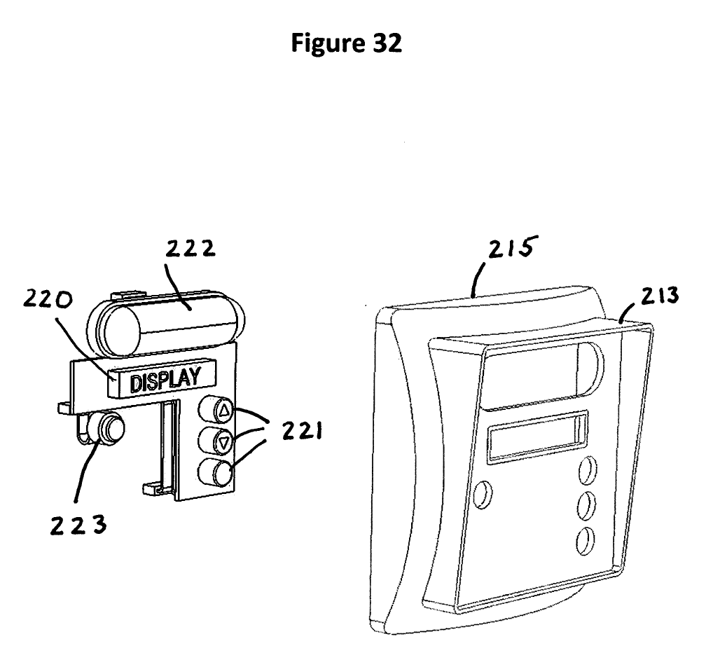

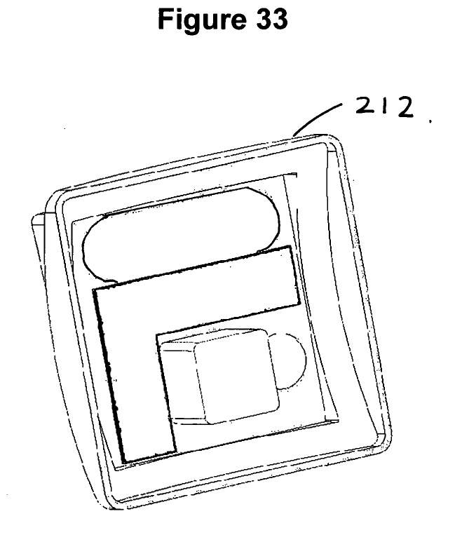

FIG. 32 illustrates an embodiment of the Sentinel Advanced Control Module 25-200 without the security options of the video camera 224, microphone 225, audio speaker or annunciator 226. The front shell encasement 215 (front face plate), rain guard 213, and other components are shown as in FIG. 30: wide angle motion detector 222; photocell with variable output range 223; liquid crystal (or other) display module 220; weatherproof momentary contact push-button switches 221.

FIG. 33 illustrates the back view of a generic face plate 212 of the same size as the front shell encasement 215 (front face plate) of the Sentinel Advanced Control Module FIG. 25-200. Blanks are utilized to fill voids which may be relied upon to reduce manufacturing costs when a production run is made and any or several of the optional components are not desired or required. This method would allow for simple and inexpensive manufacturing of various embodiments in the interest of reducing cost for the consumer.

FIG. 34 illustrates the back view of the Sentinel Advanced Control Module FIG. 25-200 with back shell 216, printed circuit PC board 210, dual 1.4 Amp/hour battery arrays 253, input terminals 250, output terminal strip 251, 3-pin male battery array connector 254 for the supply of the battery array 253, 3-pin male auxiliary connector 239 for the supply of the optional auxiliary large capacity battery array 237 (not shown), and fibre optic connectors 252A and 252B which form part of the optional fibre optic transmit receive module FIG. 21-236. The input terminals are for conductors from the weatherproof PVC (or other) cable/box connector FIG. 35-261. Two outer terminals L1 273, L2 274 are power inputs, the third in the center COMM 275 is for optional communication interconnection conductor best seen in FIG. 21. Not shown are battery array cables and 3-pin female connectors. Not shown is a jumper kit with 2 3-pin male connectors into a single 3-pin female. Not shown is a transmit and receive (transceiver) 227 with cord and 3-pin female connector located in the back shell void behind the battery array(s) 253, best seen in FIG. 29. In one embodiment as described, a third 3-pin male cable connector 230 would be included for optional transmit and receive (transceiver) assembly FIG. 23-227.

FIG. 35 illustrates the PC (printed circuit board) 210 and supply input terminals 250 for the Sentinel Advanced Control Module FIG. 25-200. Also shown are the input terminal cover 255 for double insulation of the supply input terminals 250, terminal cover screw 235, output terminal strip 251, weatherproof PVC (or other) cable/box connector 261, and also fibre optic connectors 252A, 252B and the battery array 253. The output terminals 251 are shown for connection to components. Not shown is the alternate mounting for fibre optic connector to allow for surface mounting of the fibre optic connectors 252A and 252B of the Sentinel Advanced Control Module FIG. 25-200.

FIG. 35 also illustrates the proprietary isolated switch mode power supply SMPS module 295 within the isolated SMPS encasement 296, both of which can be optioned for use with the Sentinel Advanced Control Module FIG. 25-200, and both of which are best illustrated and described in further detail in FIG. 24-295, 296. The isolated SMPS encasement 296 is extended to create a deeper bodied version of the input terminal cover 255 and requires a longer screw FIG. 24-297. It is molded to accept the weatherproof PVC (or other) cable/box connector 261. Once the isolated switch mode power supply SMPS module 295 is connected to the supply conductors 287, which are protected by a grommet, the isolated switch mode power supply SMPS module 295 will be tightly sealed with a gasket (not shown) via pressure push-snap-lock, completely enclosing the input termination means and isolated switch mode power supply SMPS module 295. The Sentinel Advanced Control Module FIG. 25-200 accepts nominal 12 or 15 volts AC or DC. Nominal 15 volts is required for the optional battery array 253.

FIG. 36 illustrates an exploded view of the front face 215 of the Sentinel Advanced Control Module FIG. 25-200 with all options as illustrated in FIG. 31. Also shown is the back of the printed circuit PC board 210 with optional battery array 253. Also shown is the back shell cover 216 with voids for the output terminal strip 251 and the fibre optic connectors FIG. 34-252A, 252B which form part of the optional fibre optic transmit receive module FIG. 21-236.

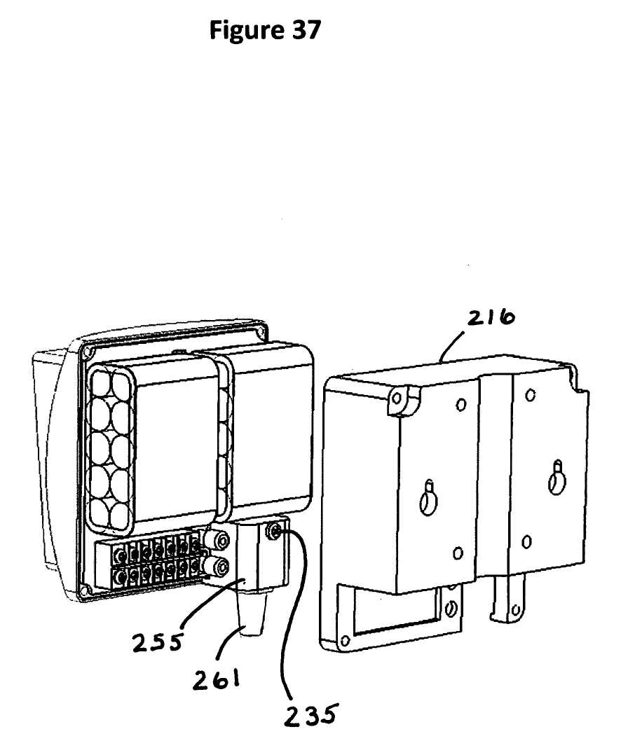

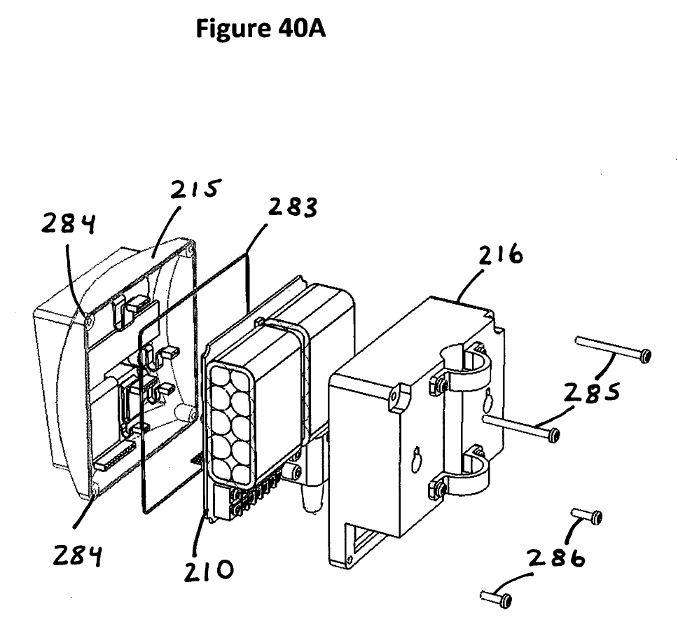

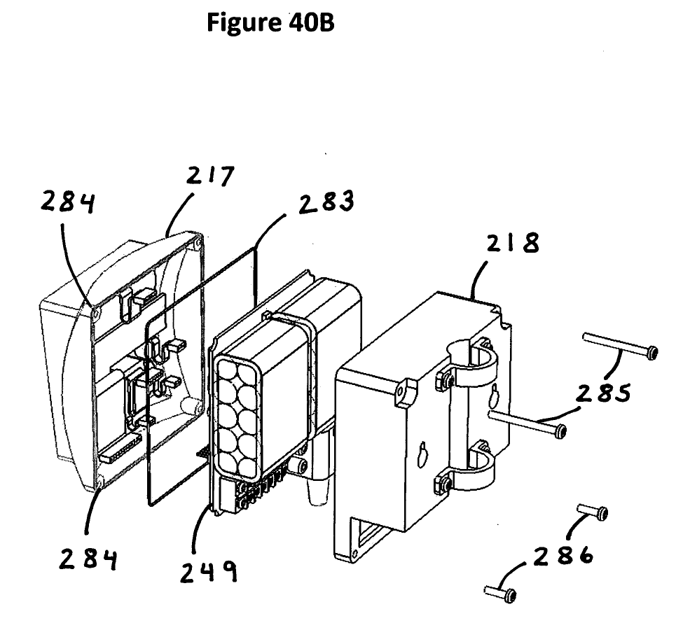

FIG. 37 illustrates an exploded view of the Sentinel Advanced Control Module FIG. 25-200, showing that the power supply input terminal cover 255 may be sealed upon installation with screw 235 and weatherproof PVC (or other) cable/box connector 261. All other back side components are accessible with back shell cover 218 removed. Cover screws are best shown in FIG. 40B 285, 286.

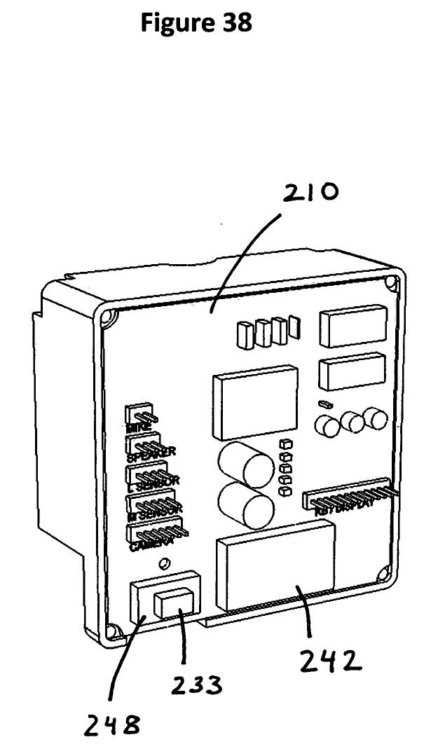

FIG. 38 illustrates the front view of the printed circuit PC board 210 of the Sentinel Advanced Control Module FIG. 25-200 with multiple components as seen on FIGS. 21, 22, 23, including a microcontroller with programmable CPU 242. Mounted on the cover of the LED and/or incandescent dimmer control module 248 is a temperature thermistor 233. Male wire connectors for speaker 226-C, for microphone 225-C, for video camera 224-C, for weatherproof momentary contact push-button switches 221-C, for motion detector 222-C, for photocell with variable output capacity 223-C, for liquid crystal (or other) display module 220-C. Note that some pins have additional pins for alternate potential use components.

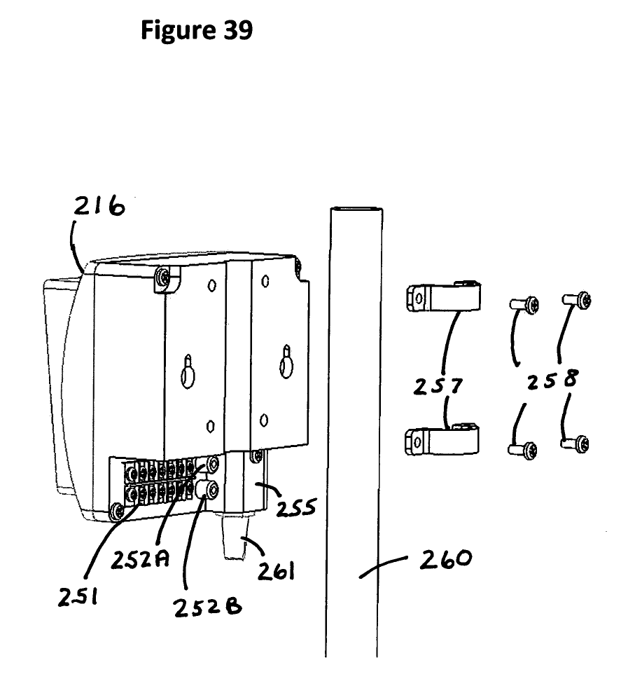

FIG. 39 illustrates the back view of the Sentinel Advanced Control Module FIG. 25-200 for mounting on a tubular garden pole or stake 260 (unassembled) with details: two mounting voids 259 for hanging on a fastener (i.e., for surface mounting); 2 hole pipe straps 257; four screws for straps 258; output terminal strip 251; input terminal cover 255; weatherproof PVC (or other) cable/box connector 261; fibre optic connectors 252A and 252B; and pole or stake for mounting 260. Not shown is a hinged or snap-on cover plate for the output terminal strip 251. The cover plate will include terminal markings for correct connections to luminaires and other potential components.

FIG. 40A illustrates the Sentinel Advanced Control Module FIG. 25-200 with means of sealing the front shell 215 with the back shell 216 via two top fasteners 285 and two bottom fasteners 286 which are threaded into threaded voids 284 in the back shell 216 and then into threaded voids 284 in the front shell 215 with the printed circuit PC board 210 contained within, and for the purpose of weatherproofing, with a compression gasket 262 between. A flange (not shown) prevents the printed circuit PC board 210 from pressing forward to the front shell 215.

FIG. 40B illustrates the 0.5 Sentinel Control Module FIG. 16-211 with a means of sealing the front shell 217 with the back shell 218. FIG. 40B is a replica of FIG. 40A, however the components are alternate, namely the front shell 217, back shell 218 and the printed circuit PC board 249. Two top fasteners 285 and two bottom fasteners 286 are threaded into threaded voids 284 in the back shell 218 and then into threaded voids 284 in the front shell 217 with the printed circuit PC board 249 contained within, and for the purpose of weatherproofing, with a compression gasket 262 between. A flange (not shown) prevents the printed circuit PC board 249 from pressing forward to the front shell 217.

For the 0.5 Sentinel Control Module FIG. 16-211 there are several differences in the front shell 217 and back shell 218, and the printed circuit PC board 249 compared to the Sentinel Advanced

Control Module FIG. 25-200 front shell FIG. 40A-215, back shell FIG. 40A-216 and printed circuit PC board FIG. 40A-210. However these differences are related to the number of additional components in the front shell FIG. 40A-215 of the Sentinel Advanced Control Module FIG. 25-200 which are not included in the front shell 217 of the 0.5 Sentinel Control Module FIG. 16-211. Additionally, the printed circuit PC board FIG. 40A-210 of the Sentinel Advanced Control Module FIG. 25-200 has further additional components which are not included in the printed circuit PC board 249 of the 0.5 Sentinel Advanced Control Module FIG. 16-211.

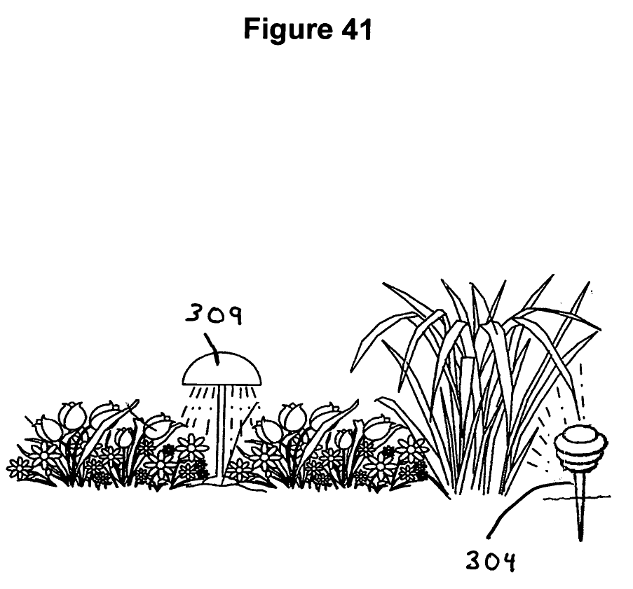

FIG. 41 illustrates a pathway luminaire 309 and a beacon 304. A pathway luminaire 150 is a luminaire containing a lamp which is dimmable, potentially dimmable, or not designed for dimming, and which is designed to illuminate pathways composed of pavement, pavers, gravel, or any other underfoot natural, manufactured or processed material forming a pathway. A beacon 151 is a luminaire typically containing a low energy LED or other lamp which is dimmable, potentially dimmable or not designed for dimming, which serves primarily as an indicator for navigation or for delineation of a boundary.

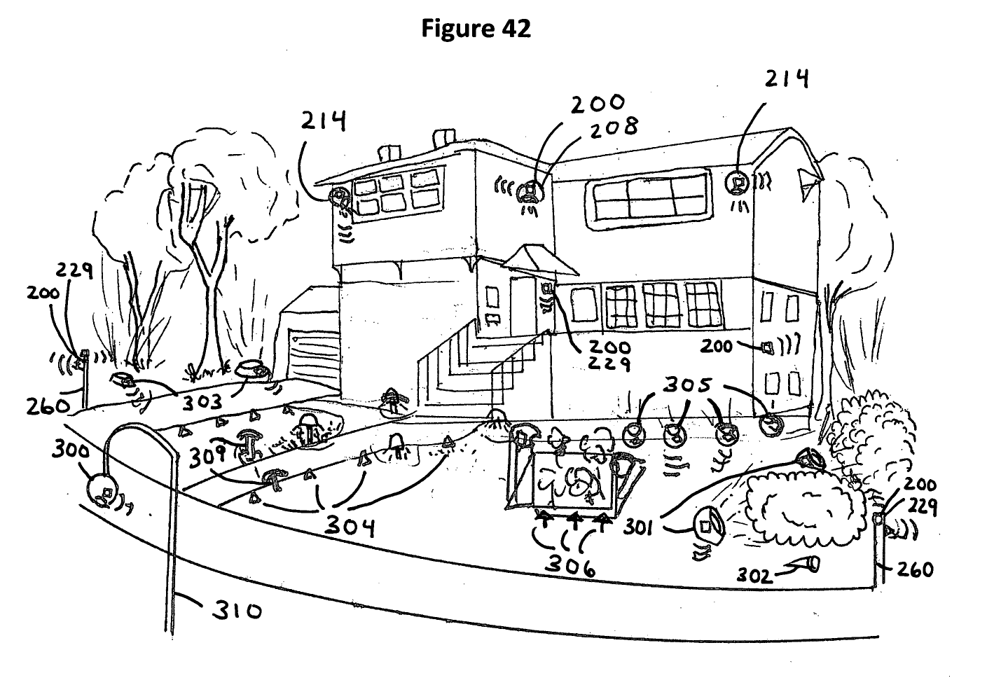

FIGS. 42, 43, 44 and 45 illustrate a house on a developed lot. Luminaires include: two floodlight luminaires 301 by the side hedge, one narrow flood light luminaire 302 by the hedge, two well-type luminaires 303, a number of beacons 304, four wall wash luminaires 305, three garden luminaires 306, a number of pathway luminaires 309 along the path and driveway. Additionally, there are two proprietary luminaires with lamps only 214 (i.e., without a control module) providing soft lit down lighting at the top right and left corners of the house. There are a total of 5 Sentinel Advanced Control Modules on the property: two Sentinel Advanced Control Modules 200 mounted on a post and tube 260 on either side of the lot facing 45 degrees into the yard and additional narrow angle variable long range motion detector(s) 229 which will detect distant persons when placed at the perimter, one Sentinel Advanced Control Module 200 mounted on a side wall of the house, one Sentinel Advanced Control Module 200 mounted at the entrance beside the door with an additional narrow angle variable long range motion detector 229, and one Sentinel Advanced Control Module 200 within a proprietary spherical luminaire encasement 208 providing soft-lit down lighting above the entrance. All the dimmable luminaires may be dimmed as desired. Also illustrated is a down light 300 (which comprises a Sentinel Advanced Control Module 200 within an inverted cast bronze proprietary spherical luminaire) mounted on a street standard 310 beside the road. Not shown in FIGS. 42, 43, 44 and 45 is the back yard where, if desired, there could be mounted aesthetic path or area lighting including beacons 304. However, the control of all yard luminaires can be isolated from the front as desired from individual 0.5 Sentinel Control Modules FIG. 16-211. The Sentinel Advanced Control Module FIG. 25-200 allows the same isolation, but for special occasions any or all lamps may be programmed to function in unison.

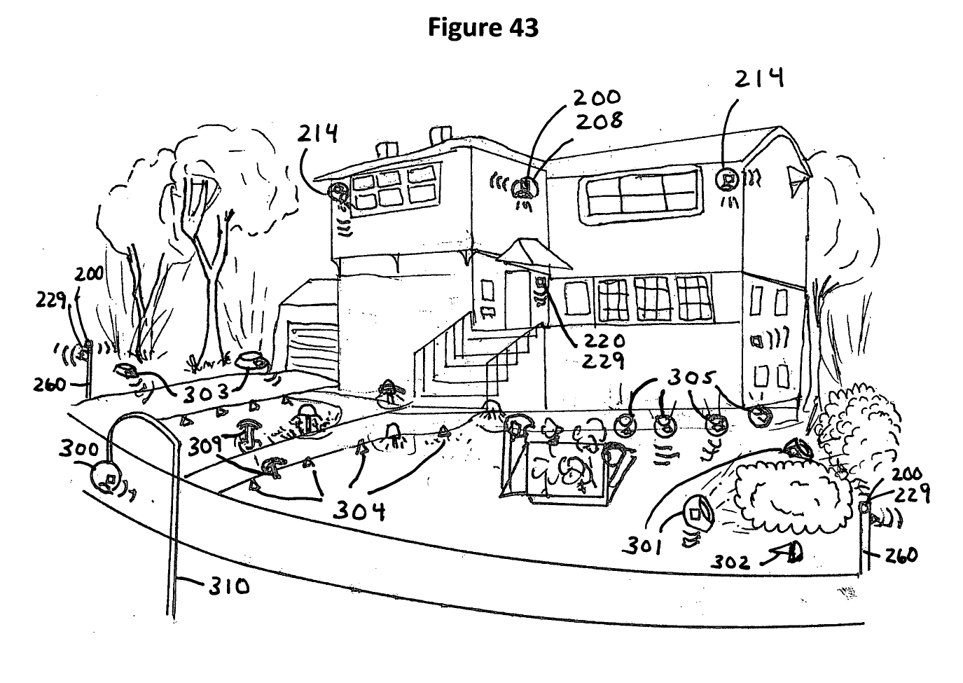

An additional and optional narrow angle variable long range motion detector 229 may be mounted on the proprietary spherical luminaire encasement 208 which includes the Sentinel Advanced Control Module 200, or on the proprietary sphere with lamp only 214, or as seen most clearly in FIG. 43, on the body of the Sentinel Advanced Control Module 200 which is attached to a tube on top of a post 260 in this figure, although it may also be mounted in other ways. The narrow angle variable long range motion detector 229 differs from the wide angle motion detector FIG. 30-222 located on the front shell FIG. 30-215 of the Sentinel Advanced Control Module FIG. 25-200, and in this example is additional to the wide angle motion detector FIG. 30-222. The narrow angle wide range motion detector 229 allows for the Sentinel Advanced Control Module 200 to be directed into the property for security. A low level standby light output can be maintained and programmed for a slow ramping up when persons are detected approaching the property from a distance.

FIG. 42 illustrates a scene where persons have walked past the narrow angle variable long range motion detector 229 located in one of the two Sentinel Advanced Control Modules 200 mounted on a post and tube 260. The narrow angle variable long range motion detector 229 has ramped the aesthetic illumination to the pre-selected set percentage full ON and has actuated all 5 of the Sentinel Advanced Control Modules 200 to energize for a pre-selected delay ON of 5 minutes. Not shown is the ‘ready’ output, however, for example, the output could be set for 30 percent for the wall wash luminaires 305 and the soft lit down light proprietary spherical luminaire encasement 208 with Sentinel Advanced Control Module 200 located above the entrance to the house, and two proprietary luminaires with lamps only 214.

FIG. 43 illustrates a scene with reduced energy and aesthetic lighting which is programmed to begin at the third hour and remains ON for two hours, after which all the luminaires are de-energized except for the beacons 304, which remain ON until dawn. During said two hours, two well-type luminaires 303, four wall wash luminaires 305, and two floodlight luminaires 301 by the side hedge and one narrow floodlight luminaire 302 by the hedge remain ON. Every luminaire is dimmed unless persons pass in this example.

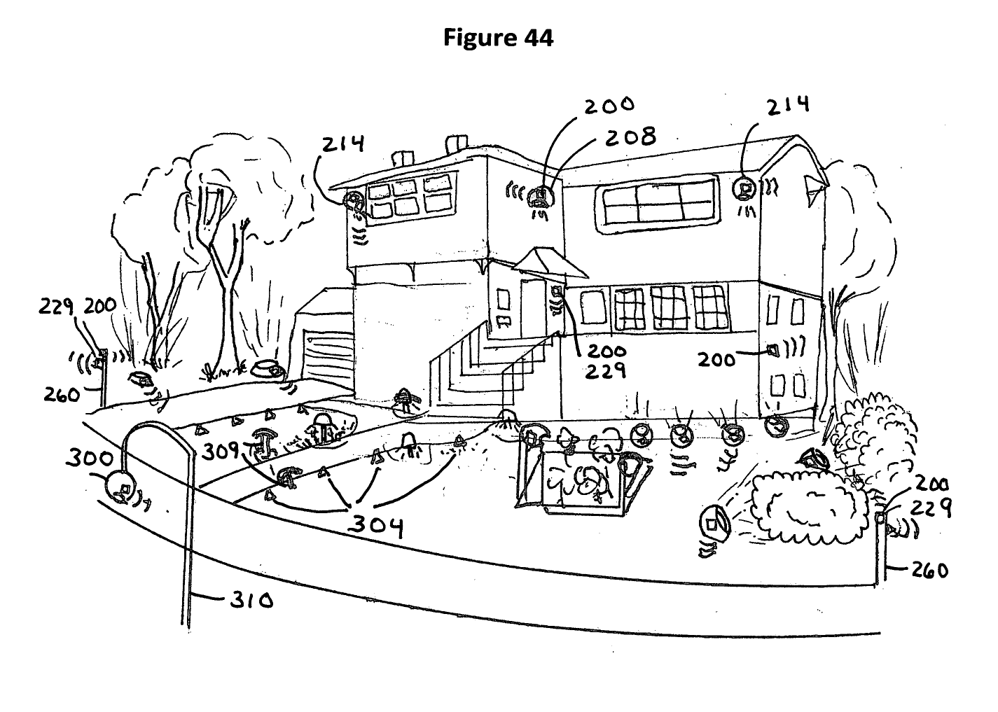

FIG. 44 illustrates a scene where a guest arrives late at night. All beacons 304 are ON. The Sentinel Advanced Control Module 200 mounted on the post and tube 260 located on the left side of the property detects the motion, as do two the Sentinel Advanced Control Modules 200, one in the proprietary spherical luminaire encasement 208 located above the entrance, and one at the entrance beside the door. All pathway luminaires 309 along the path and driveway are energized ON, as is the Sentinel Advanced Control Module 200 in proprietary spherical luminaire encasement 208 located above the entrance. Note that it is possible to program the pathway luminaires 309 to be energized only if the Sentinel Advanced Control Module 200 beside the entrance door, and/or when the optional narrow angle variable long range motion detector 229 is activated.

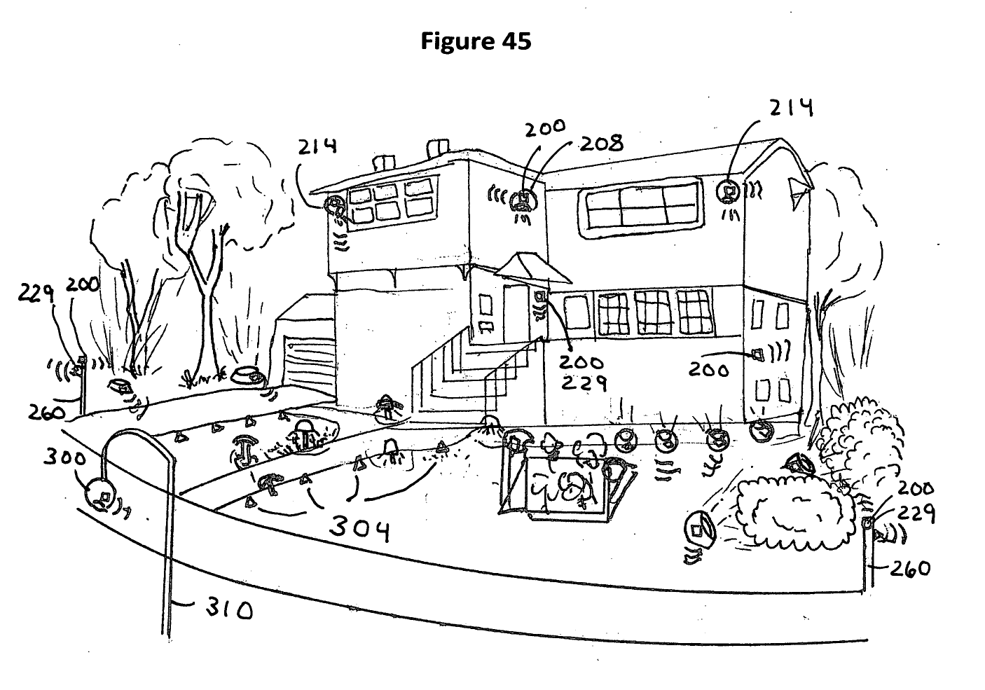

FIG. 45 illustrates a scene where all beacons 304 are ON from dusk to dawn. The system is ready for a guest but will count time with pathway luminaires 309 energized ON at low output, and with more time lapsed will brighten. Movement off the path to the side, where most people would consider inappropriate, will cause all luminaires/lamps to be energized to 50 percent. Then, 20 seconds after this, luminaires/lamps will be energized to 80 percent, and after another 20 seconds, to 100 percent. At this time, optionally, a pre-set audio announcement recording could, if programmed to do so, request the person's to leave the property. After 30 seconds more, all luminaires/lamps would begin to flash. Note that this is only an example of how the security system could be programmed, if equipped, and many variations are possible.

The herein described invention may be embodied in other specific forms and with additional options and accessories without departing from the spirit or essential characteristics thereof. The presently disclosed embodiments are therefore to be considered in all respects as illustrative and not restrictive, the scope of the invention being indicated by the appended claims rather than by the foregoing description, and all changes which come within the meaning and range of equivalence of the claims are therefore intended to be embraced therein.

We claim:

1. A system of extra-low voltage outdoor lighting wherein a control module, which is located either inside a fixture, attached to a fixture or as close as practicable to a fixture, and which has an exterior accessible means of variable adjustment of an approximation of desired luminous intensity projected from a lamp to which it supplies electrical energy, and said adjustment means is commonly referred to as a dimmer, and when said control module is supplied with a greater than zero number of volts by power supply conductors, and when on occasion said power supply conductors cease to supply said voltage for a greater than zero number of milliseconds, then said control module has a means of reproducing said desired luminous intensity for a greater than zero number of occasions, and said variable number of milliseconds results from a greater than zero number of potential means, thus the said system can be utilized for a wide range of applications with the advantage that said dimming of said lamp at said fixture reduces power supply conductor losses, and said dimming of said lamp at said fixture to the minimum requirement may reduce both the lamp current and the line losses yet further for a substantial overall energy demand reduction, and if the supply voltage is greater than the lamp voltage then said supply voltage will be regulated by said control module and said increased supply voltage will be a means of reducing current flow in said supply conductors without loss of luminous intensity of said lamp and thereby further reduce losses in said supply conductors.

2. The system of lighting of claim 1, in which the control module first rectifies, then regulates, and then can be made to dim the power supplied to the extra-low voltage light fixture.

3. The system of lighting of claim 1, in which power at 24 volts AC is supplied along an electrical conductor that would typically be used for 12 volts, and is then stepped down by the control module to 12 volts DC to the light fixture, whereby voltage drop and power loss over the electrical conductor is approximately halved.

4. The system of lighting of claim 1, in which in addition to stepping power supply voltage down from 24 volts AC to 12 volts DC, the control module provides for selectable further reduction of voltage to the fixture as desired for dimming lighting effects and further energy savings.

5. The system of lighting of claim 1, in which a plurality of lights are connected in a circuit, provided that aggregate current draw by the light fixtures does not exceed the capacity of the control module.

6. The system of lighting of claim 1, in which a supply voltage used in the system for power transmission is 24 volts AC rather than 12 volts AC, whereby power would be saved over using 12 volts AC for power transmission over a distance, given an equal light output and equally sized power supply conductors.

7. The system of lighting of claim 1, in which an extra-low voltage control module including an outdoor extra-low voltage lighting regulator, rectifier, and dimmer operating exclusively between 4 and 30 volts, is used.

8. The system of lighting of claim 1, in which the control module is encased in a weatherproof housing and has an accessible dimming control which can be used to further reduce power consumption from 12 volts DC down and enhance outdoor lighting effects

9. The system of lighting of claim 1, in which the control module is supplied with voltage that is greater than 11 volts via transmission cables that are supplied with the highest voltage that applicable electrical codes will allow, typically 30 volts, for extra-low voltage applications or for low voltage lighting systems.

10. The system of lighting of claim 1, in which the control module will bring down by means of voltage regulation, a supplied voltage to 12 volts, which is industry standard, effectively creating a transmission line effect of power supply conductors.

11. The system of lighting of claim 10, in which the control module can further reduce voltage by means of an accessible dimming control from 12 volts DC down.

12. The system of lighting of claim 1, in which the control module when properly supplied will ensure that maximum voltage is supplied to each light fixture and only then will the voltage, be fed to a dimmer in order to enable the most widely variable desired light effect in extra-low voltage at the light fixture.

13. The system of lighting of claim 1, in which a dimming control will reduce voltage for the sake of dimming and energy savings down from 12 volts DC to a light fade out voltage of a extra-low voltage fixture light and back up to full voltage (12 volts) repeatedly as selected by an end user.

14. The system of lighting of claim 1, in which the control module will fit inside a substantially spherical light fixture with or without a convertible mushroom cap.

15. The system of lighting of claim 1, in which the light fixture allows for rapid conversion from up-light to down-light by means of a tube and a mushroom shaped canopy.

16. The system of lighting of claim 1, in which the light fixtures have multi-colored LED lamps which when combined can be made to imitate the light output of a halogen lamp and when dimmed retain the same color as with full power, whereby more energy may be conserved.

17. A system of lighting claim 1, in which a DC power supply feeds current to the control module between 12 and 30 volts DC, the control module protecting a lamp in the light fixture from over-voltage.

18. The system of lighting of claim 2, in which:
a) power at 24 volts AC is supplied along an electrical conductor that would typically be used for 12 volts AC, and is then stepped down by the control module to 12 volts DC to the light fixture, whereby power loss over the electrical cable is approximately halved;
b) in addition to stepping power supply voltage down from 24 volts AC to 12 volts DC, the control module provides for selectable further reduction of voltage to the fixture as desired for dimming lighting effects and further energy savings;
c) an extra-low voltage control module including an outdoor extra-low voltage lighting regulator, rectifier, and dimmer operating exclusively between 4 and 30 volts AC and DC, is used;
d) in which the control module is encased in a weatherproof housing and has an accessible dimming control which can be used to further reduce power consumption from 12 volts DC down and enhance outdoor lighting effects;
e) the control module will fit inside a substantially spherical fixture with or without a convertible mushroom cap;
f) the light fixture allows for rapid conversion of from up-light to down-light by means of a tube and a mushroom shaped canopy.

19. The system of lighting claim 1, further comprising an LED control module for the dimming of multi-color LED lamps.

20. The system of lighting claim 1, in which a multi-color LED lamp comprises red, yellow and white emitters to simulate halogen light and has a glass refractory lens to provide a substantially homogenous blending of colours.
Note to examiner: Independent claims 21 and 22 are based on an original embodiment in prior U.S. patent application Ser. No. 10/999,917, ‘MULTIPLE DIMMER LIGHTING SYSTEM”, by the same inventors, Bondy et al., and the continuation-in-part of prior U.S. patent application Ser. No. 11/723,445, “ENERGY SAVING EXTRA-LOW VOLTAGE DIMMER LIGHTING SYSTEM”, by the same inventors, Bondy et al, in which the original embodiment was comprised of a means of voltage regulation, rectification and modulation/dimming of a low voltage halogen lamp or color control and current modulation/dimming of a 3 color or other LED lamp. In the embodiment of claim 21, these capacities are individually provided for in modules which may be chosen depending on required or desired function. Also, importantly, Bondy et al claimed 3 color control in the original patent application Ser. No. 10/999,917.

21. An embodiment of the multiple dimmer lighting system, which potentially in some embodiments or groups could be called a “low voltage outdoor lighting system”,
and which optionally may include a proprietary weatherproof spherical luminaire encasement such that when the spherical luminaire encasement is optimized for the inclusion of the Sentinel Advanced Control Module, that said Sentinel Advanced Control Module be fitted via a split shell embodiment of the advantageous proprietary spherical luminaire encasement by means of matching voids in the invertible top and bottom of said shells,
and each said Sentinel Advanced Control Module, whether fitted in the spherical luminaire or not, will include a dimmer module socket or installation location which will accept a single lamp dimmer module comprised of components for voltage modulation or a multi-color LED driver,
and comprised of components for a 3-color LED emitter lamp, and comprised additionally of components for current modulation, and one embodiment is comprised of all of the above components in a single dimmer module,
and each said Sentinel Advanced Control Module, whether fitted in the spherical luminaire encasement or not, is comprised of an internal mainframe structure and a greater than zero number of internal modules which will allow for multiple potential control functions, but that in the main the base state of one embodiment will, in addition to said dimmer socket and dimmer module, include
a weatherproof means of encasement with front and back shells and gasket, and
with voids for required embodiments or voids for all embodiments and blanks for unused optional modules, and
a means of being securely fitted into the proprietary spherical luminaire encasement with top and bottom shell, and/or optionally a means of mounting on a stake or post and/or a means of surface mounting, and
a means of current overload protection, and
a microcontroller with a programmable central processing unit (CPU), and
a printed circuit board with all listed components and potentially sockets for all potential optional modules, and
a 5 volt power supply module, and
a means of power supply output via an output terminal strip or other conductor termination means, and
a means of power supply input via an input terminal strip or block, and and via the input terminal strip a third communication conductor and termination means, and/or a fiber optic transmit and receive module including cable connector(s), and/or a wireless transmit and receive module, or alternatively to the above three means, and
a communications module, and
a push button module with accessible momentary contact buttons for the purpose of programming or actuating said microcontroller with programmable central processing unit (CPU), and
a liquid crystal or other display module, and
a means of accepting a switching or other power supply module for the isolation of low voltage greater than nominal 15 volts, and
a means of storing voice recognition programming, and any of the communication options are a means of increasing program and memory capacity, thus as voice recognition improves as it has thus far, the central processing unit (cpu) will be enlarged and with the microphone module and potentially the speaker module, the sentinel advanced control module can be made to recognize/distinguish one voice from another, and this will be a security and function advantage,
and said embodiment may be utilized to control or supply output energy to a greater than zero number of output terminals on the output terminal block,
and the programming for the energization of said outputs can in the main be programmed via the described data input means,
and when fitted into a void or voids in the optional proprietary spherical luminaire encasement, can be made to provide the described outputs, and for the completion of the described luminaire, a lamp and a mounting grommet with supply lead to said lamp,
and said Sentinel Advanced Control Module is formed and designed for the modular optimization of a greater than zero number of additional components which may be accurately described as function or function supply modules, and that the body encasement and the printed circuit PC board are purposely constructed, for comparison, as is a mainframe for a home computer, whereby modules or cards may be purchased as required or desired but said components are in the main supplied with required operating hardware,
and in this embodiment, the mainframe with plug-in sockets or attachment locations allows for the inclusion of modules as described in this document but not limited to the modules described in this document,
and the component sockets or attachment locations may be industry standard and with ample conductor capacity to allow for a continuous addition of function modules, or as new devices are made available, they may be proprietary to Bondy et al or custom ordered to fit the existing sockets,
and an inexpensive patch cord may be included for the purpose of connecting modules which can be utilized most efficiently in this way,
and all of the capacities of the connectors and conductors may be upgraded to allow for current flow and ambient temperature ratings exceeding the described modules' capacities and output conductors chosen for maximum possible load as approved by governing agencies, but not less than National Electrical Code allows,
and a connector (not shown) is placed for a variety of potential cooling devices, if required,
and said Sentinel Advanced Control Module forms the operating system to which, as much as is desired or required, possible functions may be interconnected, and like the mainframe of a computer, increased functions or upgrades are possible,
and all of the above makes possible a wide variety of lamp control and control of other devices and supply not limited to what is included at time of purchase or assembly,
and the functions of the power supply have been brought to, or as close as practicable to, the locality of the lamps, the results of which are energy savings and greater range of energy saving and improved function control options, comprised of, but not limited to the following, all of which may be optioned either during assembly or after purchase:
a module comprised of a means to provide a current limiter, over current protection and ammeter, and
two resistors to form a voltage divider, and
two diodes to cause voltage rectification of the power supply, and
a 12 volt power supply module, and
a communications module, and
a fiber optic transmit/receive module including two connectors for fiber optic data management and connection, and
a wet contact isolation power supply module for supply voltage inputs above nominal 15 volts, and
a battery charge control module, and
a battery fuel gauge module, and
an output over current protection and shutdown module for one output terminal pair, and
a battery array pack assembly module, and
a clock timer module, and
an audio video module, and
an LED and/or incandescent dimmer module with or without color control drivers, and
and switching modules Q1, Q2, Q3 for three controlled output terminals for supply of lamps, and
and an liquid crystal display LCD module, and
and a narrow angle long range motion detector module, and
a photocell module, and
a wide range variable motion detector module, and
a video camera assembly module, and
a microphone module, and
a speaker module, and
a wireless data, audio and video transmit and receive (transceiver) module,
and by means of some of said components, the capacity to directly connect to an alternate power supply up to a nominal 12 volts, and via an isolating power supply module built for this purpose, a nominal 24 to 30 volts.

22. A system of extra low or low voltage outdoor lighting and potential auxiliary systems control which is intended to reduce energy use and increase lighting function, and said system in the main ranges to nominal 30 volts AC and 48 volts DC but in one embodiment supplies at the output terminals a maximum nominal 15 volts AC or DC, and said system is comprised of all of the following items which have been designed for inclusion, which may also plug in as modules into sockets or attachment locations:
a microcontroller with a programmable central processing unit (CPU), and
a module comprised of a means of double insulation and isolation of voltage greater than 15 volts AC or DC, and
a module comprised of a means of reducing 15 volts AC or DC input to 12 volts AC or DC or other as required to energize lamp(s), as for example, for reduction of line losses or to make available charging voltage for a 12 volt battery array, and
a 4 conductor output terminal set fed by a module which makes possible the color control of LED lamps, and also lamps which can be dimmed via current modulation, if the above module includes this capacity or otherwise supplied via fixed supply current at nominal 12 volts to 4 terminals for LED lamps of total 30 watts, and
a module comprised of a means to allow for controlled dimming of any voltage modulated lamp which is approved for this purpose, and
one or more output terminal pairs may be energized and de-energized by means of a photocell input to said microcontroller with programmable central processing unit (CPU), and
one or more output terminal pairs may be energized and de-energized by a means of a module comprised of a photocell with variable output capacity to said microcontroller with programmable central processing unit (CPU) and allows for a pre-set contrast to be maintained from dusk to ambient darkness for aesthetics and/or energy savings, and
one or more output terminal pairs which may be energized or de-energized by means of a wide range motion detector and input to the control by means of a pre-selected output response from said microcontroller with programmable central processing unit (CPU), and to any number of the dimmer outputs or simply to energize and de-energize lamps which are not supplied from terminals with dimming capacity depending on options chosen and utilized, and
one or more output terminal pairs which may be energized or de-energized by means of a narrow angle long range motion detector by means of a pre-selected output response from said microcontroller with programmable central processing unit (CPU), and
one or more output terminal pairs which may be energized or de-energized by means of a clock timer module by means of a pre-selected output response from said microcontroller with a programmable central processing unit (CPU), and
one or more output terminal pairs which may be energized or de-energized by means of an optional adjustable over current protection and shutdown module which provides a 12 volt electrical supply which may serve any approved purpose up to the limit of the overload protection, and which allows for said terminal pair to be energized or de-energized via said microcontroller with programmable central processing unit (CPU), and
a greater than zero number of actuation means, or combinations of actuation means, for all said output terminals, and
said microcontroller with programmable central processing unit (CPU) has the capacity to energize any of said output terminal pairs by means of input from a greater than zero number of momentary contact push button switches, and
and said microcontroller with programmable central processing unit (CPU) may energize any of said terminal pairs by means of input from any of said actuation means or combinations of said actuation means, and
said narrow angle long range motion detector can be utilized to detect motion at greater distances and may be utilized to ramp up aesthetic or functional lamp(s) output to increase the luminous intensity as to be fully operational once person(s) are in closer proximity, and in this manner conserve energy by ramping to desired settings when persons are near enough to view, and said narrow angle long range motion detector is comprised of a means of independent horizontal rotation for aim, and
the outer encasement of the luminaire can be produced with voids for as many as 3 Sentinel Advanced Control Modules, and by means of two or more of said voids, allow for up to 360 degrees of motion detection and audio/video monitoring such that the pathways may be illuminated and/or illuminated at a greater luminous intensity when motion is detected, and
said microcontroller with programmable central processing unit (CPU) can by means of any of said actuation means and a greater than zero number of power outputs energize and de-energize with or without a greater than zero number of current and/or voltage modulation means, and can then be dimmed by the Control Module, such that 3 lamps can be optioned, and as optioned, said dimmer control module may provide for up to 3 terminal pairs, one being common to each of three or less, and
not less than 3 paths for data to be shared, signalled or transmitted among other Sentinel Advanced Control Modules and/or to central control systems, indoors or outdoors with software now available or created in the future for this purpose,
a greater than zero number of means of interconnection in addition to said electrical communication conductor, including a wireless transmit and receive module, and/or a fiber optic transmit and receive module via one or more connectors, or a means of interconnection comprised of any combination of those listed above or alternatively, and
a central processing unit (CPU) with the required capacity to run any program desired and/or required or the capacity to accept and process data from a much larger processor, such as a personal computer, and
an audio video module and a video camera for input from and output to a speaker and a microphone for the purpose of multi-directional communication (intercom) with a speaker and microphone and/or multipath audio/video with a video camera, and
with the capacity for a speaker of the required power handling capacity as to be used in a greater than zero number of interconnecting modules which can be made to function as a public announcement (PA) system or a source of live or recorded music, and
a microphone module, and
a video monitor option, and
a means of storing voice recognition programming, and
a means of weatherproof battery array enclosure placement within the back shell cover of said Sentinel Advanced Control Module, including venting where required, and
a module comprised of a means of over current protection, and
a module comprised of a means to provide a current limiter/controller, over current protection and ammeter, and
a socket for a battery charger module which includes the capacity to charge and maintain a battery array with nominal storage capacity of 0.5 kW/hours or greater or lesser capacity with the advantage that as a socket and module are utilized, the future battery arrays can be provided for in the spherical lamp encasement which is compatible with the design of said Sentinel Advanced Control Module encasement, and
a switched terminal pair which may be used to control an irrigation valve which provides an irrigation function, and this output can be utilized for any purpose, and
a thermistor which placed on or projecting into said dimmer module sends a continuous variable resistance to said microcontroller with programmable central processing unit (CPU) and is thereby a means of detection of excessive heat build up resulting from the ramping up and down of the lamps which are being driven by said dimmer control module, via a pre-selected and entered program to said thermistor which will provide input to said microcontroller with programmable central processing unit (CPU), which will allow for a factory set heat reduction program which may include a time controller program which slows ramp speed and/or reduces power output to lamps to which it supplies energy, and
voice recognition hardware and software which would function with a greater than zero number of said Sentinel Advanced Control Modules, and
a handheld remote control wireless transmitter and receiver, and
a means of connection to and software for a central remote control to a personal computer (PC) or a portable personal computer (PC) via electrical conductor, fiber optic cable or wireless transceiver for the purpose of entering programs or changing programs, or monitoring functions of components which are chosen for the provision of security, and any other of the currently available systems, or systems which may become available in the future, intended for this or other functions, and
when provided with a battery array of the correct capacity and a battery charger module which corresponds with the battery array charge requirements, a direct connection to a solar panel, which when correctly sized for full power during winter months, will supply power along the original supply conductors such that there will be a surplus energy produced and stored, and
a module socket for charging and a battery charger consisting of desired charge and discharge capacity and corresponding battery array, with the means for the inclusion of a battery array and/or a larger capacity battery charge controller module with corresponding capacity battery over current protection, and optional auxiliary large capacity battery array, and
a means for additional battery capacity for direct connection to solar panel or other alternate energy source, either AC or DC to 30 volts, and
a battery fuel gauge module, and
by means of a voltage drop limiting control, reduced by means of a 24 hour battery array charging means, where available, such that the daily illumination requirements may be produced by the transmission of a voltage which will not exceed a required or desired maximum limit for the purpose of reducing voltage drop in supply conductors feeding one or multiple modules along a pathway or at a distance from the on grid or off grid power supply source, and
with multiple pre-programmed security default operation choices for staged security response including a means of full system luminous intensity ramp-up to full power flashing followed optionally by audio and signalling to a central dialler and internal audio video output, and optionally including irrigation actuation, and
where the absence of any of the described modules would result in a lack of function due to incomplete circuits, blanks which complete the circuit will be included where required for correct function, and
the spherical luminaire housing can be fitted with an auxiliary beacon luminaire, either blue for security enhancement, or blue as desired, or any other color but additional to the primary lamp, and connected to the terminal pair intended for photocell actuated output for dusk to dawn lamp function with override from the microcontroller with programmable central processing unit CPU, and
a means for energizing and with a second source rotate or swivel in a socket device so that either by manual or motorized adjustment, lasers of any color available now or in the future, can be added both to delineate and create yet greater aesthetics, or for security, and modular in application, and said laser light output can be actuated by a greater than zero number of devices, and also said movement can be made to follow a pre-selected path for a pre-selected duration by means of said actuator(s) and programming of the Sentinel Advanced Control Module microcontroller with programmable CPU, and the electric or electromechanical beam direction mechanism for a greater than zero number of purposes, and motion detection and other actuation can be utilized to prevent injury with safe function, and security can be increased to great advantage by said light beams owing to the distance from which an erratic beam movement would become noticeable from a great distance, and also that homes or locations in any way secluded or otherwise would be far more likely to be noticed by law enforcement or even simply the general public from said distance, and one color such as blue or red, for example, could become recognized for this purpose, and the ON/OFF duration or flash frequency and interval periodicity could be established and used only for the purpose of safety, security warning and indication of danger and/or a need for help, and said laser light can optionally also be utilized for aesthetic effect.

23. From claim 21 and claim 22, a system of low voltage lighting which includes a means of limiting line losses by means of a current limiting circuit in said module comprised of a means to provide a current limiter, over current protection and ammeter, and which includes a means of sending a range of voltage or resistance to the microcontroller with programmable central processing unit (CPU), fabricated and programmed to allow the current to be read on said display, and the voltage of the supply conductors also can be read on said display, and the source of the voltage measure is a voltage divider comprised of two resistors utilized in a manner commonly known in the art, and with both the current and the voltage, the central processing unit (CPU) is programmed to display the product of these values when prompted, and thus watts can be found on the menu of the display from the microcontroller with programmable central processing unit (CPU), and this feature may be understood by laypersons and understood as the nominal total power being utilized, and for those able to do the programming the source voltage can be compared to the supply voltage and with zero load the line loss will be measured and held in the central processing unit (CPU) memory, and to great advantage the full load voltage can be processed and displayed also, and with the program in place the loss of the supply conductors can also be viewed when prompted as a percentage of the total so that
the voltage drop can be used to indicate that suitable supply conductors have been chosen, or
to indicate that the supply conductors are not of sufficient capacity for the chosen purpose, and
that the conductor may be replaced, or
said current limiter can be utilized to reduce current flow to a sufficient degree to bring the line loss value down into the required limit and/or the dimmed load might instead be reduced by means of the central processing unit (CPU and a selection from the program menu, and
the described components may by means of battery array modules cause a charge cycle of up to a period of 24 hours so that the required power may be supplied to the module over as long as is possible, and this will result in less current flowing to the Sentinel Advanced Control module and into the battery array, and
this will result in a significant reduction in supply conductor losses, and
the result will make possible much greater length of supply conductors, and/or a series of Sentinel Advanced Control Modules can be placed along a pathway and/or roadway, and multiple Sentinel Sentinel Advanced Control Modules, all or required, with motion detectors and delay OFF settings which will allow for illumination on sections of said pathway and/or roadway, and
one result will be the potential to provide lighting along pathways which may have been impractical to illuminate due to high cost or power requirements,
and this also makes possible a daylight dependent energy source to be connected to the described series of Sentinel Advanced Control Modules, with the result that a solar array can be sized for this purpose and connected to the supply conductors, and with the described voltage drop limitation components and the charger modules and the central microcontroller with CPU can be arranged to provide the required or desired illumination, and also with said components, a single or a multitude of Sentinel Advanced Control Modules can be supplied by said solar energy source and by means of LED or other high efficiency lamps, and with or without the motion detector.
